(19) United States
(12) Patent Application Publication
(10) Pub. No.: US 2004/0086811 A1
(43) Pub. Date: May 6, 2004

(54) Silver halide color photosensitive material

(75) Inventors: Fumitaka Ueda, Minami-Ashigara-shi (JP); Koji Takaku, Minami-Ashigara-shi (JP); Ryoji Nishimura, Minami-Ashigara-shi (JP); Keisuke Matsumoto, Minami-Ashigara-shi (JP); Yoshio Ishii, Minami-Ashigara-shi (JP)

Correspondence Address: Sughrue Mion, PLLC, 2100 Pennsylvania Avenue, N.W., Washington, DC, 20037-3213, US

(73) Assignee: FUJI PHOTO FILM CO., LTD.

(21) Appl. No.: 10/689,356

(22) Filed: Oct. 21, 2003

(30) Foreign Application Priority Data
Oct. 22, 2002 (JP) 2002-307215
Aug. 20, 2003 (JP) 2003-296459

(51) Int. Cl. G03C 1/08; G03C 7/26; G03C 7/32

(52) U.S. Cl. 430/553; 430/544; 430/505; 430/957; 430/567

(57) ABSTRACT

A silver halide color photosensitive material has, on a support, a unit blue-sensitive silver halide emulsion layer, a unit green-sensitive silver halide emulsion layer and a unit red-sensitive silver halide emulsion layer, each comprising two or more light-sensitive layers having the same color sensitivity but differing in speed to each other. The silver halide color photosensitive material contains at least one compound represented by the following general formula (I) or general formula (II); and at least one of the light-sensitive layers contains silver halide grains in which tabular grains each having an aspect ratio of 5.0 or more account for 60% or more of the total projected area of the silver halide grains.

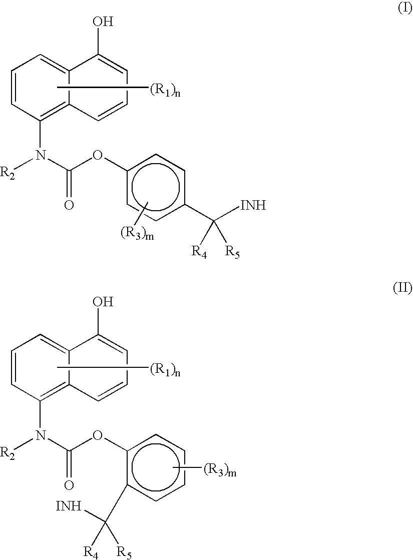

The respective definitions of the substituents are described in the specification.

### CROSS-REFERENCE TO RELATED APPLICATIONS

This application is based upon and claims the benefit of priority from the prior Japanese Patent Applications No. 2002-307215, filed Oct. 22, 2002; and No. 2003-296459, filed Aug. 20, 2003, the entire contents of both of which are incorporated herein by reference.

### BACKGROUND OF THE INVENTION

1. Field of the Invention

The present invention relates to silver halide color photosensitive materials, and more specifically to high-speed photosensitive materials which are excellent in graininess and sharpness and which can achieve good color reproduction.

2. Description of the Related Art

For enhancing user's benefits in color negative films, silver halide photosensitive materials have been required to have an increased speed. In recent years, high-speed film with a specific photographic speed (ISO film speed) of 800 or more have steadily come into regular use through penetration of films with lens and compact cameras with zoom function which can easily and simply cope for various exposure conditions.

On the other hand, as performance of silver halide photosensitive materials, sharpness and color reproducibility are important after speed. DIR couplers that undergo coupling reactions with oxidized products of color developing agents to release development inhibitors, are known as means for improving sharpness and color reproducibility. It is known that when the DIR couplers are contained in emulsions, an improvement in sharpness due to an edge effect and an improvement in color reproducibility due to an interlayer effect are achieved (see, for example, Japanese Patent Application KOKAI Publication (hereinafter referred to as JP-A-) 4-278942). However, the DIR couplers disclosed in the patent publication release development inhibitors through their coupling reactions with oxidized developing agents and, simultaneously, form azomethine dyes. As a result, the layers where the DIR couplers are used and the amount of the DIR couplers used are strictly limited. It is, therefore, difficult to recognize such DIR couplers as a technology of great versatility.

As a solution to this problem, proposed is a DIR coupler which undergoes a coupling reaction with an oxidized developing agent and then forms a cyclized product and simultaneously releases a development inhibitor through an intramolecular nucleophilic substitution reaction with a nitrogen atom derived from the developing agent (for example, European Patent Publication (hereinafter also referred to as “EP”) 950922 A1). The DIR coupler disclosed in this patent publication can Release a development inhibitor while forming substantially no color image. It has, therefore, no limitations in the layer where it is used and, accordingly, may be recognized as a technology of great versatility.

On the other hand, disclosed is a technology that provides a photosensitive material having an ISO film speed of not less than 320 which is of high speed and which has superior graininess, sharpness and pressure resistance due to using, in an emulsion layer located furthest from the support, tabular grains having an aspect ratio of 5 or more and having a dislocation line (JP-A-5-341459, for example). However, it is becoming difficult to achieve an edge effect and an interlayer effect caused by a DIR coupler by this technology. Even the performance of the DIR coupler disclosed in the above patent publication is unsatisfactory in a high-speed photosensitive material. Accordingly, it is difficult to achieve a satisfactory sharpness and satisfactory color reproducibility in a high-speed photosensitive material by conventional technologies.

### BRIEF SUMMARY OF THE INVENTION

An object of the present invention is to provide a high-speed color photosensitive material which is superior in sharpness and graininess and which is of fully improved color reproducibility.

The inventors conducted extensive and intensive investigations. As a result, they were able to achieve the object of the present invention by the use of the following constitutions.

(1) A silver halide color photosensitive material having, on a support, a unit blue-sensitive silver halide emulsion layer, a unit green-sensitive silver halide emulsion layer and a unit red-sensitive silver halide emulsion layer, each comprising two or more light-sensitive layers having the same color sensitivity but differing in speed to each other, wherein the silver halide color photosensitive material containing at least one compound represented by the following general formula (I) or general formula (II); and wherein at least one of the light-sensitive layers containing silver halide grains in which tabular grains each having an aspect ratio of 5.0 or more account for 60% or more of the total projected area of the silver halide grains:

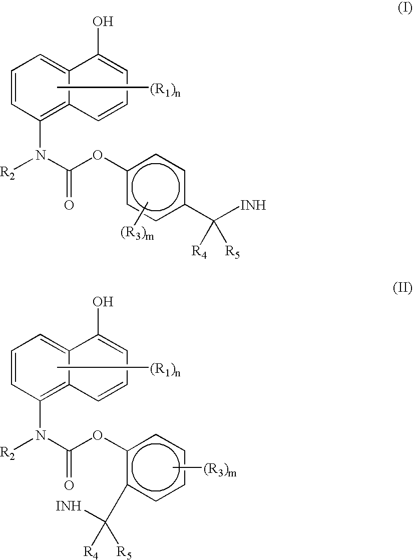

wherein R₁ represents a substituent capable of bonding to a naphthalene ring; n represents an integer of 0 to 6, provided that when n is 2 or more; R₁s may be the same or different; R₂ represents an alkyl group or aryl group, provided that R₁ and R₂ may be bonded to each other to form a ring; R₃s represent m independent substituents bonding to an aryloxy ring which are selected so that the sum of their Hammett substituent constants σ_{P} may be 0.1 or more, provided that R₃ may be bonded to RS to form a ring, m represents an integer of 1 to 3, provided that when m is 2 or 3, R₃s may be the same or different; R₄ and RS independently represent a hydrogen atom, alkyl group (including cycloalkyl), alkenyl group (including cycloalkenyl), alkynyl group or aryl group; and INH represents a residue of a mercaptotetrazole derivative, mercaptotriazole derivative, mercaptothiadiazole derivative, mercaptooxadiazole derivative, mercaptothiazole derivative, mercaptooxazole derivative, mercaptoimidazole derivative, mercaptobenzimidazole derivative, mercaptobenzothiazole derivative, mercaptobenzoxazole derivative, tetrazole derivative, 1,2,3-triazole derivative, 1,2,4-triazole derivative or benzotriazole derivative.

(2) The silver halide color photosensitive material described in (1), wherein the silver halide tabular grains accounting for 60% or more of the total projected area of the silver halide grains each having an aspect ratio of 8.0 or more.

(3) The silver halide color photosensitive material described in (1) or (2), wherein the tabular silver halide grains each having at least ten dislocation lines per grain.

(4) The silver halide color photosensitive material described in any one of (1) to (3), wherein an emulsion contained in at least one light-sensitive emulsion layer in the silver halide color photosensitive material comprising tabular grains each having a (111) face as a main plane, and each meeting a relationship I₂/I₁<1, wherein I₁ represents a silver iodide content (mol %) of an outermost surface layer in a main plane region and I₂ represents a silver iodide content (mol %) of an outermost surface layer in a side face region, in an amount of 50% or more of the total projected area of all the silver halide grains contained in the emulsion.

(5) The silver halide color photosensitive material described in any one of (1) to (4), wherein the silver halide color photosensitive material having an ISO speed of 640 or more.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DETAILED DESCRIPTION OF THE INVENTION

The DIR couplers used in the silver halide color photosensitive material of the present invention are described in detail below.

In the above general formula (I) and (II), R₁ represents a substituent which can bond to a naphthalene ring, which for example, is a halogen atom, alkyl group (including a cycloalkyl and bicycloalkyl), alkenyl group (including a cycloalkenyl and bicycloalkenyl), alkynyl group, aryl group, heterocyclic group, cyano group, nitro group, alkoxy group, aryloxy group, heterocyclicoxy group, acyloxy group, carbamoyloxy group, alkoxycarbonyloxy group, aryloxycarbonyloxy group, acylamino group, aminocarbonylamino group, alkoxycarbonylamino group, aryloxycarbonylamino group, sulfamoylamino group, alkyl- and aryl-sulfonylamino groups, alkylthio group, arylthio group, heterocyclic thio group, sulfamoyl group, sulfo group, alky- and aryl-sulfinyl groups, alkyl- and aryl-sulfonyl groups, acyl group, aryloxycarbonyl group, alkoxycarbonyl group, carbamoyl group, imide group, phosphino group, phosphinyl group, phosphinyloxy group, phosphinylamino group, or silyl group.

More specifically, R₁ represents a halogen atom (e.g., a chlorine atom, bromine atom, and iodine atom), an alkyl group [which represents a straight-chain, branched, or cyclic, substituted or unsubstituted alkyl group. Examples are, an alkyl group (preferably a 1- to 30-carbon, substituted or unsubstituted alkyl group, e.g., methyl, ethyl, n-propyl, isopropyl, t-butyl, n-octyl, eicosyl, 2-chloroethyl, 2-cyanoethyl, and 2-ethylhexyl), cycloalkyl group (preferably a 3- to 30-carbon, substituted or unsubstituted cycloalkyl group, e.g., cyclohexyl, cyclopentyl, and 4-n-dodecylcyclohexyl), bicycloalkyl group (preferably a 5- to 30-carbon, substituted or unsubstituted bicycloalkyl group, i.e., a monovalent group obtained by removing one hydrogen atom from 5- to 30-carbon bicycloalkane, for example, bicyclo[1,2,2]heptane-2-yl and bicyclo[2,2,2]octane-3-yl), and also higher cyclic structures such as tricyclic structure. The alky groups of substituents to be described below (e.g., the alkyl group of an alkylthio group) also have the same concept.], an alkenyl group [which represents a straight-chain, branched, or cyclic, substituted or unsubstituted alkenyl group. Examples are an alkenyl group (preferably a 2- to 30-carbon, substituted or unsubstituted alkenyl group, e.g., vinyl, allyl, prenyl, geranyl, and oleyl), cycloalkenyl group (preferably a 3- to 30-carbon, substituted or unsubstituted cycloalkenyl group, i.e., a monovalent group obtained by removing one hydrogen atom from 3- to 30-carbon cycloalkene. Examples are 2-cyclopentene-1-yl and 2-cyclohexene-1-yl), bicycloalkenyl group (a substituted or unsubstituted bicycloalkenyl group, preferably a 5- to 30-carbon, substituted or unsubstituted bicycloalkenyl group, i.e., a monovalent group obtained by removing one hydrogen atom from bicycloalkene having one double bond. Examples are bicyclo[2,2,1]hepto-2-ene-1-yl and bicyclo[2,2,2]octo-2-ene-4-yl)], an alkynyl group (preferably a 2- to 30-carbon, substituted or unsubstituted alkynyl group, e.g., ethynyl, propargyl, and trimethylsilylethynyl), aryl group (preferably a 6- to 30-carbon, substituted or unsubstituted aryl group, e.g., phenyl, p-tolyl, naphthyl, m-chlorophenyl, and o-hexadecanoylaminophenyl), heterocyclic group (preferably a monovalent group obtained by removing one hydrogen atom from a 5- or 6-membered, substituted or unsubstituted, aromatic or nonaromatic heterocyclic compound, to which an aromatic group such as benzene may be condenced, and more preferably, a 3- to 30-carbon, 5- or 6-membered aromatic heterocyclic group. Examples are 2-furyl, 2-thienyl, 2-pyrimidinyl, 2-benzothiazolyl, pyrrolidinyl, pyrrolidino, morpholinyl, and morpholino), cyano group, nitro group, alkoxy group (preferably a 1- to 30-carbon, substituted or unsubstituted alkoxy group, e.g., methoxy, ethoxy, isopropoxy, t-butoxy, n-octyloxy, and 2-methoxyethoxy), an aryloxy group (preferably a 6- to 30-carbon, substituted or unsubstituted aryloxy group, e.g., phenoxy, 2-methylphenoxy, 4-t-butylphenoxy, 3-nitrophenoxy, and 2-tetradecanoylaminophenoxy), heterocyclic oxy group (preferably a 2- to 30-carbon, substituted or unsubstituted heterocyclic oxy group, e.g., 1-phenyltetrazole-5-oxy and 2-tetrahydropyranyloxy), acyloxy group (preferably a formyloxy group, 2- to 30-carbon, substituted or unsubstituted alkylcarbonyloxy group, and 7- to 30-carbon, substituted or unsubstituted arylcarbonyloxy group, e.g., formyloxy, acetyloxy, pivaloyloxy, stearoyloxy, benzoyloxy, and p-methoxyphenylcarbonyloxy), carbamoyloxy group (preferably a 1- to 30-carbon, substituted or unsubstituted carbamoyloxy group, e.g., N,N-dimethylcarbamoyloxy, N,N-diethylcarbamoyloxy, morpholinocarbonyloxy, N,N-di-n-octylaminocarbonyloxy, and N-n-octylcarbamoyloxy), alkoxycarbonyloxy group (preferably a 2- to 30-carbon, substituted or unsubstituted alkoxycarbonyloxy group, e.g., methoxycarbonyloxy, ethoxycarbonyloxy, t-butoxycarbonyloxy, and n-octylcarbonyloxy), aryloxycarbonyloxy group (preferably a 7- to 30-carbon, substituted or unsubstituted aryloxycarbonyloxy group, e.g., phenoxycarbonyloxy, p-methoxyphenoxycarbonyloxy, and p-(n-hexadecyloxy)phenoxycarbonyloxy), acylamino group (preferably a formylamino group, 2- to 30-carbon, substituted or unsubstituted alkylcarbonylamino group, and 7- to 30-carbon, substituted or unsubstituted arylcarbonylamino group, e.g., formylamino, acetylamino, pivaloylamino, lauroylamino, benzoylamino, and 3,4,5-tri-(n-octyloxyphenyl)carbonylamino), aminocarbonylamino group (preferably a 1- to 30-carbon, substituted or unsubstituted aminocarbonylamino, e.g., carbamoylamino, N,N-dimethylaminocarbonylamino, N,N-diethylaminocarbonylamino, and morpholinocarbonylamino), an alkoxycarbonylamino group (preferably a 2- to 30-carbon, substituted or unsubstituted alkoxycarbonylamino group, e.g., methoxycarbonylamino, ethoxycarbonylamino, t-butoxycarbonylamino, n-octadecyloxycarbonylamino, and N-methyl-methoxycarbonylamino), aryloxycarbonylamino group (preferably a 7- to 30-carbon, substituted or unsubstituted aryloxycarbonylamino group, e.g., phenoxycarbonylamino, p-chlorophenoxycarbonylamino, and m-(n-octyloxy)phenoxycarbonylamino), sulfamoylamino group (preferably a 0- to 30-carbon, substituted or unsubstituted sulfamoylamino group, e.g., sulfamoylamino, N,N-dimethylaminosulfonylamino, and N-n-octylaminosulfonylamino), alkyl- and aryl-sulfonylamino groups (preferably 1- to 30-carbon, substituted or unsubstituted alkylsulfonylamino and 6- to 30-carbon, substituted or unsubstituted arylsulfonylamino, e.g., methylsulfonylamino, butylsulfonylamino, phenylsulfonylamino, 2,3,5-trichlorophenylsulfonylamino, and p-methylphenylsulfonylamino), alkylthio group (preferably a 1- to 30-carbon, substituted or unsubstituted alkylthio group, e.g., methylthio, ethylthio, and n-hexadecylthio), arylthio group (preferably a 6- to 30-carbon, substituted or unsubstituted arylthio group, e.g., phenylthio, p-chlorophenylthio, and m-methoxyphenylthio), heterocyclic thio group (preferably a 2- to 30-carbon, substituted or unsubstituted heterocyclic thio group, e.g., 2-benzothiazolylthio and 1-phenyl-tetrazole-5-ylthio), sulfamoyl group (preferably a 2- to 30-carbon, substituted sulfamoyl group, e.g., N-(3-dodecyloxypropyl)sulfamoyl, N,N-dimethylsulfamoyl, N-(N′-phenylcarbamoyl)sulfamoyl), sulfo group, alkyl- and aryl-sulfinyl groups (preferably a 1- to 30-carbon, substituted or unsubstituted alkylsulfinyl group and 6- to 30-carbon, substituted or unsubstituted arylsulfinyl group, e.g., methylsulfinyl, ethylsulfinyl, phenylsulfinyl, and p-methylphenylsulfinyl), alkyl- and aryl-sulfonyl groups (preferably a 1- to 30-carbon, substituted or unsubstituted alkylsulfonyl group and 6- to 30-carbon, substituted or unsubstituted arylsulfonyl group, e.g., methylsulfonyl, ethylsulfonyl, phenylsulfonyl, and p-methylphenylsulfonyl), acyl group (preferably a formyl group, 2- to 30-carbon, substituted or unsubstituted alkylcarbonyl group, and 7- to 30-carbon, substituted or unsubstituted arylcarbonyl group, e.g., acetyl, pivaloyl, 2-chloroacetyl, stearoyl, benzoyl, and p-(n-octyloxy)phenylcarbonyl), aryloxycarbonyl group (preferably a 7- to 30-carbon, substituted or unsubstituted aryloxycarbonyl group, e.g., phenoxycarbonyl, o-chlorophenoxycarbonyl, m-nitrophenoxycarbonyl, and p-(t-butyl)phenoxycarbonyl), alkoxycarbonyl group (preferably a 2- to 30-carbon, substituted or unsubstituted alkoxycarbonyl group, e.g., methoxycarbonyl, ethoxycarbonyl, t-butoxycarbonyl, and n-octadecyloxycarbonyl), carbamoyl group (preferably 1- to 30-carbon, substituted or unsubstituted carbamoyl, e.g., carbamoyl, N-methylcarbamoyl, N,N-dimethylcarbamoyl, N,N-di-(n-octyl)carbamoyl, N-(o-methoxyfenyl)carbamoyl, N-(o-tetradecyloxyphenyl)carbamoyl, and N-(p-acylaminophenyl)methoxyphenyl)carbamoyl), imido group (preferably N-succinimido and N-phthalimido), phosphino group (preferably a 2- to 30-carbon, substituted phosphino group, e.g., dimethylphosphino, diphenylphosphino, and methylphenoxyphosphino), phosphinyl group (preferably a 2- to 30-carbon, substituted phosphinyl group, e.g., dioctyloxyphosphinyl, and diethoxyphosphinyl), phosphinyloxy group (preferably a 2- to 30-carbon, substituted phosphinyloxy group, e.g., diphenoxyphosphinyloxy and dioctyloxyphosphinyloxy), phosphinylamino group (preferably a 2- to 30-carbon, substituted phosphinylamino group, e.g., dimethoxyphosphinylamino and dimethylaminophosphinylamino), silyl group (preferably a 3- to 30-carbon, substituted silyl group, e.g., trimethylsilyl, t-butyldimethylsilyl, and phenyldimethylsilyl).

Of the above substituents, those having a hydrogen atom may be further substituted by the above groups by removing the hydrogen atom. Examples of such substituents are an alkylcarbonylaminosulfonyl group, arylcarbonylaminosulfonyl group, alkylsulfonylaminocarbonyl group, and arylsulfonylaminocarbonyl group. Examples of these groups are methylsulfonylaminocarbonyl, p-methylphenylsulfonylaminocarbonyl, acetylaminosulfonyl, and a benzoylaminosulfonyl group.

R₁ preferably represents a halogen atom, cyano group, acylamino group, sulfamoyl group and carbamoyl group, more preferably an acylamino group, sulfamoyl group and carbamoyl group, and particularly preferably a carbamoyl group.

n represents an integer of 0 to 6. When n is 2 or more, the R₁s may be the same or different. n is preferably 1. At this time it is preferable that R₁ be located at an α position of the hydroxyl group in general formula (I).

R₂ represents an alkyl group or aryl group. Detailed descriptions about the alkyl group and aryl group are the same as those described above for R₁. R₂ is preferably a substituted or unsubstituted alkyl group having 1 to 30 carbon atoms, and more preferably an unsaturated alkynyl group having 1 to 20 carbon atoms. R₂ may be bonded to R₁ to form a ring. The ring is preferably a 5- to 7-membered ring.

R₃s have the same meaning as that described for R₁, provided that they are selected so that the sum of their Hammet substituent constants σ_{P} may be 0.1 or more.

The sum of the Hammet substituent constants σ_{P} is preferably 0.1 to 1.6, more preferably 0.1 to 1.0, and especially 0.2 to 0.8. When the σ_{P} value is within this range, a preferable releasing timing of the development inhibitor is achieved. When the σ_{P} value is a large value toward plus the releasing timing delays, while the σ_{P} value is small, the releasing timing quickens.

Here, some explanation of the Hammett substituent constant used herein will be described. Hammett's rule is an empirical rule proposed by L. P. Hammett in 1935 in order to quantitatively argue the effects of substituents on reaction or equilibrium of benzene derivatives. The rule is widely regarded as appropriate these days. The substituent constants obtained by the Hammett rule include a σp value and a σm value, and these values are described in a large amount of general literature. For example, the values are described in detail in J. A. Dean ed., “Lange's Handbook of Chemistry,” the 12th edition, 1979 (McGraw-Hill), “The Extra Number of The Domain of Chemistry (KAGAKUNO RYOIKI ZOUKAN),” Vol. 122, pages 96 to 103, 1979 (Nanko Do) and Chemical Reviews, Vol. 91, pp. 165-195 (1991). Note that in the present invention, substituents are specified by or explained with Hammett substituent constant σp. This does not mean that the substituents are limited only to the substituents whose σp values are known in the above literatures, but it is needless to say that the substituents also include those, even the σp values thereof are not known in a literature, which may have σp values within the range when the values are measured according to Hammett' rule. Hereinafter, σp value and σm value have this meaning.

R₃s are selected preferably from an alkyl group, alkenyl group, halogen atom, cyano group, nitro group, acylamino group, sulfamoyl group, alkyl- and arylsulfinyl groups, alkyl- and arylsulfonyl groups, acyl group, aryloxycarbonyl group, alkoxycarbonyl group and carbamoyl group, more preferably from a halogen atom, cyano group, nitro group, sulfamoyl group and alkoxycarbonyl group, and particularly preferably from a halogen atom and nitro group.

R₃ may be bonded to R₅ to form a ring. The ring may have a substituent, preferably the ring is a 5- to 6-membered ring.

m represents an integer of 1 to 3, preferably 1 or 2. When m is 2 or 3, the R₃s may be the same or different.

R₄ and RS independently represent a hydrogen atom, alkyl group (including cycloalkyl), alkenyl group (including cycloalkenyl), alkynyl group and aryl group.

More specifically, R₄ and R₅ represent a hydrogen atom, alkyl group [straight-chain, branched, or cyclic, substituted or unsubstituted alkyl group. Examples are, an alkyl group (preferably a 1- to 8-carbon alky group, e.g., methyl, ethyl, n-propyl, isopropyl, t-butyl, n-octyl, 2-chloroethyl, 2-cyanoethyl and 2-ethylhexyl), cycloalkyl group (preferably a 3- to 8-carbon, substituted or unsubstituted cycloalkyl group, e.g., cyclohexyl and cyclopentyl)], alkenyl group [straight-chain, branched, or cyclic, substituted or unsubstituted alkenyl group. Examples are an alkenyl group (preferably a 2- to 8-carbon, substituted or unsubstituted alkenyl group, e.g., vinyl, allyl and prenyl), cycloalkenyl group (preferably a 3- to 8-carbon, substituted or unsubstituted cycloalkenyl group, i.e., a monovalent group obtained by removing one hydrogen atom from 3- to 8-carbon cycloalkene. Examples are 2-cyclopentene-1-yl and 2-cyclohexene-1-yl), an alkynyl group (preferably a 2- to 8-carbon, substituted or unsubstituted alkynyl group, e.g., ethynyl, propargyl, and trimethylsilylethynyl) or aryl group (preferably a 6- to 12-carbon, substituted or unsubstituted aryl group, e.g., phenyl, p-tolyl, naphthyl and m-chlorophenyl).

R₄ and R₅ are preferably a hydrogen atom or alkyl group.

Of the above substituents, those having a hydrogen atom may be further substituted by the above groups by removing the hydrogen atom. Examples of such substituents are a halogen atom (e.g., a fluorine atom, chlorine atom, bromine atom and iodine atom), sulfo group, cyano group, nitro group, alkyl group (e.g., methyl, ethyl, and hexyl), alkenyl group (e.g., vinyl), alkynl group (e.g., ethynyl), aryl group (e.g., phenyl, tolyl, naphthyl), alkoxy group (e.g., methoxy, ethoxy and octyloxy), aryloxy group (e.g., phenoxy and naphthyloxy), acyl group (e.g., acetyl, propionyl and benzoyl), alkyl- and aryl-sufonyl groups (e.g., methylsulfonyl and phenylsulfonyl), acylamino group (e.g., acetylamino and benzolyamino), carbamoyl group (e.g., carbamoyl, N-methylaminocarbonyl, N,N-dimethylaminocarbonyl and N-phenylaminocarbonyl), alkoxycarbonyl group (e.g., methoxycarbonyl, ethoxycarbonyl and octyloxycarbony), aryloxycarbonyl group (e.g., phenoxycarbonyl and naphtyloxycarbonyl), acyloxy group (e.g., acetyloxy and benzoyloxy), alkoxycarbonylamino group (e.g., methoxycarbonyl amino and butoxycarbonyl amino), and aminocarbonylamino (e.g., N-methylaminocarbonylamino and N-phenylaminocarbonylamino).

INH represents a residue of a mercaptotetrazole derivative, mercaptotriazole derivative, mercaptothiadiazole derivative, mercaptooxadiazole derivative, mercaptothiazole derivative, mercaptooxazole derivative, mercaptoimidazole derivative, mercaptobenzimidazole derivative, mercaptobenzothiazole derivative, mercaptobenzoxazole derivative, tetrazole derivative, 1,2,3-triazole derivative, 1,2,4-triazole derivative or benzotriazole derivative.

INH preferably represents a residue of a mercaptotetrazole derivative, mercaptotriazole derivative, mercaptothiadiazole derivative or mercaptooxadiazole derivative.

The following are specific examples of the residues represented by INH of the above-mentioned derivatives. The present invention, however, is not limited to them. It is to be noted that INH can be bonded to a DIR coupler at a site marked by * in the following formulas.

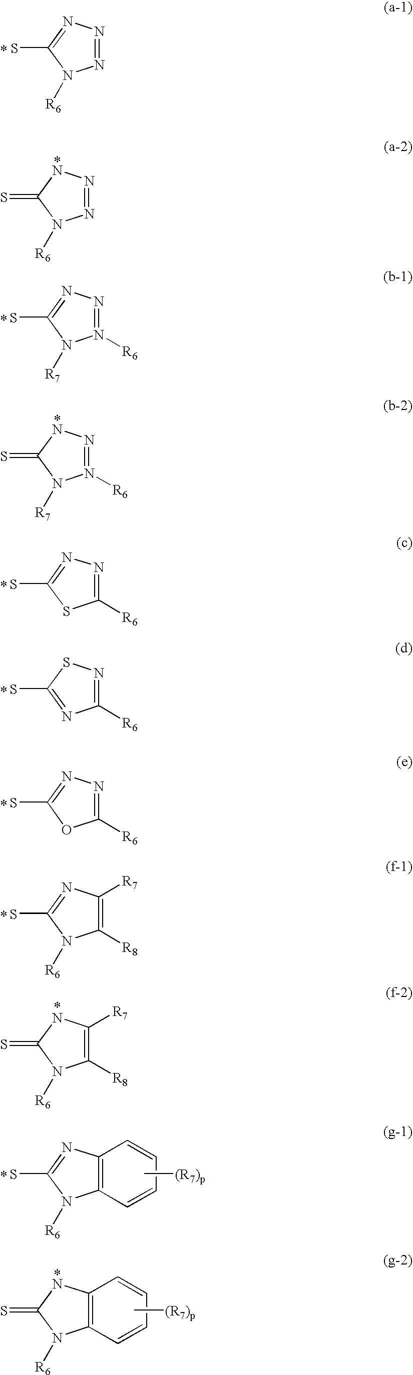

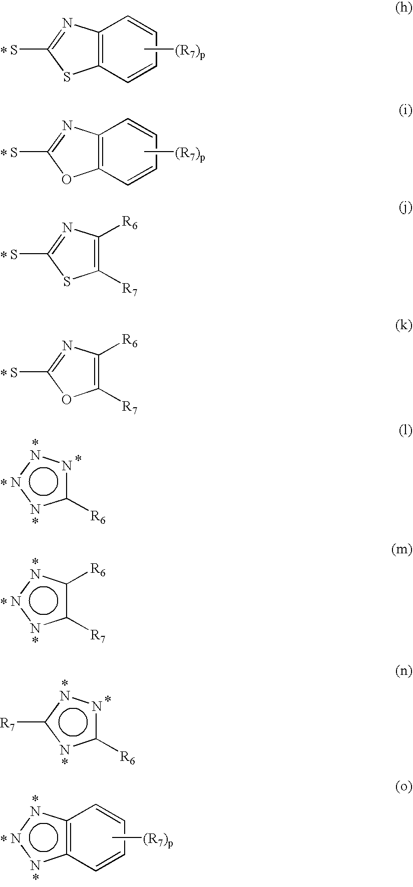

In the formulas each of R₆ to R₈ independently represents a hydrogen atom or substituent. Examples of the substituent represented by R₆ to R₈ are the same as the examples of the substituent mentioned above for R₁ to R₆ when these groups have a hydrogen atom and have an additional substituent by removing the hydrogen atom. q represents an integer from 0 to 4, preferably an integer of 0 to 2.

Specific examples of preferable INH are shown below, but INH is not limited to these.

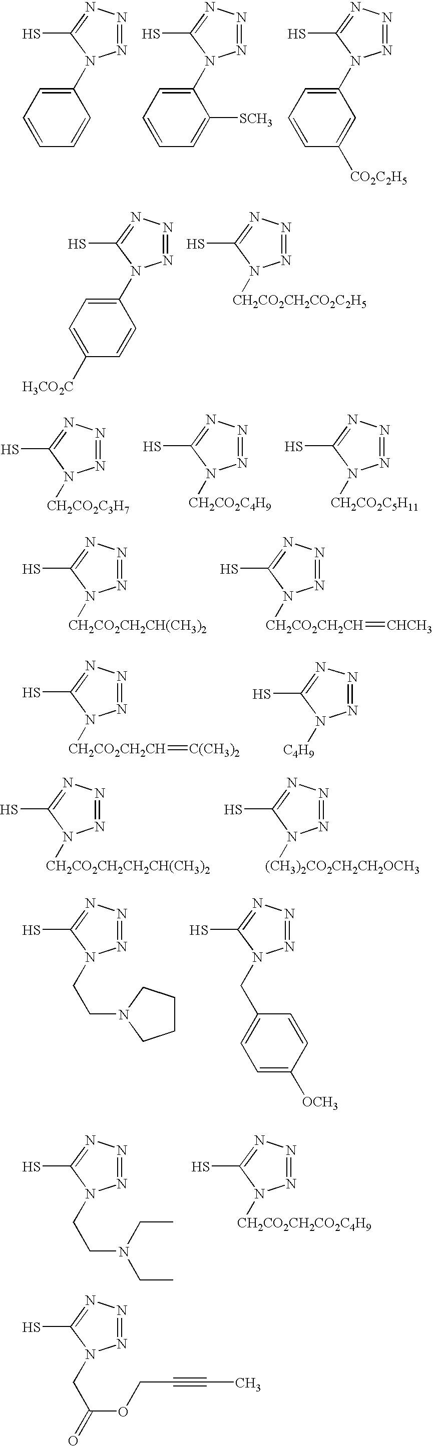

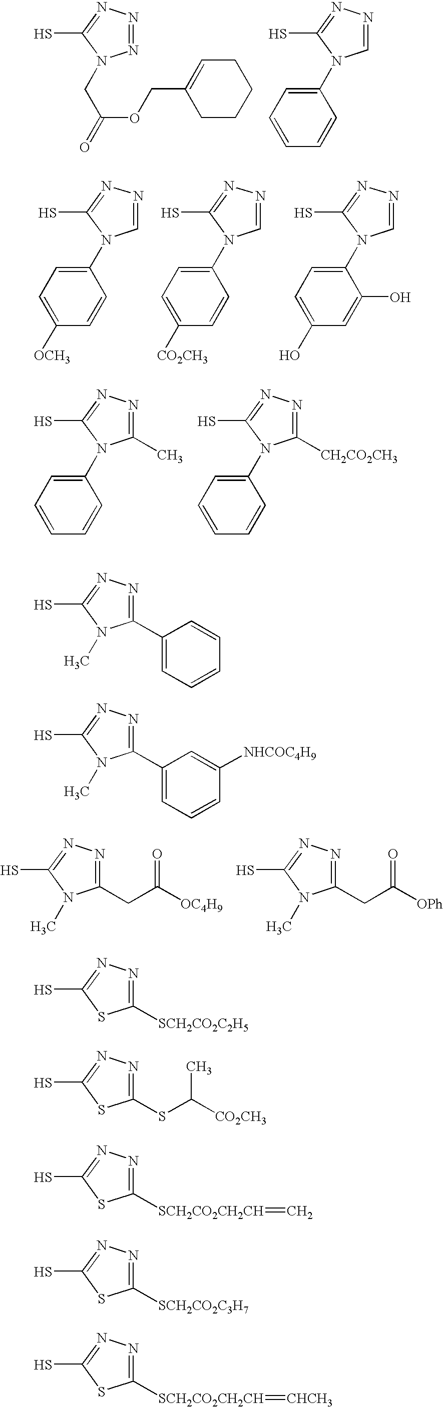

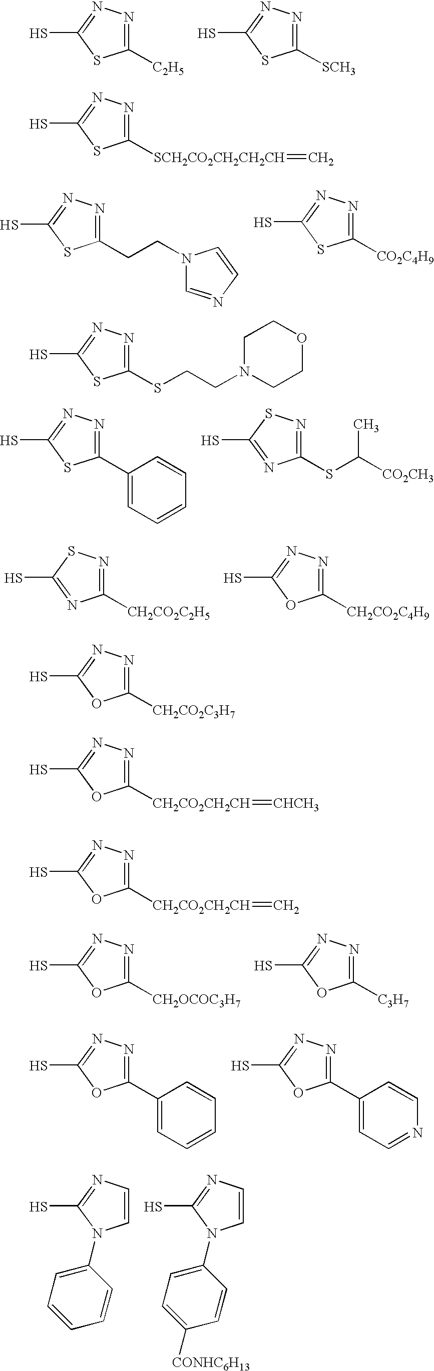

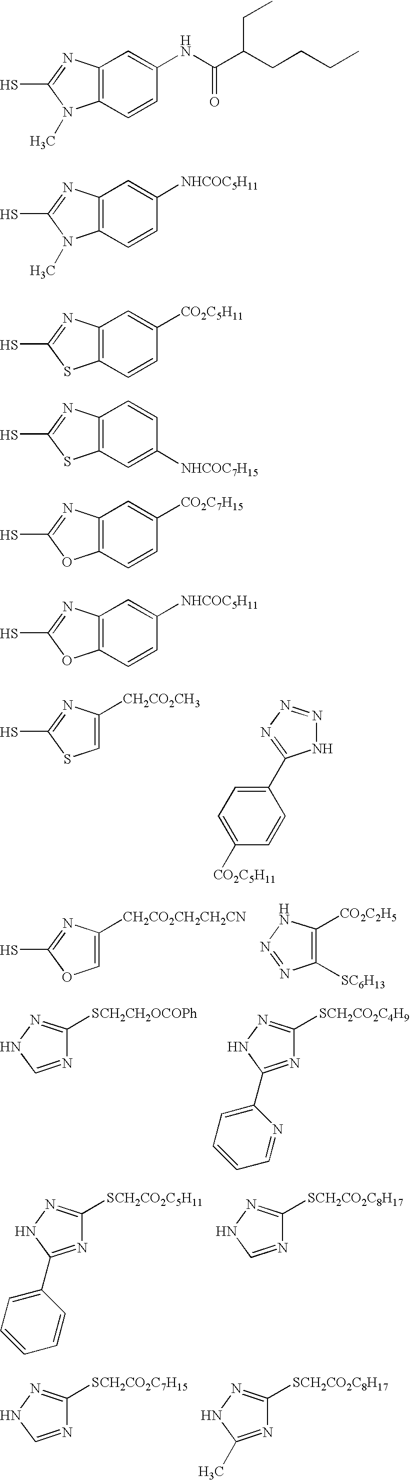

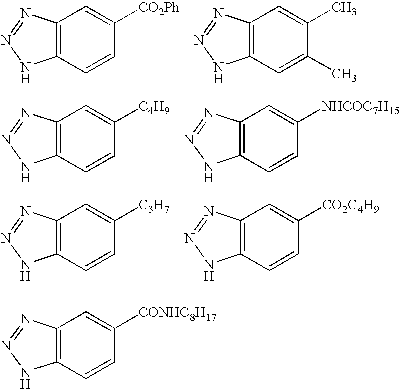

Specific examples of the compound represented by general formula (I) are set froth below, but the compounds represented by general formula (I) are not limited to these examples.

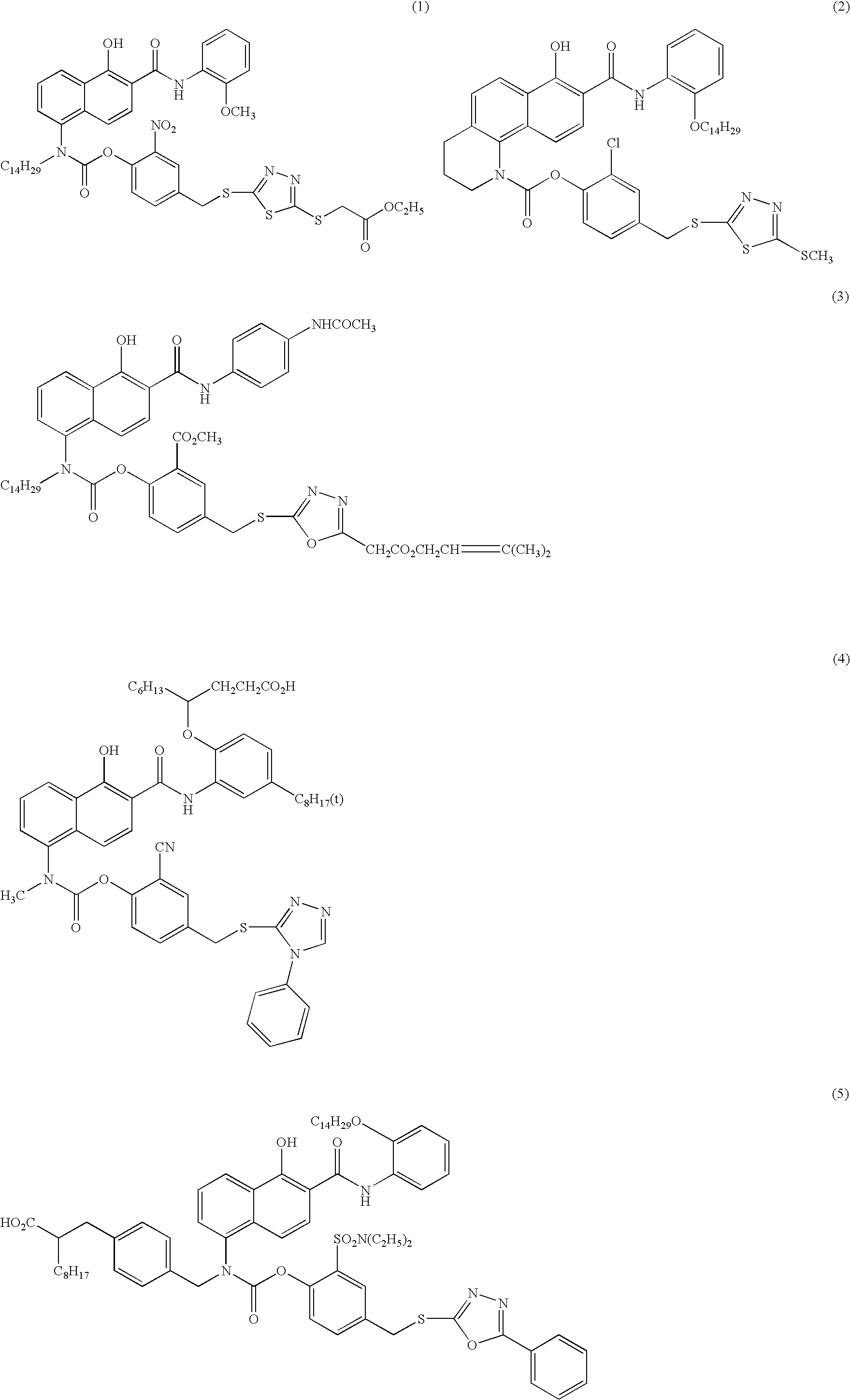

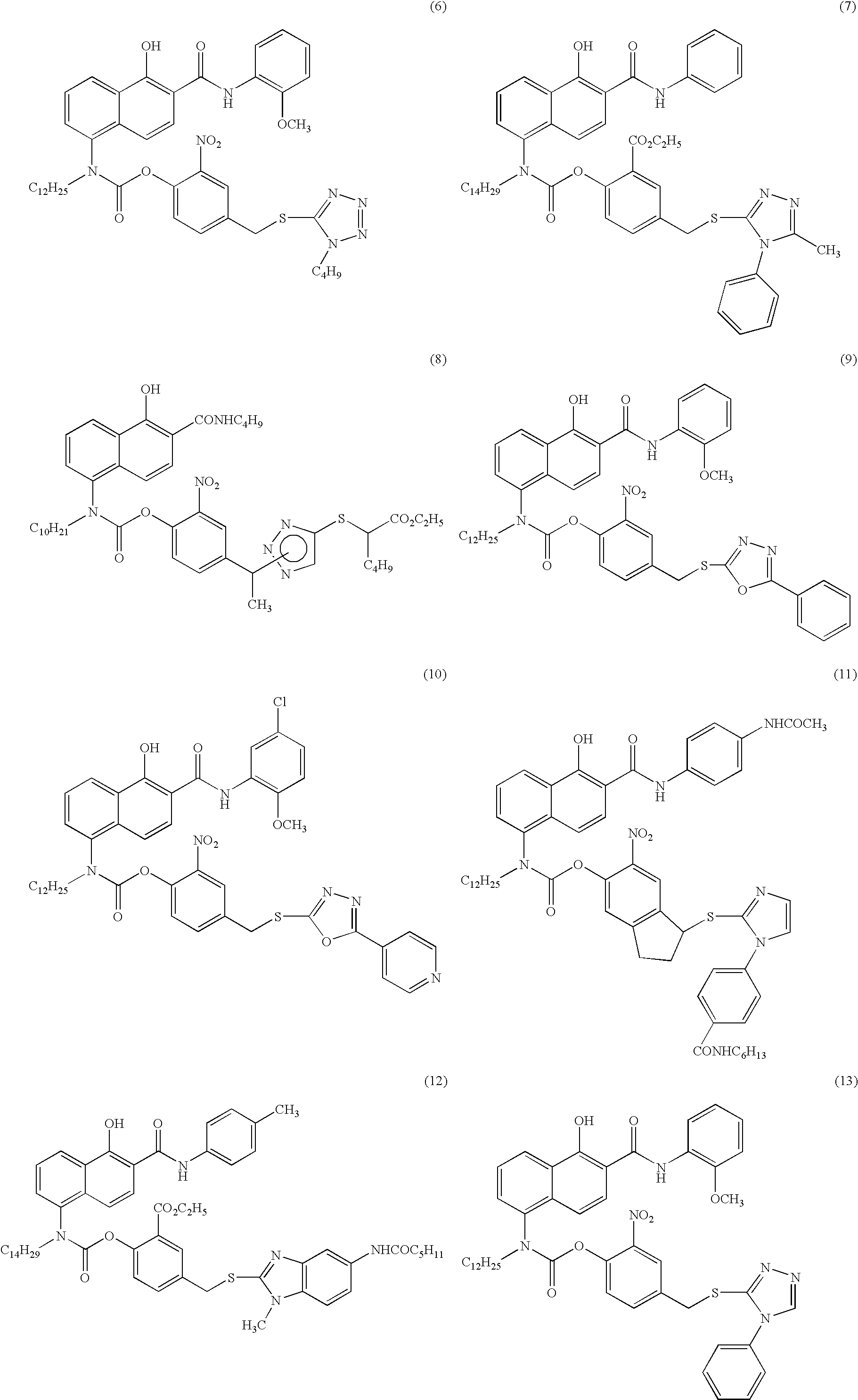

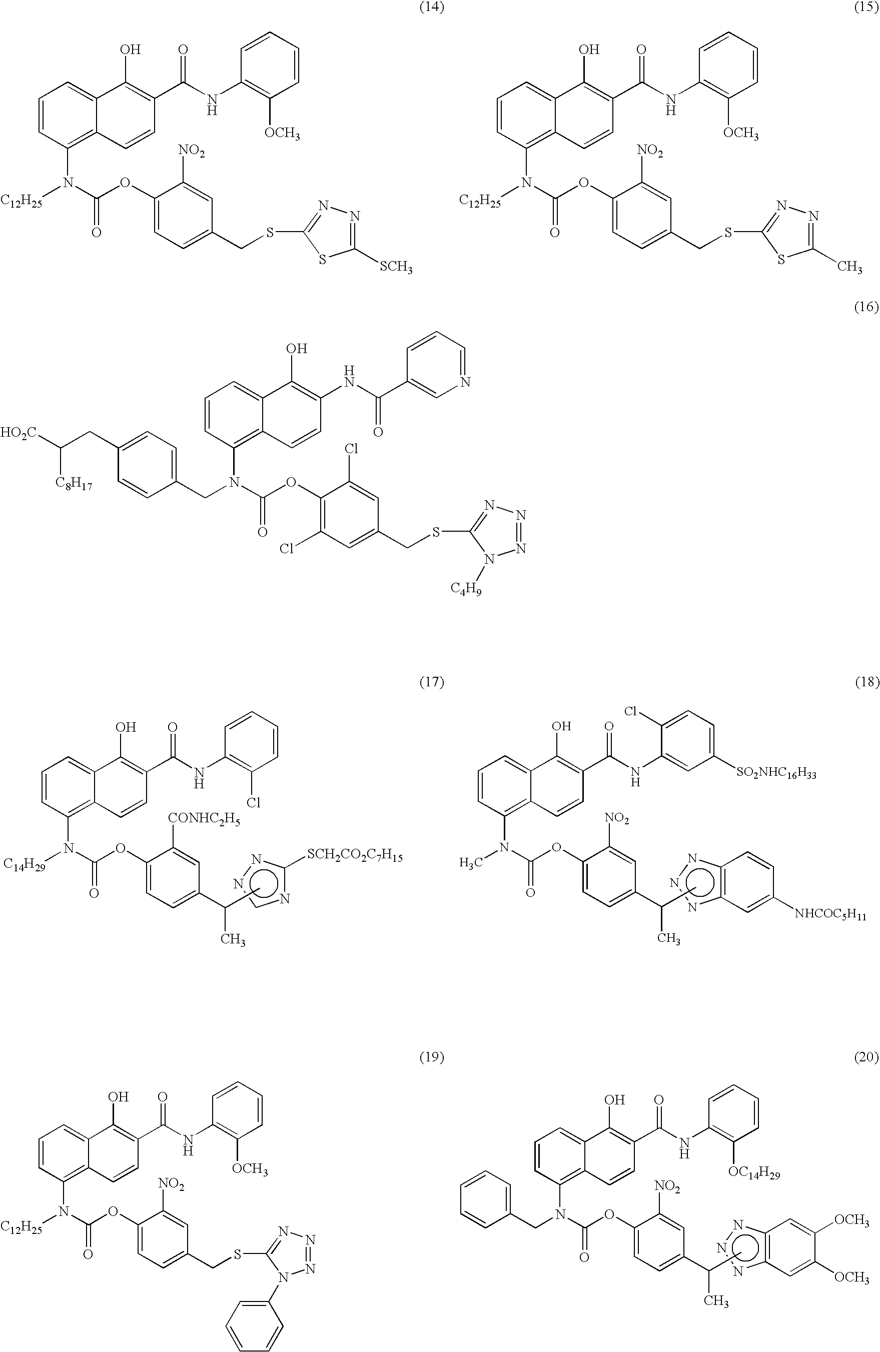

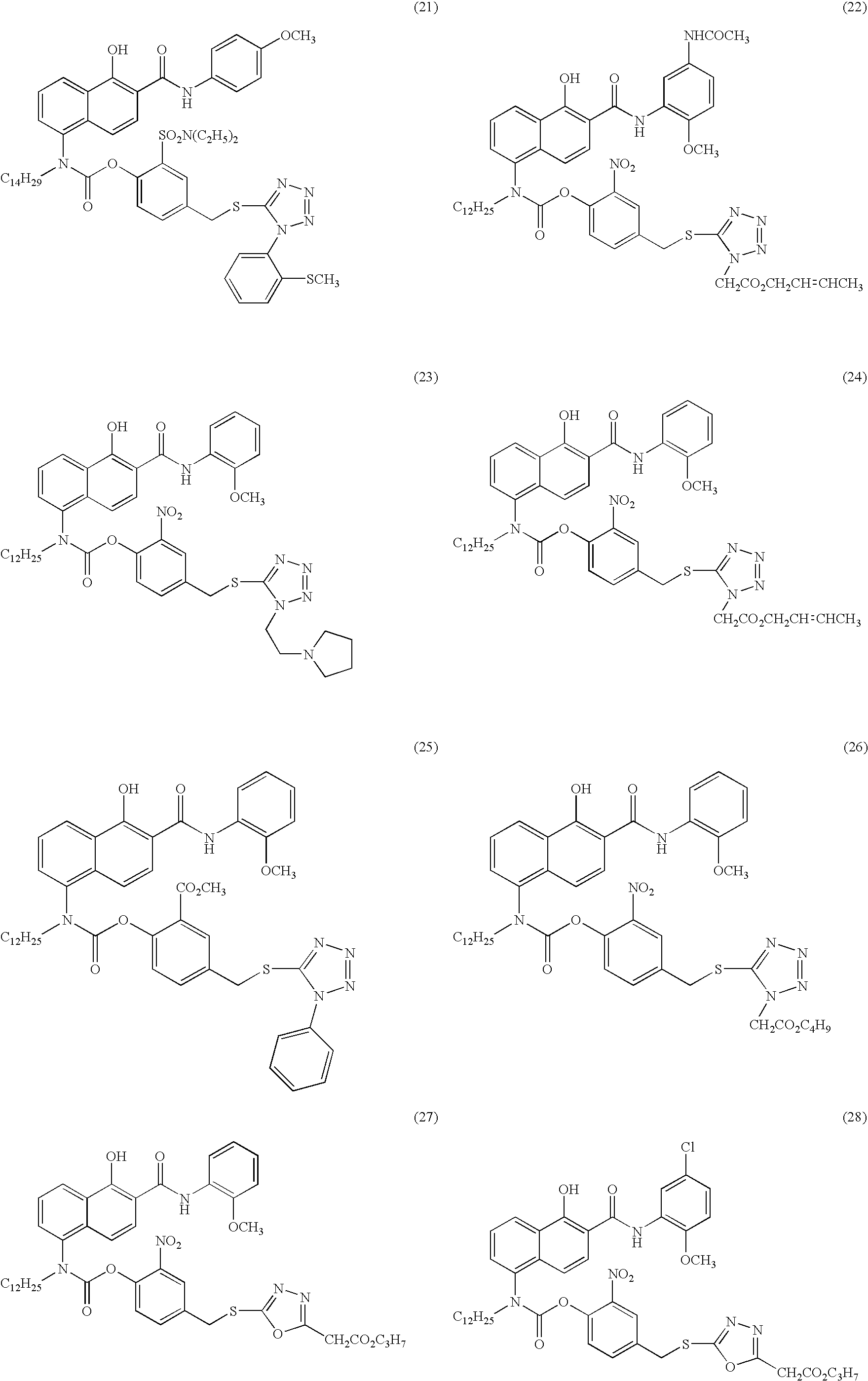

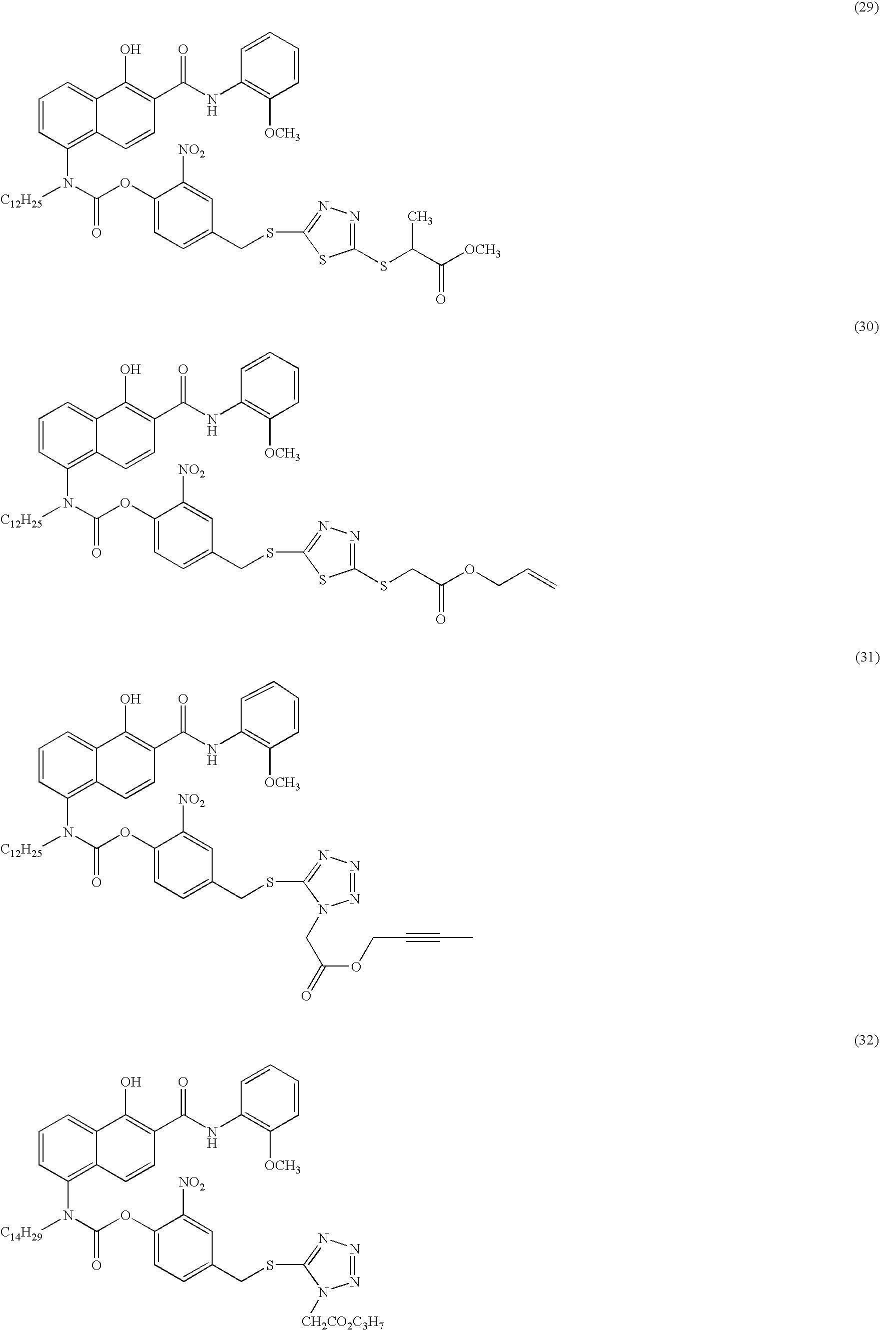

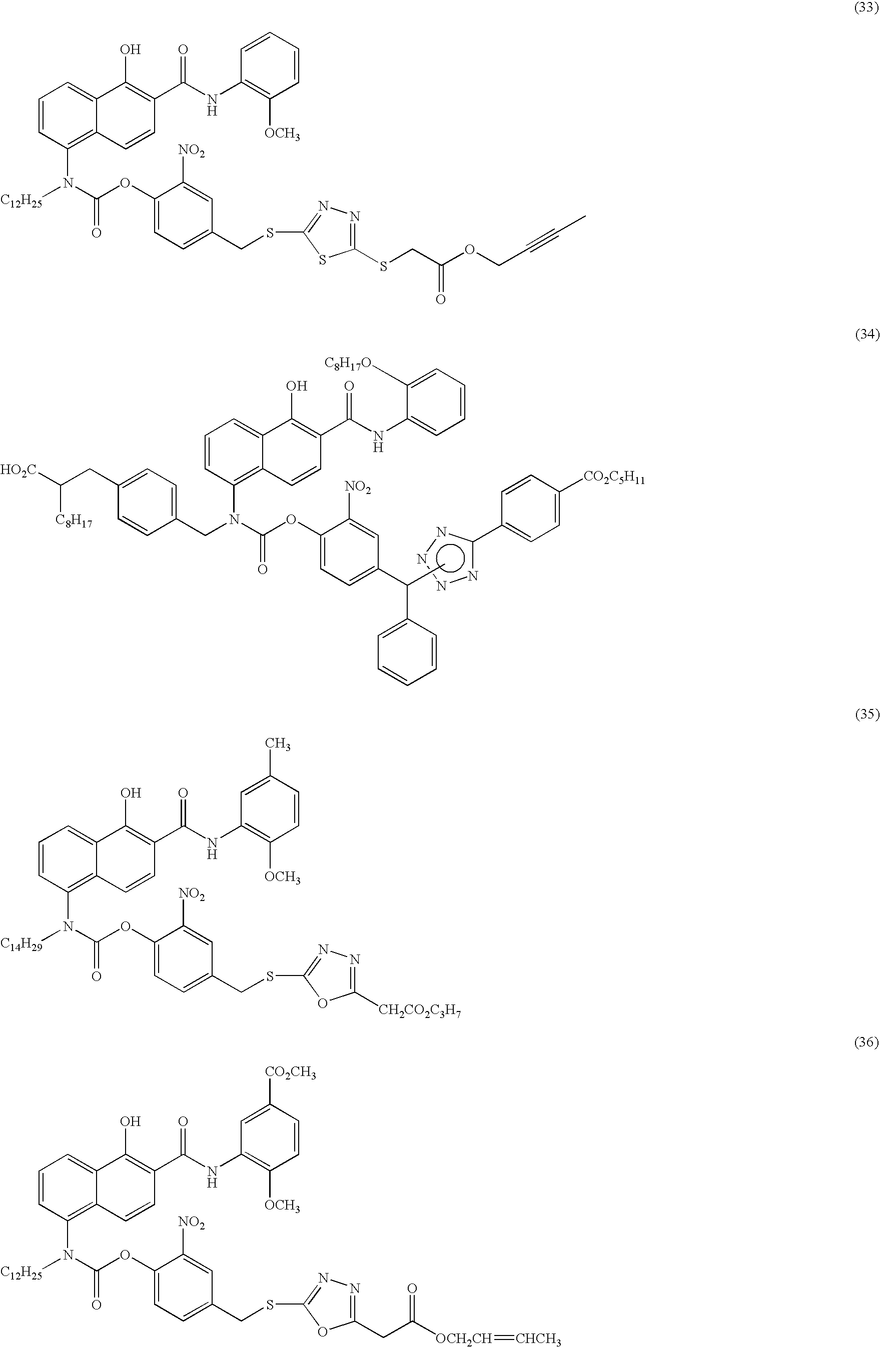

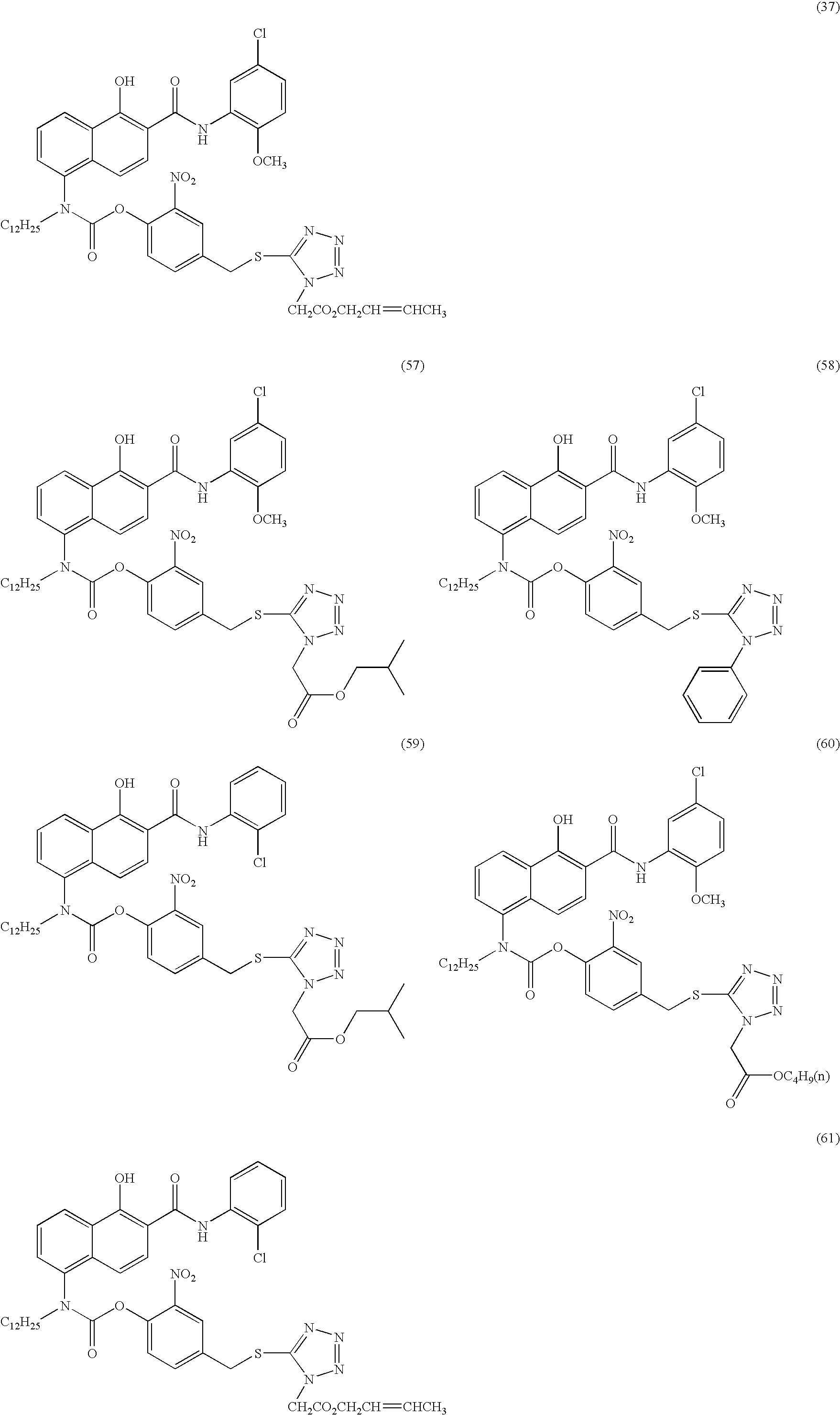

Specific examples of the compound represented by general formula (II) are set froth below, but the compounds represented by general formula (I) are not limited to these examples.

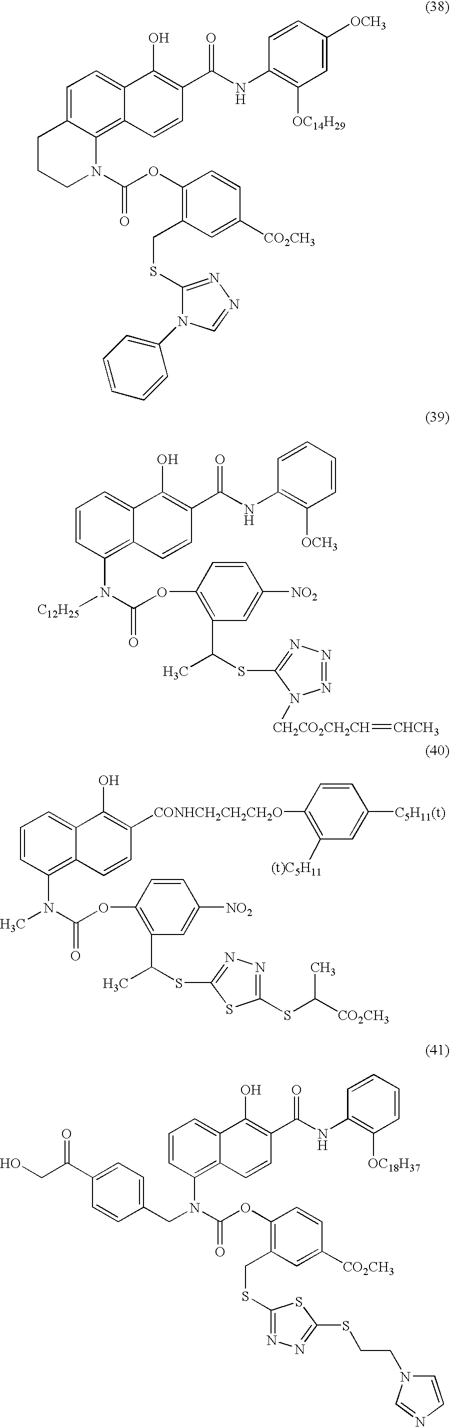

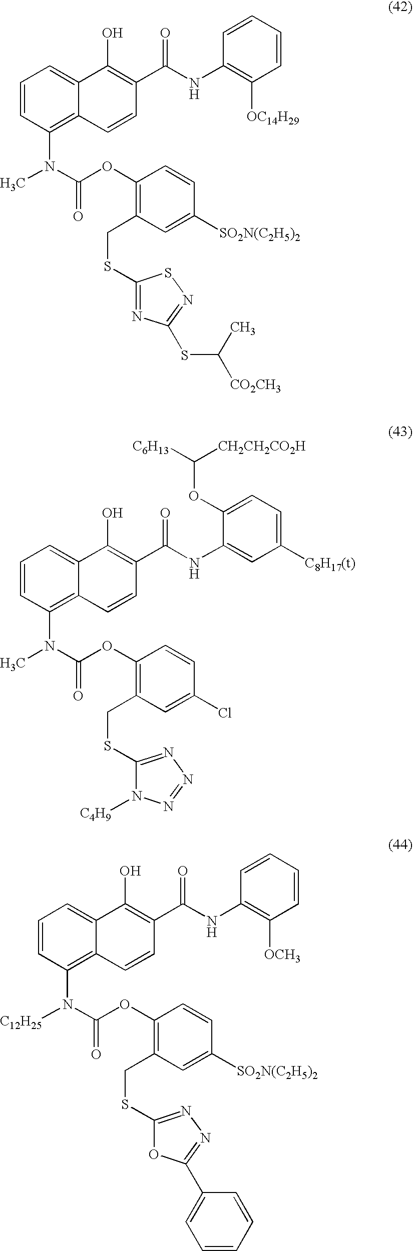

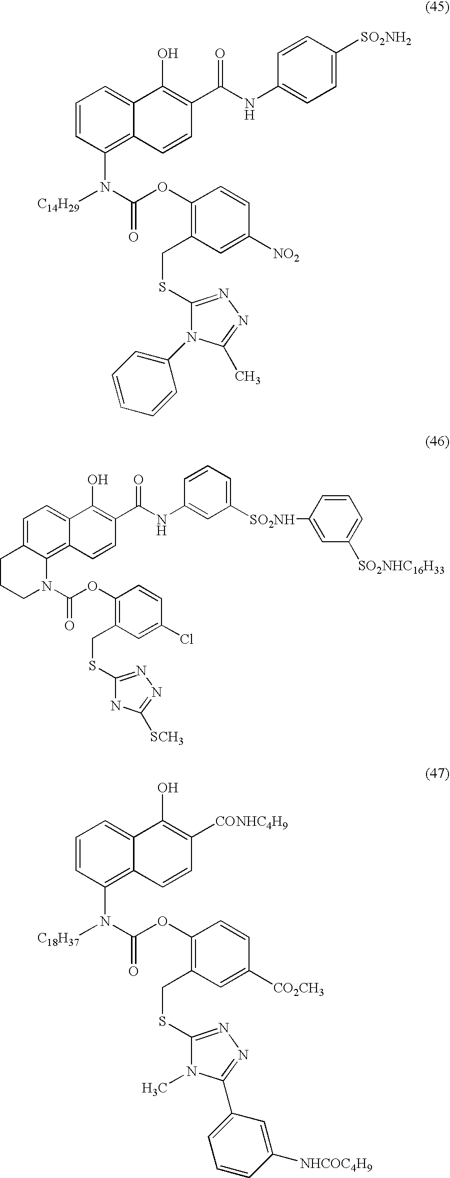

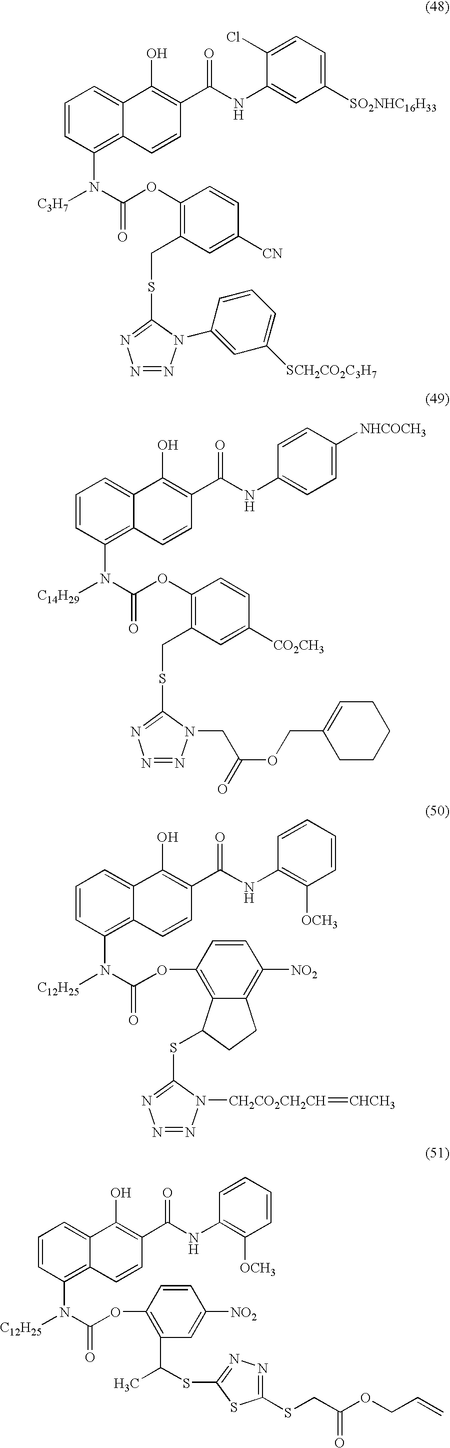

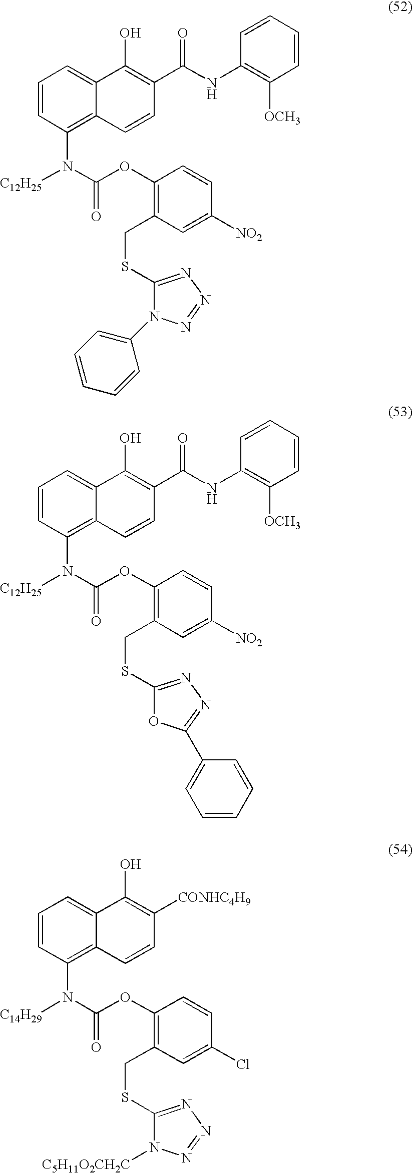

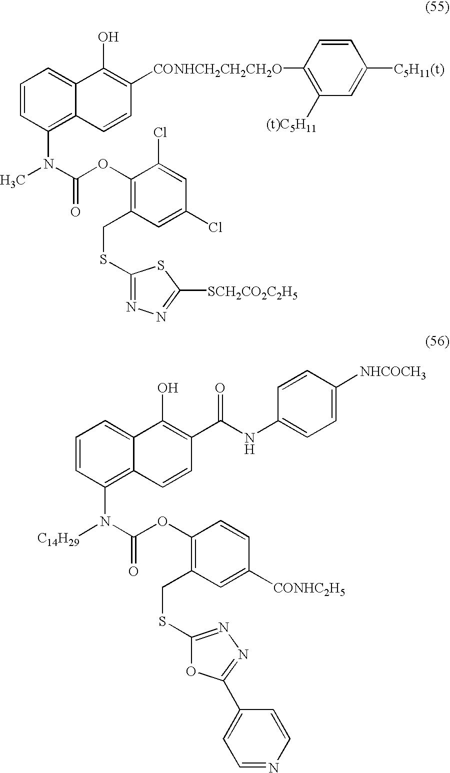

Specific synthetic methods of the couplers of the present invention will be described below.

Synthesis of the Coupler of Compound Example (24)

According to the following scheme, couplers, compound examples (24), were synthesized.

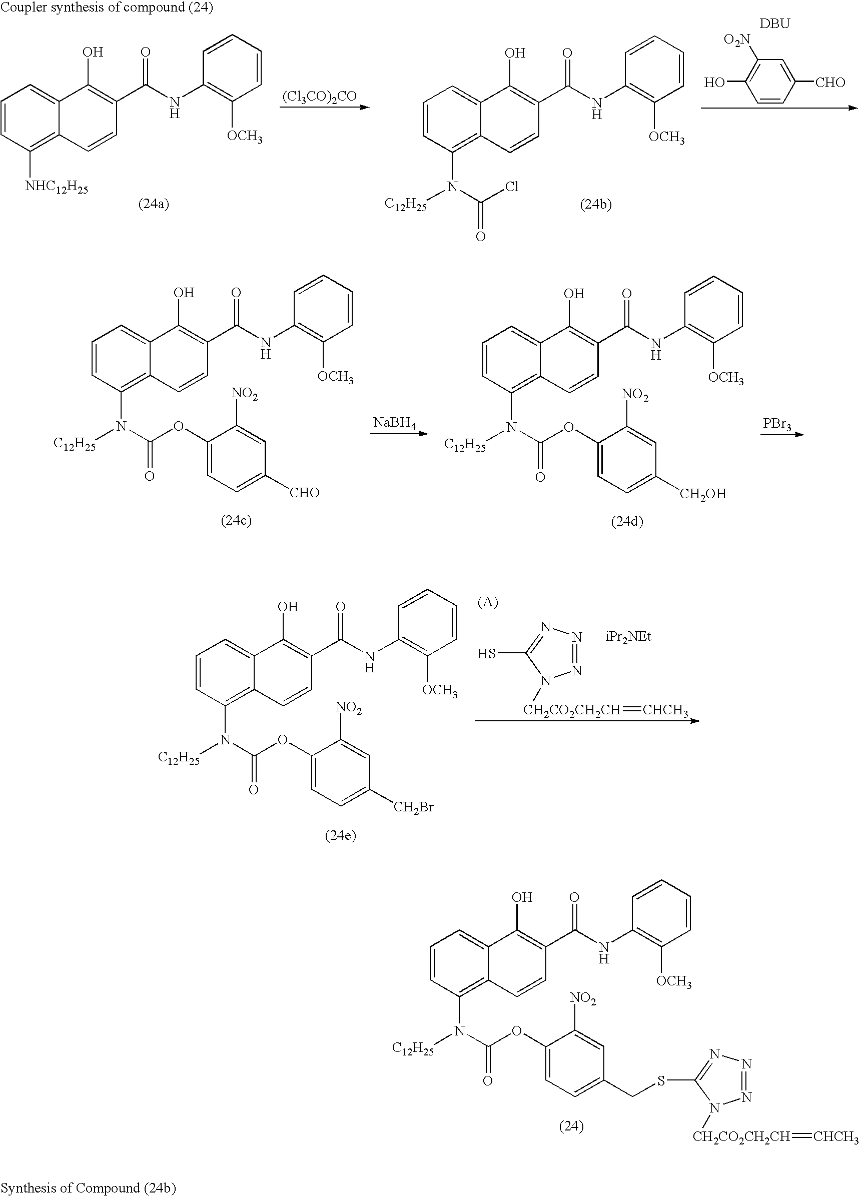

To 60 milliliter (hereinafter also referred to as “mL”) of an ethyl acetate solution containing compound 24a (log) prepared in the same method as that for compound (41b) disclosed in the specification of EP 950922 A1 and dimethylaniline (2.8 g), bis(trichloromethyl) carbonate (2.3 g) was added at 10° C. and the mixture was stirred for 2 hours. The reaction solution was poured into acetonitrile (50 mL)/1N aqueous hydrochloric acid (50 mL) and the resulting mixture was stirred for one hour. The crystals formed were filtered off, washed with acetonitrile, and then dried to yield compound 24b (10.2 g).

Synthesis of Compound (24c)

DBU (5.6 g) was added to a mixied solution of compound 24b (log) and 4-hydroxy-3-nitrobenzaldehyde (6.2 g) in toluene (80 mL) and THF (20 mL) and the resulting mixture was stirred at 80° C. under a nitrogen gas stream for two hours. The reaction solution was cooled to 30° C. and subsequently poured into ethyl acetate (100 mL)/1N aqueous hydrochloric acid (200 mL). The resulting mixture was subjected to liquid separation. The organic layer was washed with 5% aqueous sodium carbonate solution, dried on magnesium sulfate, and then concentrated under reduced pressure. The concentrated residue was purified by silica gel column chromatography (eluent: ethyl acetate/hexane=1/2) to yield compound 24c (9.9 g).

Synthesis of Compound (24d)

Sodium borohydride (0.95 g) was added to a mixed solution of compound 24c (9.5 g) in methanol (38 mL) and tetrahydrofuran (8 mL) at 10° C. and the resulting mixture was stirred for one hour. The reaction solution was poured into ethyl acetate (60 mL)/1N aqueous hydrochloric acid (120 mL). The organic layer was washed with water, dried on magnesium sulfate, and then concentrated under reduced pressure. The concentrated residue was purified by silica gel column chromatography (eluent: ethyl acetate/hexane=1/1) and then recrystallized from acetonitrile to yield compound 24d (8.4 g).

Synthesis of Compound (24e)

A solution of phosphorus tribromide (3.2 g) in dichloromethane (15 mL) was added drop-wise to a solution of compound 24d (8 g) in dichloromethane (35 mL) at 10° C. and the resulting mixture was stirred for four hours. The reaction solution was poured into ethyl acetate (200 mL)/1N aqueous hydrochloric acid (200 mL). The organic layer was washed with water, dried on magnesium sulfate, and then concentrated under reduced pressure. The concentrated residue was recrystallized from an ethyl acetate/acetonitrile system to yield compound 24e (7.4 g).

Synthesis of Compound (24)

A solution of compound 24e (7 g) in N,N-dimethylacetamide (20 mL) was added to a solution of mercaptotetrazole derivative A (3.1 g) and N,N-diisopropyl-N-ethylamine (1.8 g) in N,N-dimethylacetamide (30 mL) at 10° C. and the resulting mixture was stirred at 25° C. for two hours. The reaction solution was poured into ethyl acetate (100 mL)/1N aqueous hydrochloric acid (100 mL). The organic layer was washed with 5% aqueous sodium carbonate solution, dried on magnesium sulfate, and then concentrated under reduced pressure. The concentrated residue was purified by silica gel column chromatography (eluent: ethyl acetate/hexane=1/2) to yield 6.2 g of exemplified compound (24), identification of which was carried out by elemental analysis, NMR and Mass spectrum.

Synthesis of Coupler, Compound Example (53)

According to the following scheme, couplers, compound examples (53), were synthesized.

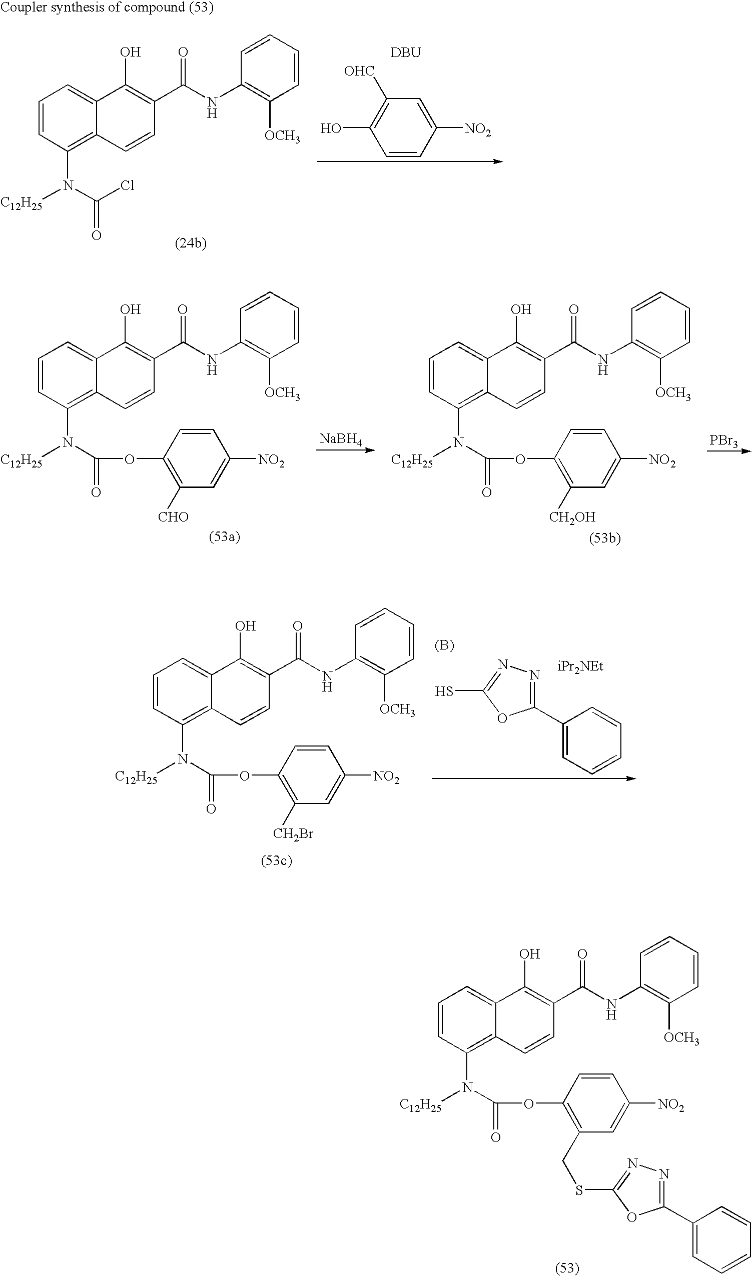

Synthesis of Compound (53a)

DBU (20 g) was added to a mixed solution of compound 24b (28 g) and 2-hydroxy-5-nitrobenzaldehyde (22 g) in toluene (220 mL) and THF (55 mL) and the resulting mixture was stirred at 80° C. under a nitrogen gas stream for four hours. The reaction solution was cooled to 30° C. and subsequently poured into ethyl acetate (300 mL)/1N aqueous hydrochloric acid (300 mL). The resulting mixture was subjected to liquid separation. The organic layer was washed with 5% aqueous sodium carbonate solution, dried on magnesium sulfate, and then concentrated under reduced pressure. The concentrated residue was purified by silica gel column chromatography (eluent: ethyl acetate/hexane=1/3) to yield compound 53a (26 g).

Synthesis of Compound (53b)

Sodium borohydride (2.7 g) was added to a mixed solution of compound 53a (26 g) in methanol (120 mL) and tetrahydrofuran (30 mL) at 10° C. and the resulting mixture was stirred for one hour. The reaction solution was poured into ethyl acetate (300 mL)/1N aqueous hydrochloric acid (300 mL). Organic layer was washed with water, dried on magnesium sulfate, and then concentrated under reduced pressure. The concentrated residue was purified by silica gel column chromatography (eluent: ethyl acetate/hexane=1/2) and then recrystallized from acetonitrile to yield compound 53b (16 g).

Synthesis of Compound (53c)

Phosphorus tribromide (6.4 g) was added to a solution of compound 53b (16 g) in dichloromethane (80 mL) at 10° C. and the resulting mixture was stirred for eight hours. The reaction solution was poured into ethyl acetate (300 mL)/1N aqueous hydrochloric acid (300 mL). The organic layer was washed with water, dried on magnesium sulfate, and then concentrated under reduced pressure. The concentrated residue was purified by silica gel column chromatography (eluent: ethyl acetate/hexane=1/3) to yield compound 53c (13.1 g).

Synthesis of Compound (53)

A solution of compound 53c (13 g) in N,N-dimethylacetamide (30 mL) was added to a solution of mercapto oxadiazole derivative B (6.3 g) and N,N-diisopropyl-N-ethylamine (4.6 g) in N,N-dimethylacetamide (60 mL) at 10° C. and the resulting mixture was stirred at 25° C. for two hours. The reaction solution was poured into ethyl acetate (200 mL)/1N aqueous hydrochloric acid (200 mL). Organic Layer was washed with 5% aqueous sodium carbonate solution, dried on magnesium sulfate, and then concentrated under reduced pressure. The concentrated residue was purified by silica gel column chromatography (eluent: ethyl acetate/hexane=1/3) to yield 9.1 g of exemplified compound (53), identification of which was carried out by elemental analysis, NMR and Mass spectrum.

The couplers represented by general formulas (I) and (II) of the present invention (hereinafter referred to as couplers of the present invention) may be used in any layer in a photosensitive material. That is, these couplers may be used in any of light-sensitive layers (a blue-, green- and red-sensitive layers, and interlayer effect-donating layers having different spectral sensitivity distributions from those of these main light-sensitive layers) and non-sensitive layers (e.g., a protective layer, yellow filter layer, interlayer and antihalation layer). When a layer sensitive to one color is divided into two or more layers having different speeds, couplers may be added to any or all of highest-, lowest- and medium-speed layers. Couplers are preferably added to a light-sensitive layer and/or a non-sensitive layer adjacent to the light-sensitive layer.

The use amount of the couplers of the present invention to a photosensitive material is 5×10⁻⁴ to 2 g/m², preferably 1×10⁻³ to 1 g/m², and more preferably 5×10⁻³ to 5×10⁻¹ g/m².

The couplers of the present invention may be added to a photosensitive material by using any known dispersion method according to compounds. For example, if a compound is alkali-soluble, the compound may be added in the form of an aqueous alkaline solution or in the form of a solution prepared by dissolving the compound in an organic solvent miscible with water. Alternatively, the compound may be added by an oil-in-water dispersion method using a high-boiling organic solvent or by a solid dispersion method.

The couplers of the present invention may be used singly, or two or more couplers may be used together. The same compound can also be used in two or more layers. Furthermore, the couplers of the present invention may be used together with other known compounds which are capable of releasing a photographically useful group or a precursor thereof or may be employed while being present together with couplers or other additives described later. These are chosen appropriately depending on the performance which the photosensitive material is required to have.

The specific photographic speed of the color photosensitive material of the present invention is preferably not less than 640, and more preferably not less than 800. However, for exhibiting the effect of the present invention, it is particularly preferable that the color photosensitive material be used at a specific photographic speed of 1000 or more.

The content of silver contained in the color photosensitive material of the present invention is preferably 6 to 10 g/m², and more preferably 6 to 9 g/m². The “content of silver” used herein is a content of all silver including silver halide, metallic silver and the like in terms of silver. Some methods are known to analyze the content of silver in a photosensitive material and any method may be employed. For example, elemental analysis using a fluorescent X-ray method is simple and easy.

The film thickness of the color photosensitive material of the present invention represents the total sum in thickness of all hydrophilic colloid layers on the side of the light-sensitive silver halide emulsion layer on a support. The film thickness is preferably not less than 22 μm, and more preferably not less than 23 μm and not more than 27 μm. The film thickness is measured by photographing a section under magnification through a scanning electron microscope.

It is preferable that the color photosensitive material for use in the present invention has a unit red-sensitive silver halide emulsion layer, unit green-sensitive silver halide emulsion layer and unit blue-sensitive silver halide emulsion layer on a support and each of the unit color sensitive layers be constituted of two or more silver halide emulsion layers differing in speed. At least 60% of the total projected area of the silver halide grains contained at least one of the emulsion layers is accounted for by tabular silver halide grains having an aspect ratio of not less than 5.0. The aspect ratio is preferably not less than 8.0, more preferably not less than 10.0, and most preferably not less than 12.0. The upper limit of the aspect ratio is preferably 200. The term “aspect ratio” refers to a value obtained by dividing the equivalent circle diameter of a grain by the thickness of the grain. Too small an aspect ratio adversely results in a low speed, whereas too large an aspect ration adversely results in reduction in speed and deteriorations in pressure resistance and storage stability, due to intrinsic desensitization caused by a dye, which is not preferable.

The tabular silver halide grains for use in the present invention are described in detail below. The composition of the tabular silver halide emulsion for use in the present invention is not particularly limited. However, a silver iodobromide or silver chloroiodobromide tabular grain emulsion is preferably used.

In the present invention, a tabular silver halide grain (hereinafter referred also to as tabular grain) refers to a silver halide grain having two opposing, parallel (111) main planes. A tabular grain of the present invention has one twin plane or two or more parallel twin planes. A twin plane denotes a (111) face on both sides of which ions at all lattice points have a mirror image relationshipship.

When viewed from above, the tabular grain has a triangular shape, a hexagonal shape or a circular shape like a rounded triangular or hexagonal shape and also has mutually parallel external surfaces.

The equivalent circle diameter and thickness in a tabular grain are determined by a method in which a thickness and a diameter (equivalent circle diameter) in a circle having an area equal to the projected area of each individual grain are determined by taking a transmission electron micrograph by the replica method. In this method, the thickness is calculated from the length of a shadow of the replica.

A silver halide grain for use in the present invention preferably has a equivalent circle diameter of 0.2 to 20 μm, more preferably 0.3 to 15 μm, and still more preferably 0.6 μm to 10.0 μm.

The equivalent spherical diameter of the silver halide grain is preferably not less than 0.2 μm and not more than 5.0 μm, and more preferably not less than 0.6 μm and not more than 4 μm. The “equivalent spherical diameter” used herein means the diameter of a sphere having the same volume as that of each individual tabular grain.

The emulsion of the present invention is preferably monodisperse. The variation coefficient of equivalent sphere diameters of all the silver halide grains of the present invention is preferably 30 mol % or less, more preferably 25% or less. For the case of tabular grains, the variation coefficient of equivalent circle diameter is also important. The variation coefficient of the equivalent circle diameters of all the silver halide grains of the present invention is preferably 30% or less, more preferably 25% or less. The variation coefficient of thickness of tabular grains is preferably 30% or less, more preferably 25% or less. The coefficient of variation is a value obtained by dividing a standard deviation of distribution of the equivalent circle diameters of individual silver halide grains by an average equivalent circle diameter or by dividing a standard deviation of distribution of the thickness of individual tabular grains by an average thickness, and multiplying the resultant quotient by 100.

Also, the distance between twin planes of the tabular grains contained in the emulsion of the present invention is preferably 0.012 μm or less as described in U.S. Pat. No. 5,219,720. The ration of (111) main plane distance/twin plane distance may be 15 or more, as described in JP-A—5-249585, depending on purposes.

The variation coefficient in distance between twin planes of all tabular grains in the emulsion of the present invention is preferably 3 to 25%, more preferably 3 to 20%, and still more preferably 3 to 15%. The variation coefficient in distance between twin planes is a value obtained by dividing the dispersion (standard deviation) in the thickness of individual tabular grains by the average twin plane distance, and multiplying the resultant quotient by 100. When the variation coefficient of twin plane distance distribution with respect to all the tabular grains exceeds 25%, it is unfavorable from the viewpoint of intergrain homogeneity. On the other hand, it is difficult to prepare an emulsion having a variation coefficient of less than 3%.

In the present invention, the silver iodide content in a silver halide grain, based on the total silver in the grain, is preferably not less than 0.5% and not more than a solid dissolution limit, and more preferably not less than 1 mol % and not more than 20 mol %. The silver chloride content is preferably at least 0 mol % and not more than 10 mol % based on the total silver in the grain.

In the present invention, an outermost layer of a silver halide grain is defined as a silver halide layer that includes a surface of the silver halide grain and extends to a depth of 5 nm from the surface of the silver halide grain. An outermost layer in a main plane region of a tabular grain is defined as an internal portion of the grain, and this portion exists in a plane apart by at least 10 nm from the periphery of the main plane, and extends to a depth of 5 nm. On the other hand, an outermost layer in a side face region is defined as an internal portion of the grain, and this portion exists in a plane apart by at least 10 nm from the periphery of the side face of the grain, and extends to a depth of 5 nm.

In the present invention, the silver iodide content in an outermost layer of a silver halide grain refers to an arithmetic average value of the silver iodide contents measured at five points of the outermost layer by the method described previously. In the measurement of the silver iodide content in an outermost layer in a main plane region, the intervals between the five measurement points are determined so as to be not less than 1/10 the equivalent circular diameter of the grain to be measured. On the other hand, in the measurement in an outermost layer in a side face region, the intervals between the five measurement points are determined so as to be not less than 1/10 the thickness of the grain to be measured.

Each of the silver iodide contents in an outermost layer of a main plane and side face regions of a silver halide grain is measured by a method described below.

The measurement is carried out by cutting a tabular grain in round perpendicularly to a main plane thereof to form a cross section so that two main plane regions and two side face regions of an outermost layer may be present in the cross section, and irradiating the cut grain with electron beams from the cross sectional direction. Specifically, grains isolated from an emulsion or photosensitive material by centrifugation are applied to a triacetylcellulose support and covered with a resin. An approx. 50 nm thick section is cut from this specimen by means of an ultramicrotome, and mounted on a copper mesh overlaid with a support membrane.

The measurement of silver iodide content is carried out by performing a point analysis, with a spot diameter reduced to 2 nm or less, of given parts of these grains by means of an analytical electron microscope. The silver iodide content can be determined by treating silver halide grains of known contents in the above manner and measuring the ratio of Ag intensity to I intensity thereof in advance, to thereby obtain a calibration curve. As an analytical beam source of an analytical electron microscope, a field emission type electron gun of high electron density is more suitable than a thermoelectronic one. The halide composition of minute parts can be easily analyzed by reducing the spot diameter to 1 nm or less.

When cutting a tabular grain in round perpendicularly to a main plane thereof, there are several positions at which the tabular grain can be cut. The tabular grain may be cut in round at any position if the method mentioned above can be conducted with no problems.

It is preferable for the silver halide grain of the present invention that at least 50% of the projected area of the total silver halide grains contained in an emulsion layer is accounted for by tabular silver halide grains meeting a relationship I₂/I₁<1 where the silver iodide content in the outermost layer is indicated by I₁ mol % in a main plane region and by I₂ mol % in a side face region.

Furthermore, the relationship between I₁ and I₂ is preferably I₂/I₁<0.8, more preferably I₂/I₁<0.6, and most preferably I₂/I₁<0.4.

I₁ excludes 0 mol %, and preferably is less than 30 mol %, more preferably 8 to 20 mol %. On the other hand, I₂ includes 0 mol % and preferably is less than 7 mol %.

The inventors conducted extensive and intensive investigations. As a result, the inventors found that the above-described silver halide grain used in the present invention can surprisingly improve the sharpness and color reproducibility through its combination with the compound of the present invention described previously.

Next, a description will be made to methods for preparing the silver halide emulsion of the present invention.

The preparation process of the present invention comprises (a) a base grain forming process and a subsequent grain forming process (process (b)). Process (b) may be any of (b1) a step of introducing dislocation, (b2) a step of introducing dislocation at a corner portion restrictedly, and (b3) an epitaxial junction step. Process (b) may contain either one step or a combination of two or more steps.

First, (a) base grain forming process will be described. The silver amount used for a base grain formation may be any value with respect to the total silver amount finally used for grain formation, but is preferably 20% to 95%, more preferably 30% to 90%. The average content of iodine relative to the amount of silver in the base portion is preferably not less than 0 mol % and not more than 30 mol %, more preferably not less than 0 mol % and not more than 25 mol %, and much more preferably not less than 0 mol % and not more than 20 mol %. The base portion may have a core-shell structure, if necessary.

The growth of base grain may be conducted by a double jet method in which an aqueous silver salt solution and an aqueous halide solution are added simultaneously, but in this case, satisfactory stirring in a reaction vessel and dilution of the concentrations of the addition solutions are preferable, in order to prevent introduction of growth dislocation due to unevenness in the iodide ion distribution. It is also preferably to raise pAg during growth. At this time, the pAg is preferably not less than 7.0, more preferably not less than 7.4.

A method is more preferable in which an AgI fine grain emulsion prepared outside the reaction vessel is added to the same timing when an aqueous silver salt solution and an aqueous halide salt solution are added. In this case, the temperature of growth is preferably not less than 50° C. and not more than 90° C., and more preferably no less than 60° C. and not more than 85° C. The AgI fine grain emulsion may be that prepared in advance. Alternatively, an AgI fine grain emulsion may be added while being prepared continuously. In this case, with respect to the preparation method, JP-A-10-43570 is available as a reference.

The average grain size of the AgI emulsion to be added is not less than 0.01 μm and not more than 0.1 μm, and preferably not less than 0.02 μm and not less than 0.08 μm. The iodine composition of the base grains can be varied by adjusting the amount of the AgI emulsion to be added.

It is also possible to add silver iodobromide fine grains instead of adding an aqueous silver salt solution and an aqueous halide salt solution. In this case, base grains having a desired iodine composition are obtained by rendering the iodine amount of the fine grains equal to the iodine amount of the desired base grains. Although the silver iodobromide fine grains may be those prepared in advance, it is more preferable that the fine grains may be added while being prepared continuously. The average size of the silver iodobromide fine grains to be added is not less than 0.005 μm and not more than 0.05 μm, and preferably not less than 0.01 μm and not more than 0.03 μm. The temperature during the growth is not less than 60° C. and not more than 90° C., and preferably not less than 70° C. and not more than 85° C.

Next, step (b) will be described.

First, step (b1) will be described. Step (b1) comprises a first shell step and a second shell step. A first shell is formed on the surface of the base grain described above. The ratio of the first shell is not less than 1% and not more than 30% of the total silver amount finally used in the grain formation, and the average silver iodide content of the first shell is not less than 20 mol % and not more than 100 mol %. More preferably, the ratio of the first shell is not less than 1% and not more than 20% of the total silver amount, and the average silver iodide content of the first shell is preferably not less than 25 mol % and not more than 100 mol %. The growth of the first shell on a base grain is basically performed by the addition of an aqueous silver nitrate solution and an aqueous halogen solution containing both iodide and bromide by the double-jet method, or by the addition of an aqueous silver nitrate solution and an aqueous halogen solution containing iodide by the double-jet method. Alternatively, an aqueous halogen solution containing iodide is added by the single-jet method.

Any of these methods may be applied, and any combination thereof may also be applied. As is clear from the average silver iodide content of the first shell, silver iodide can also precipitate in addition to a silver iodobromide mixed crystal during the formation of the first shell. In either case, the silver iodide vanishes and entirely changes into a silver iodobromide mixed crystal during the formation of the second shell.

A preferable method for the formation of the first shell is a method comprising adding a silver iodobromide or silver iodide fine grain emulsion, ripening and dissolving. Another preferable method is a method comprising adding a silver iodide fine grain emulsion, followed by the addition of an aqueous silver nitrate solution or addition of aqueous silver nitrate solution and an aqueous halogen solution. In this case, the dissolution of the silver iodide fine grain emulsion is accelerated by the addition of the aqueous silver nitrate solution. The silver amount of the added silver iodide fine grain emulsion is used to obtain the first shell, and the silver iodide content thereof is assumed to be 100 mol %. The amount of silver of the added aqueous silver nitrate solution is used to calculate the second shell. It is preferable that the silver iodide fine grain emulsion is added abruptly.

“To add a silver iodide fine grain emulsion abruptly adding” is to add the silver iodide fine grain emulsion preferably within 10 minutes, and more preferably, within 7 minutes. This condition may vary in accordance with, e.g., the temperature, pBr, and pH of the system to which the emulsion is added, the type and concentration of a protective colloid agent such as gelatin, and the presence/absence, type, and concentration of a silver halide solvent. However, a shorter addition time is more preferable as described above. During the addition, it is preferable that an aqueous solution of silver salt such as silver nitrate is not substantially added. The temperature of the system during the addition is preferably not less than 40° C. and not more than 90° C., and most preferably, not less than 50° C. and not more than 80° C.

A silver iodide fine grain emulsion essentially need only be silver iodide and can contain silver bromide and/or silver chloride as long as a mixed crystal can be formed. The emulsion is preferably 100% silver iodide. The crystal structure of silver iodide can be a β body, a γ body, or, as described in U.S. Pat. No. (hereinafter referred to as “U.S.P.”) 4,672,026, an α body or an α body similar structure. In the present invention, the crystal structure is not particularly restricted but is preferably a mixture of β and γ bodies, and more preferably, a β body. The silver iodide fine grain emulsion can be either an emulsion formed immediately before addition described in U.S. Pat. No. 5,004,679, or an emulsion subjected to a regular washing step. In the present invention, an emulsion subjected to a regular washing step is used. The silver iodide fine grain emulsion can be readily formed by a method described in, e.g., aforementioned U.S. Pat. No. 4,672,026. A double-jet addition method using an aqueous silver salt solution and an aqueous iodide salt solution in which grain formation is performed with a fixed pI value is preferred. The pI is the logarithm of the reciprocal of the I⁻ ion concentration of the system. The temperature, pI, and pH of the system, the type and concentration of a protective colloid agent such as gelatin, and the presence/absence, type, and concentration of a silver halide solvent are not particularly limited. However, a grain size of preferably 0.1 μm or less, and more preferably, 0.07 μm or less is convenient for the present invention. Although the grain shapes cannot be perfectly specified because the grains are fine grains, the variation coefficient of a grain size distribution is preferably 25% or less. The effect of the present invention is particularly remarkable when the variation coefficient is 20% or less. The sizes and the size distribution of the silver iodide fine grain emulsion are obtained by laying silver iodide fine grains on a mesh for electron microscopic observation and directly observing the grains by a transmission method instead of a carbon replica method. This is because measurement errors are increased by observation done by the carbon replica method since the grain sizes are small. The grain size is defined as the diameter of a circle having an area equal to the projected surface area of the observed grain. The grain size distribution also is obtained by using this equivalent-circle diameter of the projected surface area. In the present invention, the most effective silver iodide fine grains have a grain size of not more than 0.06 μm and not less than 0.02 μm and a variation coefficient of grain size distribution of 18% or less.

After the grain formation described above, a silver iodide fine grain emulsion is preferably subjected to regular washing described in, e.g., U.S. Pat. No. 2,614,929, and adjustments of the pH, the pI, the concentration of a protective colloid agent such as gelatin, and the concentration of the contained silver iodide are performed. The pH is preferably 5 to 7. The pI value is preferably the one at which the solubility of silver iodide is a minimum or the one higher than that value. As the protective colloid agent, a common gelatin having an average molecular weight of approximately 100,000 is preferably used. A low-molecular-weight gelatin having an average molecular weight of 20,000 or less also is preferably used. It is sometimes convenient to use a mixture of gelatins having different molecular weights. The gelatin amount is preferably 10 to 100 g, and more preferably, 20 to 80 g per kg of an emulsion. The silver amount is preferably 10 to 100 g, and more preferably, 20 to 80 g, in terms of silver atoms, per kg of an emulsion. As the gelatin amount and/or the silver amount, it is preferable to choose values suited to abrupt addition of the silver iodide fine grain emulsion.

The silver iodide fine grain emulsion is usually dissolved before being added. During the addition it is necessary to sufficiently raise the efficiency of stirring of the system. The rotating speed of stirring is preferably set to be higher than usual. The addition of an antifoaming agent is effective to prevent the formation of foam during the stirring. More specifically, an antifoaming agent described in, e.g., examples of U.S. Pat. No. 5,275,929 is used.

As a more preferable method for forming the first shell, it is possible to form a silver halide phase containing silver iodide while causing iodide ions to generate abruptly by using an iodide ion releasing agent described in U.S. Pat. No. 5,496,694, instead of the conventional iodide ion supply method (the method of adding free iodide ions).

The iodide ion-releasing agent releases iodide ions through its reaction with an iodide ion release control agent (a base and/or a nucleophilic reagent). Preferable examples of this nucleophilic reagent used include the following chemical species, e.g., hydroxide ion, sulfite ion, hydroxylamine, thiosulfate ion, metabisulfite ion, hydroxamic acids, oximes, dihydroxybenzenes, mercaptanes, sulfinate, carboxylate, ammonia, amines, alcohols, ureas, thioureas, phenols, hydrazines, hydrazides, semicarbazides, phosphines and sulfides.

The release rate and timing of iodide ions can be controlled through the control of the concentration and addition method of a base or a nucleophilic reagent or the control of the temperature of the reaction solution. A preferable base is alkali hydroxide.

To generate iodide ions abruptly, the concentrations of the iodide ion-releasing agent and iodide ion release control agent are preferably 1×10⁻⁷ to 20 M, more preferably, 1×10⁻⁵ to 10 M, further preferably, 1×10⁻⁴ to 5 M, and particularly preferably, 1×10⁻³ to 2 M.

If the concentration exceeds 20 M, the addition amounts of the iodide ion-releasing agent and iodide ion release control agent having large molecular weights adversely become too great compared to the capacity of the grain formation vessel.

If the concentration is less than 1×10⁻⁷ M, the iodide ion-releasing reaction rate adversely becomes too low, and this makes it difficult to abruptly generate the iodide ion-releasing agent.

The temperature is preferably 30 to 80, more preferably, 35 to 75° C., and particularly preferably, 35 to 60° C.

At high temperatures exceeding 80° C., the iodide ion-releasing reaction rate generally becomes extremely high. At low temperatures below 30° C., the iodide ion-releasing reaction temperature generally becomes extremely low. Both cases are undesirable because the use conditions are restricted.

When a base is used to release iodide ions, a change in the solution pH can also be used. If this is the case, the pH range for controlling the rate and timing of releasing iodide ions is preferably 2 to 12, more preferably 3 to 11, and particularly preferably 5 to 10. Most preferably, the pH after adjustment is 7.5 to 10.0. Under a neutral condition of pH 7, hydroxide ions having a concentration determined by the ion product of water function as control agents.

A nucleophilic reagent and a base can be used jointly. When this is the case, the pH can be controlled within the above range to thereby control the rate and timing of releasing iodide ions.

When iodine atoms are to be released in the form of iodide ions from the iodide ion-releasing agent, these iodine atoms may be entirely released or may partially remain without decomposition.

The second shell is formed on the above-described tabular grain provided with the first shell. The ratio of the second shell is not less than 10 mol % and not more than 40 mol % of the total silver amount finally used in the grain formation, and the average silver iodide content of the second shell is not less than 0 mol % and not more than 5 mol %. More preferably, the ratio of the second shell is not more than 15 mol % and not less than 30 mol % of the total silver amount, and the average silver iodide content of the second shell is not less than 0 mol % and not more than 3 mol %. The growth of the second shell on a base and a tabular grain having the first shell can be performed either in a direction to increase the aspect ratio of the tabular grain or in a direction to decrease it. The growth of the second shell is basically performed by addition of an aqueous silver nitrate solution and an aqueous halogen solution containing bromide using the double-jet method. Alternatively, it is also possible to add an aqueous silver halogen solution containing bromide and then add an aqueous silver nitrate solution by the single-jet method. The temperature and pH of the system, the type and concentration of a protective colloid agent such as gelatin, and the presence/absence, type, and concentration of a silver halide solvent may vary over a broad range. With respect to pBr, the pBr at the end of the formation of the second shell layer is preferably higher than that in the initial stages of the formation of that layer. Preferably, the pBr in the initial stages of the formation of the second shell is no more than 2.9, and the pBr at the end of the formation of the second shell is not less than 1.7. More preferably, the pBr in the initial stages of the formation of the second shell is not more than 2.5, and the pBr at the end of the formation of the second shell is not less than 1.9. Most preferably, the pBr in the initial stages of the formation of the second shell is not more than 2.3 and not less than 1 and the pBr at the end of the formation of the second shell is not less than 2.1 and not more than 4.5.

It is preferable that there are dislocation lines in the portion of step (b1).

The dislocation lines of tabular grains can be observed by a direct method using a transmission electron microscope, described in J. F. Hamilton, Phot. Sci. Eng., 11,57,(1967) and T. Shiozawa, J. Soc. Phot. Sci. Japan, 35, 213 (1972), for example. Specifically, silver halide grains taken out from the emulsion with care so as not to apply strong pressure to the grains to generate new dislocation lines are put on a mesh for electron microscope observation. Then, the sample is observed by transmission electron radiography in the state where the sample is cooled to prevent damage (e.g., printout) by electron beam, are observed by the transmission method. The greater the thickness of the above grains, the more difficult the transmission of electron beams. Therefore, the use of an electron microscope of high voltage type (at least 200 kV on the grains of 0.25 μm in thickness) is preferred for ensuring clearer observation.

The thus obtained photograph of grains enables determining the position and number of dislocation lines in each grain viewed in the direction perpendicular to the main planes. The dislocation lines are preferably present in the vicinity of the edge portion of a tabular grain. The vicinity of the edge portion means the peripheral portion (edge portion) of the six sides of a tabular grain and inner portion thereof, i.e., the portion grown in step (b1). The number of dislocation lines present in the edge portion is preferably at least 10 per grain on the average and more preferably at least 20 per grain on the average. When dislocation lines are densely present or when dislocation lines are observed in the state of crossing each other, it happens that the number of dislocation lines per grain cannot accurately be counted. However, in this instance as well, rough counting on the order of, for example, 10, 20 or 30 dislocation lines can be effected, so that a clear distinction can be made from the presence of only a few dislocation lines. The average number of dislocation lines per grain is determined by counting the number of dislocation lines of each of at least 100 grains and calculating a number average thereof.

Next, step (b2), restricted introduction of dislocation to corner portion, will be described.

Step (b2) includes the following embodiments: as a first embodiment, a method comprising dissolving only the vicinities of apexes with iodide ions; as a second embodiment, a method comprising adding a silver salt solution and an iodide salt solution simultaneously; as a third embodiment, a method comprising substantially dissolving only the vicinities of apexes with a silver halide solvent; and as a forth embodiment, a method via halogen conversion.

The first embodiment, the method of dissolving with iodide ions will be described below.

When iodide ions are added to base grains, the vicinity of each apex portion of the base grains is dissolved and the grains are somewhat rounded. When, subsequently, a silver nitrate solution and a bromide solution, or a silver nitrate solution and a mixed solution comprising a bromide solution and an iodide solution are added simultaneously, the grains further grow and dislocation is introduced in the vicinities of the apexes. With respect to this method, JP-A's-4-149541 and 9-189974 are available as references.

For attaining an effective dissolution according to the present embodiment, it is preferable that when the value obtained by multiplying, by 100, the quotient resulting from dividing the total mol number of the iodide ions by the total mol number of the silver in the base grains is let be I₁₀₂ (mol %), the total amount of the iodide ions to be added in this embodiment satisfies the condition in which (I₁₀₂-I₁₀₁) is not less than 0 and not more than 8, and more preferably not less than 0 and not more than 4, with respect to the silver iodide content of the base grains I₁₀₁ (mol %).

The lower the concentration of the iodide ions to be added in this embodiment, the more preferable. Specifically, the concentration is preferably 0.2 mol/L or less, and more preferably 0.1 mol/L or less.

The pAg during the addition of iodide ions is preferably 8.0 or more, and more preferably 8.5 or more.

Following the dissolution of the apex portions of the base grains by the addition of iodide ion to the base grains, the grains are further grown so that dislocation is introduced in the vicinities of the apexes by the sole addition of a silver nitrate solution or the simultaneous addition of a silver nitrate solution and a bromide solution or addition of silver nitrate solution and a mixed solution comprising a bromide solution and an iodide solution.

The second embodiment, the method comprising adding a silver salt solution and an iodide salt solution simultaneously will be described below. By rapidly adding a silver salt solution and an iodide salt solution to base grains, it is possible to epitaxially generate silver iodide or a silver halide having a high silver iodide content at apex portions of the grains. At this time, the addition rates of the silver salt solution and the iodide salt solution are preferably 0.2 min or more and 0.5 min or less, more preferably 0.5 min or more and 2 min or less. This method is disclosed in JP-A-4-149541 and therefore the publication is available as a reference.

Following the dissolution of the apex portions of the base grains by the addition of iodide ion to the base grains, the grains are further grown so that dislocation is introduced in the vicinities of the apexes by the sole addition of a silver nitrate solution or the simultaneous addition of a silver nitrate solution and a bromide solution or a silver nitrate solution and a mixed solution comprising a bromide solution and an iodide solution.

The third embodiment, the method using a silver halide solvent will be described below.

When a silver halide solvent is added to a dispersion medium containing base grains and then a silver salt solution and an iodide salt solution are added simultaneously, silver iodide or a silver halide having a high silver iodide content preferentially grows at apex portions of the base grains dissolved with the silver halide solvent. In this operation, it is not necessary to add the silver salt solution or the iodide salt solution rapidly. This method is disclosed in JP-A-4-149541 and therefore the publication is available as a reference.

Following the dissolution of the apex portions of the base grains by the addition of iodide ion to the base grains, the grains are further grown so that dislocation is introduced in the vicinities of the apexes by the sole addition of a silver nitrate solution or the simultaneous addition of a silver nitrate solution and a bromide solution or a silver nitrate solution and a mixed solution comprising a bromide solution and an iodide solution.

Next, the forth embodiment, the method via halogen conversion will be described.

This is a method in which an epitaxially growing site director (hereinafter, referred to as a site director), such as a sensitizing dye disclosed in JP-A-58-108526 and a water-soluble iodide, is added to base grains so that epitaxial of silver chloride is formed at the apex portions of the base grains and then iodide ions are added so that the silver chloride is halogen converted into silver iodide or silver halide having a high silver iodide content. As the site director, sensitizing dyes, a water-soluble thiocyanate ion and water-soluble iodide ion can be used, and the iodide ion is preferable. The iodide ion is used in an amount of 0.0005 to 1 mol %, and preferably 0.001 to 0.5 mol % of the base grains. After the iodide ions are added a silver salt solution and a chloride salt solution are added simultaneously, thereby epitaxial of silver chloride can be formed at apex portions of the base grains.

The following is a description on halogen conversion by iodide ions. A silver halide having a great solubility is converted into a silver halide having a less solubility by addition of halide ions capable of forming the silver halide having a less solubility. This process is called halogen conversion and is disclosed, for example, in U.S. Pat. No. 4,142,900. In the present invention by selectively subjecting the silver chloride epitaxially grown at apex portions of the base to halogen conversion with iodide ions, a silver iodide phase is formed at apex portions of the base grains. The detail will be disclosed in JP-A-4-149541.

Following the halogen conversion of the silver chloride epitaxially grown at apex portions of the base grains into a silver iodide phase caused by the addition of iodide ions, the grains are further grown so that dislocation is introduced in the vicinities of the apexes by the sole addition of a silver nitrate solution or the simultaneous addition of a silver nitrate solution and a bromide solution or a silver nitrate solution and a mixed solution comprising a bromide solution and an iodide solution.

It is preferable that there are dislocation lines in the portion of step (b2). The dislocation lines are preferably present in the vicinities of the corner portions of tabular grains. The vicinity of a corner portion of a grain refers to the three-dimensional portion defined in the following manner. Perpendiculars are dropped each from a point located on a straight line connecting the center of the grain and x % away from the center of the straight line to each of the sides of the grain defining the apex. The above perpendiculars and the above sides surround a three-dimensional portion. The value of x is preferably not less than 50 and not more than 100, and more preferably not less than 75 and not more than 100. The average number of the dislocation lines present in the edge portions is preferably 10 or more, and more preferably 20 or more per grain. If dislocation lines are densely present or they are observed to cross each other, it is sometimes impossible to correctly count dislocation lines per grain. Even in such situations, however, dislocation lines can be roughly counted to such an extent as in units of 10 lines, like 10, 20, or 30 dislocation lines, thereby making it possible to distinguish these grains from those in which obviously only a few dislocation lines are present. The average number of dislocation lines per grain is obtained as a number average by counting dislocation lines for 100 or more grains.

Next, step (b3), epitaxial junction step, will be described.

About the epitaxial formation of silver halide to base grains, U.S. Pat. No. 4,435,501 discloses that silver salt epitaxial can be formed at selected sites, e.g., edge or corner of the bas base grain, by a site director such as iodide ions, aminoazaindene or spectral sensitizing dyes adsorbed to the surface of the base grains. In JP-A-8-69069, the enhancement of speed is attained by forming silver salt epitaxial at selected sites in extremely thin tabular grains and subjecting the epitaxial phase to optimum chemical sensitization.

Also in the present invention, it is very preferable to enhance the speed of the base grains of the present invention using these methods. As the site director, aminoazaindene or spectral sensitizing dyes may be used and iodide ions or thiocyanate ions are preferably used.

By varying the addition amounts of the iodide ions or thiocyanate ions, the site for forming silver salt epitaxial phase can be limited to the edge or corner of the base grain.

The addition amount of the iodide ions is 0.0005 to 1.0 mol %, preferably 0.001 to 0.5 mol % to the silver amount of the base grains. Further the amount of the thiocyanate ions is 0.01 to 0.2 mol %, preferably 0.02 to 0.1 mol % of the silver mount of the base grains.

After the addition of the site director, the silver salt solution and halide solution are added to form silver chloride epitaxial phase. The temperature at this time is preferably 40 to 70° C., and more preferably 45 to 60° C. At this time, pAg is preferably 7.5 or less, and more preferably 6.5 or less. By using the site directors epitaxial phase of silver chloride can be formed on the corner portion or edge portion of the base grain. The thus obtained emulsion may be enhanced its speed by being subjected to chemical sensitization selectively in its epitaxial phase as in JP-A-8-69069, and also may be further grown by means of simultaneous addition of a silver salt solution and a halide salt solution following the silver salt epitaxial phase formation. As the aqueous halide salt solution to be added in this treatment, a bromide salt solution, or a mixed solution comprising a bromide salt solution and an iodide salt solution is preferable. In the treatment, the temperature is preferably 40 to 80° C., and more preferably 45 to 70° C. At this time, pAg is preferably 5.5 or more and 9.5 or less, and more preferably 6.0 or more and 9.0 or less.

The epitaxial formed in step (b3) is characterized by projecting outside the base grains formed in step (a) and the halide composition thereof is basically different from that of the base grain. The composition of epitaxial is preferably AgCl, AgBrCl, AgBrClI, AgBrI, AgI, AgSCN, or the like. It is more preferable to introduce a “dopant (metal complex)” such as those disclosed in JP-A-8-69069, to an epitaxial phase. The position of epitaxial growth may be at least a part of the corner portions, the edge portions and the main plane portions of the base grains and also may be spread over two or more portions. It is preferable that the position of epitaxial growth is in the shape wherein only the corner portion, or only the edge portion, or both the corner and edge portions.

No dislocation lines are required to be present in the portion of step (b3), but it is more preferable that there is a dislocation line. It is preferable for dislocation lines to be present in the connecting portion between a base grain and an epitaxial growth portion or in an epitaxial portion. The average number of the dislocation lines present in the connecting portions or epitaxial portions is preferably 10 or more, and more preferably 20 or more per grain. If dislocation lines are densely present or they are observed to cross each other, it is sometimes impossible to correctly count dislocation lines per grain. Even in such situations, however, dislocation lines can be roughly counted to such an extent as in units of 10 lines, like 10, 20, or 30 dislocation lines, thereby making it possible to distinguish these grains from those in which obviously only a few dislocation lines are present. The average number of dislocation lines per grain is obtained as a number average by counting dislocation lines for 100 or more grains.

The tabular grains of the present invention preferably have uniform distribution of the number of dislocation lines among grains. It is preferable that grains having 10 or more dislocation lines per grain account for 100 to 50% (number), more preferably 100 to 70%, and especially preferably 100 to 90% of the total silver halide grains.

The ratio of grains having 10 or more dislocation lines below 50% is not preferable in view of uniformity between grains.

To obtain the ratio of grains containing dislocation lines and the number of dislocation lines in the present invention, it is preferable to directly observe dislocation lines for not less than 100 grains, more preferably not less than 200 grains, and particularly preferably not less than 300 grains.

The tabular grain of the present invention is subjected to an operation by which the silver iodide content in a main plane region in the outermost layer, I₁ mol %, and the silver iodide content in a side face region in the outermost layer, I₂ mol %, come to satisfy I₂/I₁<1 in the course from the completion of step (b) to a chemical sensitization step.

Possible examples include a step of growing a tabular silver halide grain prepared in advance, so as to grow a silver halide phase having a low silver iodide content preferentially in a side face direction and then grow a silver halide phase having a high silver iodide content in a main plane direction, or a step of growing the tabular grain so as to grow a silver halide phase having a high silver iodide content preferentially in a main plane direction and then grow a silver halide phase having a low silver iodide content in a side face direction.

For the method of growing a tabular silver halide grain preferentially in its main plane direction or its side face direction, important are choice not only of (i) grain shape, halogen composition and side face structure of a tabular silver halide grain prepared for grain growth, but also of (ii) a silver and halogen ions to be supplied into a system for grain growth, or halogen composition of a silver halide grain emulsion serving as sources of the silver and halogen ions, size of a silver halide fine grain, conditions for addition of silver halide fine grains, temperature, pBr, concentration, stirring, gelatin concentration, and etc in the reaction system.

For example, a pBr and gelatin concentration suitable for the preferential growth in the side face direction are 1.0 to 2.5 and 0.5 to 2.0%, respectively. On the other hand, a pBr suitable for the preferential growth in the main plane direction is 2.5 to 4.5.

In the present invention, in order to control the thickness and silver halide composition in an outermost layer in each of the main plane region and side face region of a silver halide grain uniformly and homogeneously among grains and within a grain, a method comprising feed of silver halide fine grains to supply, through their dissolution, silver ions and halide ions to silver halide grains under growth is preferred to the ion supply method.

With regard to the feed of silver halide fine grains, fine grains prepared in advance and having a desired halogen composition may be fed rapidly. An alternative method is to feed fine grains to a reaction vessel for growth while feeding and mixing, in a mixing vessel for preparing fine grains built outside the reaction vessel for growth, silver ions and halogen ions to react.

The emulsion of the present invention is preferably subjected to ultrafiltration desalting and/or concentration.

The term “ultrafiltration” herein referred to is defined as described in M. Chenyan, “Ultrafiltration Handbook, Technomic Co., (1986). This filtration method usually uses a membrane, which permits unnecessary substances to pass therethrough. For example, in a process for manufacturing a silver halide emulsion, the method is a purification process using a membrane which permits unnecessary salts or the like to pass through, and does not permit necessary substances, such as a silver halide grain, to pass.

The ultrafiltration includes washing and/or concentrating of a silver halide emulsion so as to remove excess soluble salts. These operations are effected by permitting a silver halide emulsion dispersed to pass through a pressurized ultrafiltration module to allow excess salts to pass through a semipermeable membrane, thereby obtaining a residue (emulsion) comprising silver halide grains and a dispersing agent.

This selective separation is achieved by pressing a solution, by liquid pressure, against a synthetic semipermeable membrane designed so that all molecules having a size equal to or smaller than a specific size are allowed to pass, and molecules larger than that size are forced to remain. In the present invention, the pressure applied to the silver halide emulsion which comes into contact with an ultrafiltration membrane is preferably 1 to 10 kg/cm².

Silver halide and excess salts precipitated in a peptizer are supplied into a vessel by conventional means. Subsequently, this liquid is pumped to an ultrafiltration module through a flow meter. The excess salts are removed in the form of a permeated solution. On the other hand, the residue is returned to the vessel in a recycling operation mode. In another possible mode, many ultrafiltration modes are connected in tandem and a residue from a module of a prior stage is supplied to the inlet line of the next module.

Prior to causing a liquid to flow continuously through each module, the liquid may be rediluted with a solvent for the purpose of washing. In another method, there is no need for rediluting the liquid for the purpose of concentration.

The ultrafiltration is preferably performed by circulating a dispersed liquid in a reaction vessel while forcing the liquid in contact with a semipermeable ultrafiltration membrane so as to form a pressure differential across the membrane. An appropriate membrane which contains fine pores of a size such that molecules not larger than a specific size can pass through and silver halide and molecules larger than the specific size are forced to remain in the dispersed liquid may be chosen from those exhibiting a permeation cut-off within the molecular weight range of about 500 to about 300,000, preferably about 500 to 100,000.

The pressure applied to the dispersed liquid contacting the ultrafiltration membrane may vary widely. Typically, the pressure of a reaction vessel which contacts the ultrafiltration membrane is about 7.0 kg/cm² and the pressure at the outlet of the retentate is about 0.7 kg/cm² or less. The pressure difference across the membrane is typically about 2.8 to 4.2 kg/cm². As a matter of course, to operate under a pressure beyond the above pressure ranges depending upon the structure of the reaction vessel or the ultrafiltration membrane, the dispersed liquid viscosity, the retentate concentration or the purity of a desirable retentate is included in the technological scope of those skilled in the art.

The membrane for use in ultrafiltration is typically an anisotropic membrane including an extremely thin layer having an extremely fine porous structure supported on a porous structure layer thicker than the foregoing layer. Such a useful membrane may be of various high molecule substances, such as polyvinyl chloride, polyvinyl carboxylate, polyvinyl formate, polyvinyl acetate, polyvinylalcohol, polysulfone, polyvinyl ether, polyacrylamide, polyacrylnitrile, poly methacrylamide, polyimide, polyester, polyfluoroalkylene e.g., polytetrafluoroethylene and polyvinylidene fluoride and cellulosic polymers e.g., cellulose and cellulose ester e.g., cellulose acetate, cellulose butyrate and cellulose acetobutyrate.

When forming silver halide phases of different halogen compositions separately in the side face direction and in the main plane direction, it is preferable to appropriately employ an operation of removing unnecessary salts, ions and the like using ultrafiltration as described above.

Removal of remaining, excess or unnecessary halogen ions after the formation of one of the silver halide phases prevents occurrence of unintended conversion during the subsequent preparation process and thereby can make it easy to control the halogen composition of the other silver halide phase during its formation. The operations of washing, desalting or removal of unnecessary substances such as salts and ions by membrane separation are preferably carried out after formation of base grains and after grain growth in one optional direction chosen from the side face direction and the main plane direction, or after formation of a silver halide layer of an optional composition. In particular, it is preferable to perform these operations upon completion of each silver halide formation process.

For the purpose of retarding growth of a tabular silver halide grain in its main plane direction or side face direction, it is preferable not only to control the above-mentioned silver halide grain growth conditions, but also to employ additives called silver halide growth-controlling agents, crystal habit-controlling agents or retardants, and adsorptive substances such as face-selectively adsorptive dyes and retardants, and let them adsorb onto a specific crystal, thereby growing a silver halide phase of a desired halogen composition on a non-adsorptive surface.

As a protective colloid used for the preparation of the emulsion of the present invention, gelatin is used advantageously, but another hydrophilic colloid can also be used.

Use can be made of, for example, a gelatin derivative, a graft polymer of gelatin with another polymer, a protein, such as albumin and casein; a cellulose derivative, such as hydroxyethylcellulose, carboxymethylcellulose, and cellulose sulfate ester; sodium alginate, a saccharide derivative, such as a starch derivative; and many synthetic hydrophilic polymers, including homopolymers and copolymers, such as a polyvinyl alcohol, a polyvinyl alcohol partial acetal, a poly-N-vinylpyrrolidone, a polyacrylic acid, a polymethacrylic acid, a polyacrylamide, a polyvinylimidazole and a polyvinylpyrazole.

Preferably, the silver halide emulsion that may be used in the photosensitive material of the present invention is washed with water for desalting and is dispersed in a freshly prepared protective colloid. Gelatin is used as protective colloid but natural high polymers besides gelatin and synthetic high polymers can also be used. Alkali-processed gelatin, oxidized gelatin, i.e., gelatin in which a methionine group in the gelatin molecule is oxidized with hydrogen peroxide, etc. (a methionine content of 40 μmol/g or less) and amino group-modified gelatin of the present invention (e.g., phthalated gelatin, trimellitated gelatin, succinated gelatin, maleated gelatin, and esterified gelatin). Further, if necessary, lime-processed ossein gelatin containing 30% or more of components having a molecular weight of 280,000 in a molecular weight distribution determined by the Puggy's method disclosed in JP-A-11-237704 may be employed. Furthermore, for example, starches disclosed in EP No. 758758 and U.S. Pat. No. 5,733,718 may also be used. Further, natural high polymers will be described in JP-B-7-111550 and Research Disclosure, Vol. 176, No. 17643, item IX (December, 1978). The temperature at which the washing with water is carried out can be selected in accordance with the purpose, and preferably the temperature is selected in the range of 5° C. to 50° C. The pH at which the washing with water is carried out can be selected in accordance with the purpose, and preferably the pH is selected in the range of 2 to 10, and more preferably in the range of 3 to 8. The pAg at which the washing with water is carried out can be selected in accordance with the purpose, and preferably the pAg is selected in the range of 5 to 10. As a method of washing with water, it is possible to select from the noodle washing method, the dialysis method using a diaphragm, the centrifugation method, the coagulation settling method, the ion exchange method and the ultrafiltration. In the case of the coagulation settling method, selection can be made from, for example, the method wherein sulfuric acid salt is used, the method wherein an organic solvent is used, the method wherein a water-soluble polymer is used, and the method wherein a gelatin derivative is used.

During the grain formation of the present invention, it is possible to cause a polyalkyleneoxide block copolymer disclosed in, for example, JP-A's-5-173268, 5-173269, 5-173270, 5-173271, 6-202258 and 7-175147, or a polyalkyleneoxide copolymer disclosed in Japanese Patent No. 3089578 to exist. Such a compound exists may exist at any timing during the preparation of the grains. However, its use in early stages of grain formation exhibits a great effect.

In the preparation of the emulsion of the invention it is preferable to make salt of metal ion exist, for example, during grain formation, in a step of desalting, or chemical sensitization, or before coating in accordance with the intended use. The metal ion salt is preferably added during grain formation when doped into grains, and after grain formation and before completion of chemical sensitization when used to modify the grain surface or used as a chemical sensitizer. The salt can be doped in any of an overall grain, only the core portion, and only the shell portion. Examples of the metal are Mg, Ca, Sr, Ba, Al, Sc, Y, La, Cr, Mn, Fe, Co, Ni, Cu, Zn, Ga, Ru, Rh, Pd, Re, Os, Ir, Pt, Au, Cd, Hg, Tl, In, Sn, Pb, and Bi. These metals can be added as long as they are in the form of salt that can be dissolved during grain formation, such as ammonium salt, acetate, nitrate, sulfate, phosphate, hydroxide, hexa-coordinated complex salt, or tetra-coordinated complex salt. Examples are CdBr₂, CdCl₂, Cd(NO₃)₂, Pb(NO₃)₂, Pb(CH₃COO)₂, K₃[Fe(CN)₆], (NH₄)₄[Fe(CN)₆], K₃IrCl₆, (NH₄)₃RhCl₆, and K₄Ru(CN)₆. The ligand of a coordination compound can be selected from halo, aquo, cyano, cyanate, thiocyanate, nitrosyl, thionitrosyl, oxo, and carbonyl. These metal compounds can be used either singly or in the form of a combination of two or more types of them.

The metal compounds are preferably dissolved in water or an appropriate organic solvent, such as methanol or acetone, and added in the form of a solution. To stabilize the solution, an aqueous hydrogen halogenide solution (e.g., HCl or HBr) or an alkali halide (e.g., KCl, NaCl, KBr, or NaBr) can be added. It is also possible to add acid or alkali if necessary. The metal compounds can be added to a reactor vessel before grain formation or during the grain formation. Alternatively, the metal compounds can be added to a water-soluble silver salt (e.g., AgNO₃) or an aqueous alkali halide solution (e.g., NaCl, KBr, or KI) and added in the form of a solution continuously during formation of silver halide grains. Furthermore, a solution of the metal compounds can be prepared independently of a water-soluble salt or an alkali halide and added continuously at a proper timing during grain formation. It is also possible to combine several different addition methods.

In some cases, the method of adding a chalcogen compound described in U.S. Pat. No. 3,772,031 during the preparation of an emulsion is also useful. A cyanate, thiocyanate, selenocyanate, carbonate, phosphate or acetate may also be present other than S, Se and Te.

The silver halide grain may be subjected to at least one of sulfur sensitization, selenium sensitization, tellurium sensitization, gold sensitization, palladium sensitization, noble metal sensitization and reduction sensitization, at any step in the process of preparing the silver halide emulsion.

It is preferred to combine two or more kinds of sensitization processes. Various types of emulsions can be prepared depending on the stage at which the grains are subjected to chemical sensitization. There is a type in which a chemical sensitizing nucleus is embedded inside of the grain, a type in which the nucleus is embedded at a shallow position from a surface of the grain, and a type in which the nuclei are prepared on the surface of the grain. For the emulsions for use in the invention, the place at which the chemical sensitizing nucleus is located can be selected depending upon their purpose. However, it is generally preferred that at least one kind of chemical sensitizing nucleus is formed in the vicinity of the surface of the grain.

One chemical sensitization which can be preferably performed in the present invention is chalcogen sensitization, noble metal sensitization, or a combination of these. The sensitization can be performed by using active gelatin as described in T. H. James, The Theory of the Photographic Process, 4th ed., Macmillan, 1977, pages 67 to 76. The sensitization can also be performed by using any of sulfur, selenium, tellurium, gold, platinum, palladium, and iridium, or by using a combination of a plurality of these sensitizers at pAg 5 to 10, pH 5 to 8, and a temperature of 30 to 80° C., as described in Research Disclosure, Vol. 120, April, 1974, 12008, Research Disclosure, Vol. 34, June, 1975, 13452, U.S. Pat. Nos. 2,642,361, 3,297,446, 3,772,031, 3,857,711, 3,901,714, 4,266,018 and 3,904,415 and British Patent 1,315,755. In the noble metal sensitization, salts of noble metals, such as gold, platinum, palladium, and iridium, can be used. In particular, gold sensitization, palladium sensitization, or a combination of the both is preferred.

In gold sensitization, there can be used the gold salts described in P. Grafkides, Chimie et Physique Photographique (Paul Montel, 1987, 5th edition), Research Disclosure, vol. 307, No. 307105 and so forth.

Specifically, besides chloroauric acid, potassium chloroaurate and potassium auriothiocyanate, there can be used gold compounds described in U.S. Pat. No. 2,642,361 (gold sulfides, gold selenides etc.), U.S. Pat. No. 3,503,479 (gold thiolates having a water-soluble group etc.), U.S. Pat. No. 5,049,484 (bis(methylhydantoinate) gold complexes etc.), U.S. Pat. No. 5,049,485 (mesoionic thiolate gold complexes, e.g., 1,4,5-trimethyl-1,2,4-triazolium-3-thiolate gold complex etc.), U.S. Pat. Nos. 5,252,455 and 5,391,727 (large ring heterocyclic gold complexes), U.S. Pat. Nos. 5,620,841, 5,700,631, 5,759,760, 5,759,761, 5,912,111, 5,912,112, 5,939,245, JP-A's-1-147537, 8-69074, 8-69075, and 9-269554, JP-B-45-29274, East German Patent Nos. DD-264524A, 264525A, 265474A, 298321A, JP-A's-2001-75214, 2001-75215, 2001-75216, 2001-75217, 2001-75218 and so forth.

A palladium compound means a divalent or tetravalent salt of palladium. A preferable palladium compound is represented by R₂PdX₆ or R₂PdX₄ wherein R represents a hydrogen atom, an alkali metal atom, or an ammonium group and X represents a halogen atom, e.g., a chlorine, bromine, or iodine atom. More specifically, the palladium compound is preferably K₂PdCl₄, (NH₄)₂PdCl₆, Na₂PdCl₄, (NH₄)₂PdCl₄, Li₂PdCl₄, Na₂PdCl₆, or K₂PdBr₄. It is preferable that the gold compound and the palladium compound be used in combination with thiocyanate or selenocyanate.

For the sulfur sensitization, labile sulfur compounds are used as described in, for example, P. Grafkides, Chimie et Physique Photographique, 5th Ed., Paul Montel, 1987, and Research Disclosure, Vol. 307, No. 307105.

Specifically, the labile sulfur compounds used herein are known sulfur compounds, for example, thiosulfates (e.g., hypo), thioureas (e.g., diphenylthiourea, triethylthiourea, N-ethyl-N′-(4-methyl-2-thiazolyl) thiourea, dicarboxymethyl-dimethylthiourea and carboxymethyl-trimethylthiourea), thioamides (e.g., thioacetamide), rhodanines (e.g., diethylrhodanine and 5-benzylidene-N-ethylrhodanine), phosphine sulfides (e.g., trimethylphosphine sulfide), thiohydantoins, 4-oxo-oxazolidine-2-thiones, di- or poly-sulfides (e.g., dimorpholine disulfide, cystine, and hexathiocan), mercapto compounds (e.g., cysteine), polythionates, and elemental sulfur as well as active gelatin. Particularly, thiosulfates, thioureas, phosphine sulfides and rhodanines are preferred.

For the selenium sensitization, labile selenium compounds are used as described in, for example, JP-B's-43-13489, 44-15748, JP-A's-4-25832, 4-109340, 4-271341, 5-40324, 5-11385, 6-51415, 6-175258, 6-180478, 6-208186, 6-208184, 6-317867, 7-92599, 7-98483 and 7-140579.

Specific example thereof include colloidal metallic selenium, selenoureas (e.g., N,N-dimethylselenourea, trifluoromethylcarbonyl-trimethylselenourea, and acetyl-trimethylselenourea), selenoamides (e.g., selenoamide and N,N-diethylphenylselenoamide), phosphine selenides (e.g., triphenylphosphine selenide and pentafluorophenyl-triphenylphosphine selenide), selenophosphates (e.g., tri-p-tolylselenophosphate and tri-n-butylselenophosphate), selenoketones (e.g., selenobenzophenone), isoselenocyanates, selenocarboxylic acids, selenoesters (e.g., methoxyphenylselenocarboxy-2,2-dimethoxycyclohexane ester) and diacylselenides. Also useful are non-labile selenium compounds as described in JP-B's-46-4553 and 52-34492, for example, selenites, selenocyanic acids (e.g., potassium selenocyanide), selenazoles, and selenides. Particularly, phosphine selenides, selenoureas, selenoesters and selenocyanic acids are preferred.

Labile tellurium compounds are used in tellurium sensitization. It is possible to use labile tellurium compounds described in the publications, e.g., of JP-A-'s 4-224595, 4-271341, 4-333043, 5-303157, 6-27573, 6-175258, 6-180478, 6-208184, 6-208186, 6-317867, and 7-140579.

More specifically, it is possible to use phosphinetellurides (e.g., butyl-diisopropylphosphinetelluride, tributylphosphinetelluride, tributoxyphosphinetelluride, ethoxydiphenylphosphinetelluride), diacyl(di)tellurides (e.g., bis(diphenylcarbamoyl)ditelluride, bis(N-phenyl-N-methylcarbamoyl)ditelluride, bis(N-phenyl-N-methylcarbamoyl)telluride, bis(N-phenyl-N-benzylcarbamoyl)telluride, bis(ethoxycarbonyl)telluride), telluroureas (e.g., N,N′-dimethylethylenetellurourea and N,N′-diphenylethylenetellurourea), telluroamides, and telluroesters.

Examples of a useful chemical sensitization aid are compounds, such as azaindene, azapyridazine, and azapyrimidine, which are known as compounds capable of suppressing fog and increasing speed in the process of chemical sensitization. Examples of the chemical sensitization aid and the modifier are described in U.S. Pat. Nos. 2,131,038, 3,411,914, and 3,554,757, JP-A-58-126526, and G. F. Duffin, Photographic Emulsion Chemistry, pages 138 to 143.

The amounts of gold sensitizer and chalcogen sensitize used in the present invention varies depending on silver halide grains to be used and chemical sensitization conditions, but are 10⁻⁸ to 10⁻² per mol of silver halide, and preferably 10⁻⁷ to 10^{-3.}

The silver halide emulsion of the present invention is preferably reduction sensitized during grain formation, after grain formation and before chemical sensitization, or during chemical sensitization, or after chemical sensitization.

Herein, the reduction sensitization method may be selected from any of a method of adding a reduction sensitizer to a silver halide emulsion, a method of growing or ripening grains in a low pAg atmosphere such as pAg of 1 to 7, which is called silver ripening, and a method of growing or ripening grains in a high pH atmosphere such as pH of 8 to 11, which is called high pH ripening. Two or more methods may be used in combination.

The method of adding a reduction sensitizer is a preferable method in view of nicely adjusting the level of reduction sensitization.

Examples of known reduction sensitizers include stannous salts, ascorbic acid and derivatives thereof, amines and polyamines, hydrazine derivatives, formamidinesulfinic acid, silane compounds and borane compounds. In the reduction sensitization employed in the present invention, appropriate one may be selected from among these known reduction sensitizers and used or at least two may be selected and used in combination. Preferred reduction sensitizers are stannous chloride, thiourea dioxide, dimethylaminoborane, ascorbic acid and derivatives thereof. Although the addition amount of reduction sensitizer must be selected because it depends on the emulsion manufacturing conditions, it is preferred that the addition amount range from 10⁻⁷ to 10⁻³ mol per mol of silver halide.

The reduction sensitizer is dissolved in water or any of organic solvents such as alcohols, glycols, ketones, esters and amides, and added during the grain growth. The reduction sensitizer may be added previously in a reaction vessel, but is preferably added at an appropriate timing during grain formation. It is also possible to previously dissolve the reduction sensitizer in a water-soluble silver salt solution or water-soluble alkali halide solution to precipitate silver halide grains using these solutions. Further, preferable method is the one in which the reduction sensitizer solution is added dividedly in a plurality of times accompanying the grain formation, or is added continuously for a long period of time.

An oxidizer capable of oxidizing silver is preferably used during the process of producing the emulsion for use in the present invention. The silver oxidizer is a compound having an effect of acting on metallic silver to thereby convert the same to silver ion. A particularly effective compound is one that converts very fine silver grains, formed as a by-product in the step of forming silver halide grains and the step of chemical sensitization, into silver ions. Each silver ion produced may form a silver salt sparingly soluble in water, such as a silver halide, silver sulfide or silver selenide, or may form a silver salt easily soluble in water, such as silver nitrate. The silver oxidizer may be either an inorganic or an organic substance. Examples of suitable inorganic oxidizers include ozone, hydrogen peroxide and its adducts (e.g., NaBO₂.H₂O₂.3H₂O, 2NaCO₃.3H₂O₂, Na₄P₂O₇.2H₂O₂ and 2Na₂SO₄.H₂O₂.2H₂O), peroxy acid salts (e.g., K₂S₂O₈, K₂C₂O₆ and K₂P₂O₈), peroxy complex compounds (e.g., K₂[Ti(O₂)C₂O₄].3H₂O, 4K₂SO₄-Ti(O₂)OH—SO₄.2H₂O and Na₃[VO(O₂)(C₂H₄)₂].6H₂O), permanganates (e.g., KMnO₄), chromates (e.g., K₂Cr₂O₇) and other oxyacid salts, halogen elements such as iodine and bromine, perhalogenates (e.g., potassium periodate), salts of high-valence metals (e.g., potassium hexacyanoferrate (II)) and thiosulfonates.

Examples of suitable organic oxidizers include quinones such as p-quinone, organic peroxides such as peracetic acid and perbenzoic acid and active halogen-releasing compounds (e.g., N-bromosuccinimide, chloramine T and chloramine B).

Oxidizers preferred in the present invention are inorganic oxidizers selected from among ozone, hydrogen peroxide and its adducts, halogen elements and thiosulfonates and organic oxidizers selected from among quinones. The combined use of the above mentioned reduction sensitization and oxidizer to silver is a preferable embodiment. The method to be used can be selected from among a method of performing reduction sensitization after the use of an oxidizer, a method of vice versa and a method of co-existing the both. These methods can be used at any time selected from a grain formation step and chemical sensitization step.

Photographic emulsions used in the present invention can contain various compounds in order to prevent fog during the manufacturing process, storage, or photographic processing of a sensitized material, or to stabilize photographic properties. Usable compounds are those known as an antifoggant or a stabilizer, for example, thiazoles, such as benzothiazolium salt, nitroimidazoles, nitrobenzimidazoles, chlorobenzimidazoles, bromobenzimidazoles, mercaptothiazoles, mercaptobenzothiazoles, mercaptobenzimidazoles, mercaptothiadiazoles, aminotriazoles, benzotriazoles, nitrobenzotriazoles, and mercaptotetrazoles (particularly 1-phenyl-5-mercaptotetrazole); mercaptopyrimidines; mercaptotriazines; a thioketo compound such as oxadolinethione; azaindenes, such as triazaindenes, tetrazaindenes (particularly hydroxy-substituted(1,3,3a,7)tetrazaindenes), and pentazaindenes. For example, compounds described in U.S. Pat. Nos. 3,954,474 and 3,982,947 and JP-B-52-28660 can be used. One preferable compound is described in Japanese Patent Application No. 63-212932. The antifoggants and stabilizers can be added at any of several different timings, such as before, during, and after grain formation, during washing with water, during dispersion after the washing, before, during, and after chemical sensitization, and before coating, in accordance with the intended application. The antifoggants and the stabilizers can be added during preparation of an emulsion to achieve their original fog preventing effect and stabilizing effect. In addition, the antifoggants and the stabilizers can be used for various purposes of, e.g., controlling crystal habit of grains, decreasing a grain size, decreasing the solubility of grains, controlling chemical sensitization, and controlling an arrangement of dyes.

For enabling exertion of the effect of the present invention, it is preferred that the photographic emulsion for use in the present invention be subjected to a spectral sensitization with a methine dye or the like. Examples of employed dyes include cyanine dyes, merocyanine dyes, composite cyanine dyes, composite merocyanine dyes, holopolar cyanine dyes, hemicyanine dyes, styryl dyes and hemioxonol dyes. Particularly useful dyes are those belonging to cyanine dyes, merocyanine dyes and composite merocyanine dyes. Any of nuclei commonly used in cyanine dyes as basic heterocyclic nuclei can be applied to these dyes. Examples of such applicable nuclei include a pyrroline nucleus, an oxazoline nucleus, a thiozoline nucleus, a pyrrole nucleus, an oxazole nucleus, a thiazole nucleus, a selenazole nucleus, an imidazole nucleus, a tetrazole nucleus and a pyridine nucleus; nuclei comprising these nuclei fused with alicyclic hydrocarbon rings; and nuclei comprising these nuclei fused with aromatic hydrocarbon rings, such as an indolenine nucleus, a benzindolenine nucleus, an indole nucleus, a benzoxazole nucleus, a naphthoxazole nucleus, a benzothiazole nucleus, a naphthothiazole nucleus, a benzoselenazole nucleus, a benzimidazole nucleus and a quinoline nucleus. These nuclei may have a carbon atom being substituted.

Any of 5 or 6-membered heterocyclic nuclei such as a pyrazolin-5-one nucleus, a thiohydantoin nucleus, a 2-thioxazolidine-2,4-dione nucleus, a thiazolidine-2,4-dione nucleus, a rhodanine nucleus and a thiobarbituric acid nucleus can be applied as a nucleus having a ketomethylene structure to the merocyanine dye or composite merocyanine dye.

These spectral sensitizing dyes may be used either individually or in combination. The spectral sensitizing dyes are often used in combination for the purpose of attaining supersensitization. Representative examples thereof are described in U.S. Pat. Nos. 2,688,545, 2,977,229, 3,397,060, 3,522,052, 3,527,641, 3,617,293, 3,628,964, 3,666,480, 3,672,898, 3,679,428, 3,703,377, 3,769,301, 3,814,609, 3,837,862 and 4,026,707, GB's 1,344,281 and 1,507,803, JP-B-43-4936 and 53-12375 and JP-A-52-110618 and 52-109925.

The emulsion used in the present invention may contain a dye which itself exerts no spectral sensitizing effect or a substance which absorbs substantially none of visible radiation and exhibits supersensitization, together with the above spectral sensitizing dye.

The addition timing of the spectral sensitizing dye to the emulsion may be performed at any stage of the process for preparing the emulsion which is known as being useful. Although the doping is most usually conducted at a stage between the completion of the chemical sensitization and the coating, the spectral sensitizing dye can be added simultaneously with the chemical sensitizer to thereby simultaneously effect the spectral sensitization and the chemical sensitization as described in U.S. Pat. Nos. 3,628,969 and 4,225,666. Alternatively, the spectral sensitization can be conducted prior to the chemical sensitization and, also, the spectral sensitizing dye can be added prior to the completion of silver halide grain precipitation to thereby initiate the spectral sensitization as described in JP-A-58-113928. Further, the above sensitizing dye can be divided prior to addition, that is, part of the sensitizing dye can be added prior to the chemical sensitization with the rest of the sensitizing dye added after the chemical sensitization as taught in U.S. Pat. No. 4,225,666. Still further, the spectral sensitizing dye can be added at any stage during the formation of silver halide grains according to the method disclosed in U.S. Pat. No. 4,183,756 and other methods.

The addition amount thereof may be from 4×10⁻⁶ to 8×10⁻³ mol per mol of silver halide.

It is also preferable in the photosensitive material of the invention to use a fragmentable electron-donating sensitizer. The electron-donating sensitizer is described in the specifications of U.S. Pat. Nos. 5,747,235, 5,747,236, 6,054,260, and 5,994,051, EP's 786692A1, and 893732A1, and in the publication of JP-A's-2000-181001, 2000-180999, 2000-181002, 2000-181000, 2000-221626, and 2000-221628. The fragmentable electron-donating sensitizer may be used at any time during preparation of a photosensitive material, for example, at the time of grain formation, in desalting step, at the time of chemical sensitization, or before coating. The fragmentable electron-donating sensitizer may be added dividedly in plurality of times during these steps. The sensitizer is preferably added to the photosensitive material of the invention by dissolving it to water or a water-soluble solvent, such as methanol and ethanol, or a mixed solvent of these. When the sensitizer is dissolved into water, if the solubility of the sensitizer is enhanced when pH water is increased or decreased, the pH of water should be increased or decreased, thereby to add the solution to the photosensitive material. The fragmentable electron-donating sensitizer is preferably used in an emulsion layer, but it may be added to a protective layer or interlayer as well as an emulsion layer, thereby to have the sensitizer diffuse during coating. The addition timing of the sensitizer may be at anytime before or after the addition of a sensitizing dye. In each case, the addition amount thereof to an silver halide emulsion layer per mol of silver is preferably 1×10⁻⁹ to 5×10⁻² mol, more preferable 1×10⁻⁸ to 2×10⁻³ mol.

When the fragmentable electron-donating sensitizer is used, it is preferable to use a storability-improving agent. The compounds described in the publications of JP-A's-11-119364 and 2001-42466 are preferably used as the storability-improving agent.

The above mentioned various additives may be used in the photosensitive material of the invention, and other various additives may be used depending on purposes.

These additives are described in detail in Research Disclosure Item 17643 (December 1978), Item 18716 (November 1979) and Item 308119 (December 1989). A summary of the locations where they are described will be listed in the following table.

| | Types of | | | |
|---|---|---|---|---|
| | additives | RD17643 | RD18716 | RD308119 |
| 1 | Chemical- | page 23 | page 648 | page 996 |
| | sensitizers | | right column | |
| 2 | Sensitivity | | page 648 | |
| | increasing | | right column | |
| | agents | | | |
| 3 | Spectral | pages 23-24 | page 648, | page 996, |
| | sensitizers, | | right column | right column |
| | super- | | to page 649, | to page 998, |
| | sensitizers | | right column | right column |
| 4 | Brighteners | page 24 | page 647, | page 998 |
| | | | right column | right column |
| 5 | Antifoggants, | pages 24-25 | page 649 | page 998, |
| | and | | right column | right column |
| | stabilizers | | | to page 1000, |
| | | | | right column |
| 6 | Light | pages 25-26 | page 649, | page 1003, |
| | absorbents, | | right column | left column |
| | filter dyes, | | to page 650, | to page 1003, |
| | ultraviolet | | left column | right column |
| | absorbents | | | |
| 7 | Stain- | page 25, | page 650, | page 1002, |
| | preventing | right | left to | right column |
| | agents | column | right | |
| | | | columns | |
| 8 | Dye image | page 25 | | page 1002, |
| | stabilizers | | | right column |
| 9 | Film | page 26 | page 651, | page 1004, |
| | hardeners | | left column | right column |
| | | | | to page 1005, |
| | | | | left column |
| 10 | Binders | page 26 | page 651, | page 1003, |
| | | | left column | right column |
| | | | | to page 1004, |
| | | | | right column |
| 11 | Plasticizers, | page 27 | page 650, | page 1006, |
| | lubricants | | right column | left to right |
| | | | | columns |
| 12 | Coating aids, | pages 26-27 | page 650, | page 1005, |
| | surfactants | | right column | left column |
| | | | | to page 1006, |
| | | | | left column |
| 13 | Antistatic | page 27 | page 650, | page 1006, |
| | agents | | right column | right column |
| | | | | to page 1007, |
| | | | | left column |
| 14 | Matting agents | | | page 1008, |
| | | | | left column |
| | | | | to page 1009, |
| | | | | left column |

In order to inhibit deterioration in photographic properties due to formaldehyde gas, a compound capable of reacting with and solidifying formaldehyde as disclosed in U.S. Pat. Nos. 4,411,987 and 4,435,503 can be incorporated in the photosensitive material.

Various color couples may be used in the present invention, and the specific examples thereof are described in the patents described in the patents described in the aforementioned Research Disclosure No. 17643, VII-C to G and No. 307105, VII-C to G.

Preferred yellow couplers are those described in, for example, U.S. Pat. Nos. 3,933,051, 4,022,620, 4,326,024, 4,401,752 and 4,248,961, JP-B-58-10739, British Patent Nos. 1,425,020 and 1,476,760, U.S. Pat. Nos. 3,973,968, 4,314,023 and 4,511,649, and EP 249,473A.

Particularly preferred magenta couplers are 5-pyrazolone and pyrazoloazole compounds. Particularly preferred are those described in U.S. Pat. Nos. 4,310,619 and 4,351,897, European Patent 73,636, U.S. Pat. Nos. 3,061,432 and 3,725,067, Research Disclosure No. 24220 (June, 1984), JP-A-60-33552, Research Disclosure No. 24230 (June, 1984), JP-A's-60-43659, 61-72238, 60-35730, 55-118034 and 60-185951, U.S. Pat. Nos. 4,500,630, 4,540,654 and 4,556,630, and International Publication No. WO 88/04795.

The cyan couplers usable in the present invention are phenolic and naphtholic couplers. Particularly preferred are those described in U.S. Pat. Nos. 4,052,212, 4,146,396, 4,228,233, 4,296,200, 2,369,929, 2,801,171, 2,772,162, 2,895,826, 3,772,002, 3,758,308, 4,334,011 and 4,327,173, West German Patent Published Application No. 3,329,729, EP's 121,365A and 249,453A, U.S. Pat. Nos. 3,446,622, 4,333,999, 4,775,616, 4,451,559, 4,427,767, 4,690,889, 4,254,212 and 4,296,199, and JP-A-61-42658.

Typical examples of the polymerized color-forming couplers are described in, for example, U.S. Pat. Nos. 3,451,820, 4,080,211, 4,367,282, 4,409,320 and 4,576,910, British Patent's 2,102,137 and EP 341,188A.

The couplers capable of forming a colored dye having a suitable diffusibility are preferably those described in U.S. Pat. No. 4,366,237, British Patent No. 2,125,570, European Patent No. 96,570 and West German Patent No. 3,234,533.

Colored couplers used for compensation for unnecessary absorption of the colored dye are preferably those described in Research Disclosure No. 17643, VII-G and No. 307105, VII-G, U.S. Pat. No. 4,163,670, JP-B-57-39413, U.S. Pat. Nos. 4,004,929 and 4,138,258 and British Patent No. 1,146,368. Other couplers preferably used herein include couplers capable of compensating for an unnecessary absorption of the colored dye with a fluorescent dye released during the coupling as described in U.S. Pat. No. 4,774,181 and couplers having, as a removable group, a dye precursor group capable of forming a dye by reacting with a developing agent as described in U.S. Pat. No. 4,777,120.

Further, compounds which release a photographically useful residue during a coupling reaction are also preferably usable in the present invention. DIR couplers which release a development inhibitor are preferably those described in the patents shown in the above described RD 17643, VII-F and No. 307105, VII-F as well as those descried in JP-A's-57-151944, 57-154234, 60-184248, 63-37346 and 63-37350 and U.S. Pat. Nos. 4,248,962 and 4,782,012.

The couplers which release a nucleating agent or a development accelerator in the image-form in the development step are preferably those described in British Patent's 2,097,140 and 2,131,188 and JP-A's-59-157638 and 59-170840. Further, compounds capable of releasing a fogging agent, development accelerator, solvent for silver halides, etc. upon the oxidation-reduction reaction with an oxidized developing agent as described in JP-A's-60-107029, 60-252340, 1-44940 and 1-45687 are also preferred.

Other compounds usable for the photosensitive material according to the present invention include competing couplers described in U.S. Pat. No. 4,130,427, polyequivalent couplers described in U.S. Pat. Nos. 4,283,472, 4,338,393 and 4,310,618, DIR redox compound-releasing couplers, DIR coupler-releasing couplers, DIR coupler-releasing redox compounds and DIR redox-releasing redox compounds described in JP-A's-60-185950 and 62-24252, couplers which release a dye that restores the color after coupling-off as described in EP's 173,302 A and 313,308 A, couplers which release bleach accelerator described in RD Nos. 11449 and 24241, and JP-A-61-201247, ligand-releasing couplers described in U.S. Pat. No. 4,555,477, leuco dye-releasing couplers described in JP-A-63-75747 and fluorescent dye-releasing couplers described in U.S. Pat. No. 4,774,181.

The couplers used in the present invention can be incorporated into the photosensitive material by various known dispersion methods.

High-boiling solvents used for an oil-in-water dispersion method are described in, for example, U.S. Pat. No. 2,322,027. The high-boiling organic solvents having a boiling point under atmospheric pressure of at least 175° C. and usable in the oil-in-water dispersion method include, for example, phthalates (such as dibutyl phthalate, dicyclohexyl phthalate, di-2-ethylhexyl phthalate, decylphthalate, bis(2,4-di-t-amylphenyl) phthalate, bis(2,4-di-t-amylphenyl) isophthalate and bis(1,1-diethylpropyl)phthalate), phosphates and phosphonates (such as triphenyl phosphate, tricresyl phosphate, 2-ethylhexyldihenyl phosphate, tricyclohexyl phosphate, tri-2-ethylhexyl phosphate, tridodecyl phoshate, tributoxyethyl phosphate, trichloropropyl phosphate and di-2-ethylhexylphenyl phosphate), benzoates (such as 2-ethylhexyl benzoate, dodecyl benzoate and 2-ethylhexyl-p-hydroxybenzoate), amides (such as N,N-di ethyldodecaneamide, N,N-diethyllaurylamide and N-tetradecylpyrrolidone), alcohols and phenols (such as isostearyl alcohol and 2,4-di-tert-amylphenol), aliphatic carboxylates (such as bis(2-ethylhexyl) sebacate, dioctyl azelate, glycerol tributyrate, isostearyl lactate and trioctyl citrate), aniline derivatives (such as N,N-dibutyl-2-butoxy-5-tert-octylaniline] and hydrocarbons (such as paraffin, dodecylbenzene and diisopropylnaphthalene). Co-solvents usable in the present invention include, for example, organic solvents having a boiling point of at least about 30° C., preferably 50 to about 160° C. Typical examples of them include ethyl acetate, butyl acetate, ethyl propionate, methyl ethyl ketone, cyclohexanone, 2-ethoxyethyl acetate and dimethylformamide.

The steps and effects of the latex dispersion method and examples of the latices usable for the impregnation are described in, for example, U.S. Pat. No. 4,199,363 and West German Patent Application (OLS) Nos. 2,541,274 and 2,541,230.

The color photosensitive material used in the present invention preferably contains phenethyl alcohol or an antiseptic or mold-proofing agent described in JP-A's-63-257747, 62-272248 and 1-80941 such as 1,2-benzoisothiazolin-3-one, n-butyl p-hydroxybenzoate, phenol, 4-chloro-3,5-dimethylphenol, 2-phenoxyethanol or 2-(4-thiazolyl) benzimidazole.

The present invention is applicable to various color photosensitive materials such as ordinary color negative films, cinema color negative films, reversal color films for slides or televisions, color papers, positive color films and reversal color papers. The present invention may also preferably be used as films for color dupe.

Suitable supports usable in the present invention are described, for example, on page 28 of the above-described RD. No. 17643, from right column, page 647 to left column, page 648 of RD. No. 18716 and on page 879 of RD. No. 307105.

The photosensitive material of the present invention is preferably provided with a hydrophilic colloidal layer (called a back layer) having the total dry layer thickness of 2 μm to 20 am. The above mentioned light absorber, filter dye, ultraviolet absorber, anti-static agent, film hardener, binder, plasticizer, lubricant, coating aid, surfactant, for example, are preferably contained in the back layer. The water swelling ratio of the back layer is preferable 50 to 250%.

The color photosensitive material according to the present invention maybe developed by a conventional method described in the afore mentioned RD No. 17643, pages 28 to 29, No. 18716, page 651, left to right columns, and No. 307105, pages 880 to 881.

The color developer to be used in the development of the photosensitive material of the present invention is preferably an alkaline aqueous solution containing as a main component an aromatic primary amine color developing agent. As such a color developing agent there can be effectively used an aminophenolic compound. In particular, p-phenylenediamine compounds are preferably used. Typical examples of such p-phenylenediamine compounds include 3-methyl-4-amino-N,N-diethylaniline, 3-methyl-4-amino-N-ethyl-N-β-hydroxy-ethylaniline, 3-methyl-4-amino-N-ethyl-N-β-methanesulfonamidoethylaniline, 3-methyl-4-amino-N-ethyl-N-β-methoxyethylaniline, and sulfates, hydrochlorides and p-toluenesulfonates thereof. Particularly preferred among these compounds are 3-methyl-4-amino-N-ethyl-N-β-hydroxyethylaniline sulfate. These compounds can be used in combination of two or more thereof depending on the purpose of application.

The color developer normally contains a pH buffer such as carbonate, borate and phosphate of an alkali metal or a development inhibitor or fog inhibitor such as chlorides, bromides, iodides, benzimidazoles, benzothiazoles and mercapto compounds. If desired, the color developer may further contain various preservatives such as hydroxylamine, diethylhydroxylamine, sulfites, hydrazines (e.g., N,N-biscarboxymethylhydrazine), phenylsemicarbazides, tri-ethanolamine and catecholsulfonic acids, organic solvents such as ethylene glycol and diethylene glycol, development accelerators such as benzyl alcohol, polyethylene glycol, quaternary ammonium salts, and amines, color-forming couplers, competing couplers, auxiliary developing agents such as 1-phenyl-3-pyrazolidone, viscosity-imparting agents, various chelating agents exemplified by aminopolycarboxylic acids, aminopolyphosphonic acids, alkylphosphonic acids, and phosphonocarboxylic acids (e.g., ethylenediaminetetraacetic acid, nitrilotriacetic acid, diethylenetriaminepentaacetic acid, cyclohexanediaminetetraacetic acid, hydroxyethyliminodiacetic acid, 1-hydroxyethylidene-1,1-diphosphonic acid, nitrilo-N,N,N-trimethylenephosphonic acid, ethylenediamine-N,N,N,N-tetramethylenephosphonic acid, and ethylenediamine-di(o-hydroxyphenylacetic acid), and salts thereof).

Further, when reversal processing is to be performed on the photographic material, color development is usually performed after black-and-white development. As the black-and-white developer, known black-and-white developers can be used singly or in combination, which include dihydroxybenzenes, such as hydroquinone, 3-pyrazolidones, such as 1-phenyl-3-pyrazolidone, or aminophenols, such as N-methyl-p-aminophenol. Theses black-and-white developers usually have a pH of from 9 to 12. The replenishment rate of the developer is usually 3 liter (hereinafter liter is also referred to as “L”) or less per m² of the photosensitive material, though depending on the type of the color photographic material to be processed. The replenishment rate may be reduced to 500 milliliter/m² or less by decreasing the bromide ion concentration in the replenisher (hereinafter milliliter is also referred to as “mL”). If the replenishment rate is reduced, the area of the processing tank in contact with air is preferably reduced to inhibit the evaporation and air oxidation of the processing solution.

The area of the photographic processing solution in contact with air in the processing tank can be represented by an opening rate as defined by the following equation:

Opening rate=[area of processing solution in contact with air (cm²)/[volume of processing solution (cm³)]

The opening rate as defined above is preferably in the range of 0.1 or less, more preferably 0.001 to 0.05. Examples of methods for reducing the opening rate include a method which comprises putting a cover such as floating lid on the surface of the processing solution in the processing tank, a method as disclosed in JP-A-1-82033 utilizing a mobile lid, and a slit development method as disclosed in JP-A-63-216050. The reduction of the opening rate is preferably effected in both color development and black-and-white development steps as well as all the subsequent steps such as bleach, blix, fixing, washing and stabilization. The replenishment rate can also be reduced by a means for suppressing accumulation of the bromide ion in the developing solution.

The period for the color development processing usually sets between 2 to 5 min, the processing time can be shortened further by setting high pH and temperature, and using high concentration color developer.

The photographic emulsion layer which has been color-developed is normally subjected to bleach. Bleach may be effected simultaneously with fixation (i.e., blix), or these two steps may be carried out separately. For speeding up of processing, bleach may be followed by blix. Further, any of an embodiment wherein two blix baths connected in series are used, an embodiment wherein blix is preceded by fixation, and an embodiment wherein blix is followed by bleach may be selected arbitrarily according to the purpose. Bleaching agents to be used include compounds of potyvalent metals, e.g., iron (III), peroxides, quinones, and nitro compounds. Typical examples of these bleaching agents are organic complex salts of iron (III) with, e.g., aminopolycarboxylic acids such as ethylenediaminetetraacetic acid, diethylenetriaminepentaacetic acid, cyclohexanediaminetetraacetic acid, methyliminodiacetic acrid, 1,3-diaminopropanetetraacetic acid and glycol ether diaminetetraacetic acid, or citric acid, tartaric acid, malic acid, etc. Of these, aminopolycarboxylic acid-iron (III) complex salts such as ethylenediaminetetraacetato iron (III) complex salts and 1,3-diaminopropanetetraacetato iron (III) complex salts are preferred in view of speeding up of processing and conservation of the environment. In particular, aminopolycarboxylic acid-iron (III) complex salts are useful in both of a bleaching solution and a blix solution. The pH value of a bleaching solution or blix solution comprising such an antinopolycarboxylic acid-iron (III) complex salts is normally in the range of 4.0 to 8. For speeding up of processing, the processing can be effected at an even lower pH value.

The bleaching bath, blix bath or a prebath thereof can contain, if desired, a bleaching accelerator. Examples of useful bleaching accelerators include compounds containing a mercapto group or a disulfide group as described in U.S. Pat. No. 3,893,858, West German Patents 1,290,812 and 2,059,988, JP-A's-53-32736, 53-57831, 53-37418, 53-72623, 53-95630, 53-95631, 53-104232, 53-124424, 53-141623, and 53-28426 and Research Disclosure No. 17129 (July 1978), thiazolidine derivatives as described in JP-A-51-140129, thiourea derivatives as described in JP-B-45-8506, JP-A's-52-20832, and 53-32735 and U.S. Pat. No. 3,706,561, iodides as described in West German Patent 1,127,715 and JP-A-58-16235, polyoxyethylene compounds as described in West German Patents 966,410 and 2,748,430, polyamine compounds as described in JP-B-45-8836, compounds as described in JP-A's-49-40943, 49-59644, 53-94927, 54-35727, 55-26506 and 58-163940, and bromine ions. Preferred among these compounds are compounds containing a mercapto group or disulfide group because of their great acceleratory effects. In particular, the compounds disclosed in U.S. Pat. No. 3,893,858, West German Patent 1,290,812 and JP-A-53-95630 are preferred. The compounds disclosed in U.S. Pat. No. 4,552,834 are also preferred. These bleaching accelerators may be incorporated into the photosensitive material. These bleaching accelerators are particularly effective for blix of color photosensitive materials for picture taking.

The bleaching solution or blix solution preferably contains an organic acid besides the above mentioned compounds for the purpose of inhibiting bleach stain. A particularly preferred organic acid is a compound with an acid dissociation constant (pKa) of 2 to 5. In particular, acetic acid, propionic acid, hydroxyacetic acid, etc. are preferred.

Examples of fixing agents to be contained in the fixing solution or blix solution include thiosulfates, thiocyanates, thioethers, thioureas, and a large amount of iodides. The thiosulfites are normally used. In particular, ammonium thiosulfate can be most widely used. Further, thiosulfates are preferably used in combination with thiocyanates, thioether compounds, thioureas, etc. As preservatives of the fixing or blix bath there can be preferably used sulfites, bisulfites, carbonyl bisulfite adducts or sulfinic acid compounds as described in EP 294769A. The fixing solution or blix solution preferably contains aminopolycarboxylic acids or organic phosphonic acids for the purpose of stabilizing the solution.

In the present invention, compounds having pKa of 6.0 to 9.0 are preferably added to the fixing solution or a bleach-fixing solution in order to pH adjustment. Preferablly, imidazoles such as imidazole, 1-methylimidazole, 1-ethylimidazole, and 2-methylimidazole are added in an amount of 0.1 to 10 mol/L.

The total time required for desilvering step is preferably as short as possible so long as no maldesilvering occurs. The desilvering time is preferably in the range of 1 to 3 minutes, more preferably 1 to 2 minutes. The processing temperature is in the range of 25° C. to 50° C., preferably 35° C. to 45° C. In the preferred temperature range, the desilvering rate can be improved and stain after processing can be effectively inhibited.

In the desilvering step, the agitation is preferably intensified as much as possible. Specific examples of such an agitation intensifying method include a method as described in JP-A-62-183460 which comprises jetting the processing solution to the surface of the emulsion layer in the photosensitive material, a method as described in JP-A-62-183461 which comprises improving the agitating effect by a rotary means, a method which comprises improving the agitating effect by moving the photosensitive material with the emulsion surface in contact with a wiper blade provided in the bath so that a turbulence occurs on the emulsion surface, and a method which comprises increasing the total circulated amount of processing solution. Such an agitation improving method can be effectively applied to the bleaching bath, blix bath or fixing bath. The improvement in agitation effect can be considered to expedite the supply of a bleaching agent, fixing agent or the like into emulsion film, resulting in an improvement in desilvering rate. The above mentioned agitation improving means can work more effectively when a bleach accelerator is used, remarkably increasing the bleach acceleration effect and eliminating the inhibition of fixing by the bleach accelerator.

The automatic developing machine to be used in the processing of the photosensitive material of the present invention is preferably equipped with a photosensitive material conveying means as disclosed in JP-A's-60-191257, 60-191258 and 60-191259. As described in above JP-A-60-191257, such a conveying means can remarkably reduce the amount of the processing solution carried from a bath to its subsequent bath, providing a high effect of inhibiting deterioration of the properties of the processing solution. This effect is remarkably effective for the reduction of the processing time or the amount of replenisher required at each step.

It is usual that the thus desilvered silver halide color photosensitive material of the present invention is subjected to washing and/or stabilization. The quantity of water to be used in the washing can be selected from a broad range depending on the characteristics of the photosensitive material (for example, the kind of materials such as couplers, etc.), the end use of the photosensitive material, the temperature of washing water, the number of washing tanks (number of stages), the replenishment system (e.g., counter-current system or concurrent system), and other various factors. Of these factors, the relationship between the number of washing tanks and the quantity of water in a multistage counter-current system can be obtained according to the method described in “Journal of the Society of Motion Picture and Television Engineers”, vol. 64, pp. 248-253 (May 1955).

According to the multi-stage counter-current system described in the above reference, although the requisite amount of water can be greatly reduced, bacteria would grow due to an increase of the retention time of water in the tank, and floating masses of bacteria stick to the photosensitive material. In the processing for the color photosensitive material of the present invention, in order to cope with this problem, the method of reducing calcium and magnesium ion concentrations described in JP-A-62-288838 can be used very effectively. Further, it is also effective to use isothiazolone compounds or thiabenzazoles as described in JP-A-57-8542, chlorine type bactericides, e.g., chlorinated sodium isocyanurate, benzotriazole, and bactericides described in Hiroshi Horiguchi, “Bokinbobaizai no kagaku”, published by Sankyo Shuppan, (1986), Eisei Gijutsu Gakkai (ed.), “Biseibutsu no mekkin, sakkin, bobigijutsu”, Kogyogijutsukai, (1982), and Nippon Bokin Bobi Gakkai (ed.), “Bokin bobizai jiten” (1986).

The washing water has a pH value of from 4 to 9, preferably from 5 to 8 in the processing for the photosensitive material of the present invention. The temperature of the water and the washing time can be selected from broad ranges depending on the characteristics and end use of the photosensitive material, but usually ranges from 15° C. to 45° C. in temperature and from 20 seconds to 10 minutes in time, preferably from 25° C. to 45° C. in temperature and from 30 seconds to 5 minutes in time. The photosensitive material of the present invention may be directly processed with a stabilizer in place of the washing step. For the stabilization, any of the known techniques as described in JP-A's-57-8543, 58-14834 and 60-220345 can be used.

The aforesaid washing step may be followed by stabilization in some cases. For example, a stabilizing bath containing a dye stabilizer and a surface active agent as is used as a final bath for color photosensitive materials for picture taking can be used. Examples of such a dye stabilizer include aldehydes such as formalin and glutaraldehyde, N-methylol compounds, hexamethylenetetramine and aldehyde-bisulfite adducts. This stabilizing bath may also contain various chelating agents or antifungal agents.

The overflow accompanying replenishment of the washing bath and/or stabilizing bath can be reused in other steps such as desilvering. For example, in a processing using an automatic developing machine, if the above mentioned various processing solutions are subject to concentration due to evaporation, the concentration is preferably corrected for by the addition of water.

The silver halide color photosensitive material of the present invention may incorporate a color developing agent for the purpose of simplifying and expediting processing. Such a color developing agent is preferably used in the form of various precursors, when it is contained in the photosensitive material. Examples of such precursors include indoaniline compounds as described in U.S. Pat. No. 3,342,597, Schiff's base type compounds as described in U.S. Pat. No. 3,342,599, and Research Disclosure Nos. 14,850 and 15,159, and aldol compounds as described in Research Disclosure No. 13,924, metal complexes as described in U.S. Pat. No. 3,719,492, and urethane compounds as described in JP-A-53-135628.

The silver halide color photosensitive material of the present invention may optionally incorporate various 1-phenyl-3-pyrazolidones for the purpose of accelerating color development. Typical examples of such compounds are described in JP-A's-56-64339, 57-144547 and 58-115438.

In the present invention, the various processing solutions are used at a temperature of 10° C. to 50° C. The standard temperature range is normally from 33° C. to 38° C. However, a higher temperature range can be used to accelerate processing, reducing the processing time. On the contrary, a lower temperature range can be used to improve the picture quality or the stability of the processing solutions.

Further, the silver halide photosensitive material of the invention may be applied to heat-development photosensitive material as described, for example, in U.S. Pat. No. 4,500,626, and JP-A's-60-133449, 59-218443 and 61-238056, and EP 210 660A2.

Further, the silver halide color photosensitive material of the invention can exhibit advantages easily when it is applied to lens-fitted film unit described, for example, in Jap. Utility Model KOKOKU Publication Nos. 2-32615 and 3-39784, which is effective.

### EXAMPLE

The present invention will be specifically explained by way of examples. However, the present invention is not limited to these examples.

### Example 1

1) Preparation of Emulsion

(Seed Emulsion)

Following the preparation of emulsion 1C described in Example 1 of JP-A-11-174606, a silver halide tabular grain was prepared while the amount of a silver iodide fine grain added during a growth step was adjusted so that the silver iodide content in the grain after the completion of the growth step was 10 mol % based on the total silver amount after the completion of the growth step. After washing with water, gelatin was added to adjust the pH to 5.7, the pAg to 8.8, the weight in terms of silver per kilogram of emulsion of 131.8 g and the weight of gelatin to 64.1 g to yield a seed emulsion. The emulsion obtained comprises grains having an average silver iodide content of 10 mol %, an average equivalent spherical diameter of 0.7 μm and an average aspect ratio of 28.

(Em-A1)

1211 mL of an aqueous solution containing 46 g of trimellitated gelatin at a trimellitation ratio of 97% and 1.7 g of KBr was stirred vigorously while being kept at 75° C. Following the addition of 48 g of the aforementioned seed emulsion, 0.3 g of modified silicone oil (L7602, product of Nippon Unicar Co., Ltd. product, L7602) was added. After addition of H₂SO₄ to adjust the pH to 5.5, 67.6 mL of an aqueous solution containing 7.0 g of AgNO₃ and a mixed aqueous solution of KBr and KI containing 10 mol % of KI were added by the double-jet method over 12 min while the flow rate was accelerated so that the final flow rate was 3.5 times the initial flow rate. At this time, the silver potential was kept at +20 mV to a saturated calomel electrode. After addition of 2 mg of sodium benzenethiosulfonate and 2 mg of thiourea dioxide, 762 mL of an aqueous solution containing 170 g of AgNO₃ and a mixed aqueous solution of KBr and KI containing 10 mol % of KI were added over 143 min by the double-jet method while the flow rate was accelerated so that the final flow rate was 3.0 times the initial flow rate. At this time, the silver potential was kept at +20 mV to the saturated calomel electrode. 75 mL of an aqueous solution containing 23.4 g of AgNO₃ and 75 mL of an aqueous KBr solution were added by the double-jet method over 11 min. At this time, the silver potential was kept at −10 mV to the saturated calomel electrode. The temperature was raised to 82° C., KBr was added to adjust the silver potential to −80 mV, and an emulsion containing silver iodide fine grains having a grain size of 0.037 μm was added in an amount of 2.28 g in terms of KI weight. Immediately after the addition, 100.2 mL of an aqueous solution containing 23.4 g of AgNO₃ was added over 10 min. For the first 5 min of the addition, the silver potential was kept at −80 mV by using an aqueous KBr solution. After washing with water, gelatin was added to adjust the pH to 5.8 and the pAg to 8.7 at 40° C. Following addition of compounds 1 and 2, the temperature was raised to 60° C. After addition of sensitizing dyes ExS-1 and ExS-2, the emulsion was optimally subjected to chemical sensitization by adding potassium thiocyanate, chloroauric acid, sodium thiosulfate and N,N-dimethylselenourea. At the end of this chemical sensitization, compounds 1 and compound F-2 shown later were added. “Optimal chemical sensitization” used herein means that the addition amount of each of the sensitizing dyes and the compounds was selected to be 10⁻¹ to 10⁻⁸ mol per mole of silver halide.

This emulsion comprised tabular grains having an average equivalent spherical diameter of 1.70 μm, an average equivalent circular diameter of 2.80 μm, an average aspect ratio of 4.8 and a (111) face as a main plane.

From observation of the thus obtained tabular grains through a transmission electron microscope with the liquid-nitrogen cooling, it was found that about 80%, on a number basis, of the total grains were grains containing no dislocation lines within the grain's central area equivalent to 80% based on the projected area. These grains contained 10 or more dislocation lines per grain in their respective peripheral areas equivalent to 20% based on the projected area.

Moreover, the silver iodide contents I₁ and 12 in the outermost layer of the resulting grains were measured by analytical electron microscopy using a field emission-type electron gun according to the method described in this text. This analysis showed that the grains having a (111) face of I₂/I₁<1.0 as a main plane accounted for 40% of the total projected area.

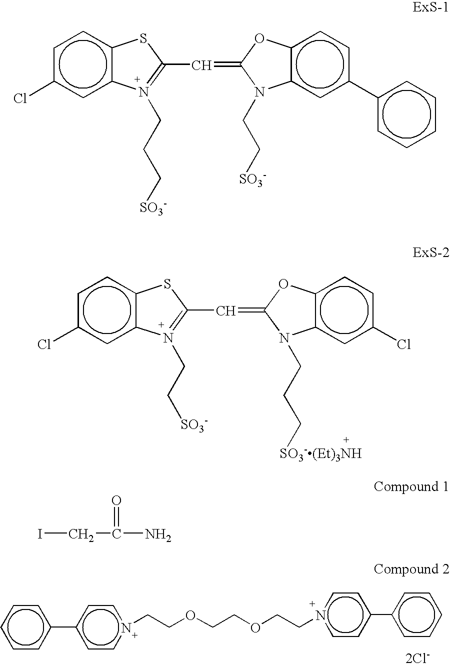

(Preparation of Silver Iodobromide Fine Grain Emulsion)

1000 mL of a solution containing 0.3 g of KBr and 30 g of gelatin was heated to 45° C. and stirred well. Subsequently, 700 mL of an aqueous silver nitrate solution containing 148 g of AgNO₃ and 700 mL of an aqueous halide solution containing 96.3 g of KBr and 10.1 g of KI were added simultaneously over 10 min while keeping the flow rate at 47.5 mL/min. A conventional desalting was performed and gelatin was added. The emulsion prepared in this way was an emulsion (silver iodobromide fine particle emulsion) comprising silver iodobromide fine grains having an average silver iodide content of 7 mol % and an average grain size of 0.04 μm.

(Preparation of Silver Bromide Fine Grain Emulsion)

The preparation of the above-mentioned silver iodobromide fine grain emulsion was repeated in the same manner except changing the aqueous halide solution to that containing KBr only. The emulsion prepared in this way was an emulsion (silver bromide fine particle emulsion) comprising silver bromide fine grains having an average grain size of 0.05 μm.

(Preparation of Em-A2)

After washing with water, the above (Em-A1) was heated to 60° C. and the silver potential thereof was kept at −35 mV to a saturated calomel electrode by a KBr solution. Then, the above-prepared silver iodobromide fine grain emulsion having an average grain size of 0.04 μm and an average silver iodide content of 7 mol % was added so that the silver amount was 2 mol % based on the total silver amount and the resulting emulsion was ripened for 30 min. After checking that the fine grains added had dissolved completely, desalting by conventional sedimentation and washing with water were carried out. Moreover, the emulsion was heated to 60° C. and the silver potential thereof was kept at −77 mV to a saturated calomel electrode by a KBr solution. After that, Em-A2 was prepared in the same manner as Em-A1 except adding the above-prepared silver bromide fine grain emulsion having an average grain size of 0.05 μm so that the silver amount was 3 mol % based on the total silver amount and ripening for 10 min.

From observation of the thus obtained tabular grains through a transmission electron microscope with the liquid-nitrogen cooling, it was found that about 90%, on a number basis, of the total grains were grains containing no dislocation lines within the grain's central area equivalent to 80% based on the projected area. These grains contained 10 or more dislocation lines per grain in their respective peripheral areas equivalent to 20% based on the projected area.

Moreover, the silver iodide contents I₁ and I₂ in the outermost layer of the resulting grains were measured by analytical electron microscopy using a field emission-type electron gun according to the method described in this text. This analysis showed that the grains having a (111) face of I₂/I₁<1.0 as a main plane accounted for 80% of the total projected area. It was also showed that the grains having a (111) face of I₂/I₁<0.8 as a main plane accounted for 65% of the total projected area.

(Em-J1)

1300 mL of an aqueous solution containing 1.6 g of low-molecular-weight oxidized gelatin having a weight average molecular weight of about 15000 and 11.0 g of KBr was kept at 58° C., adjusted to pH 9, and stirred vigorously. An aqueous solution containing 1.3 g of AgNO₃ and an aqueous solution containing 1.1 g of KBr and 0.7 g of low-molecular-weight oxidized gelatin having a weight average molecular weight of about 15000 were added over 30 sec by the double-jet method to perform nucleation. 6.6 g of KBr was added, and the temperature was raised to 78° C. to ripen the resultant material. After the ripening, 15.0 g of gelatin obtained by chemically modifying alkali-processed gelatin having a weight average molecular weight of about 100000 with succinic anhydride and then the pH was adjusted to 5.5. 230 mL of an aqueous solution containing 29.3 g of AgNO₃ and an aqueous solution containing 15.8 g of KBr and 1.92 g of KI were added over 30 min by the double-jet method. At this time, the silver potential was kept at −20 mV to a saturated calomel electrode. Moreover, an aqueous solution containing 64.5 g of AgNO₃ and 233 mL of aqueous solution containing 42.3 g of KBr and 5.14 g of KI were added over 37 min by the double-jet method while the flow rate was accelerated so that the final flow rate was 1.33 times the initial flow rate. At this time, the silver potential was kept at −20 mV during the addition. Subsequently, an aqueous solution containing 70.8 g of AgNO₃ and an aqueous KBr solution were added over 35 min by the double-jet method while keeping the silver potential at −10 mV.

After the temperature was lowered to 40° C., 4.9 g of compound 2 was added and then 32 mL of 0.8 M aqueous sodium sulfite solution was further added. Subsequently, the mixture was adjusted to pH 9.0 using an aqueous NaOH solution and was maintained for 5 min. The temperature was raised to 55° C. and then the pH was adjusted to 5.5 using H₂SO₄. 1 mg of sodium benzenethiosulfonate was added, and 13 g of lime-treated gelatin having a calcium concentration of 1 ppm was also added. After the additions, 250 mL of an aqueous solution containing 71.0 g of AgNO₃ and an aqueous KBr solution were added over 20 min while the silver potential was kept at +75 mV. At this time, 1×10⁻⁵ mol, per mole of silver, of yellow prussiate of potash and 1.0×10⁻⁸ mol, per mole of silver, of K₂IrCl₆ were added.

After washing with water, gelatin was added to adjust the pH to 6.5 and the pAg to 8.8 at 40° C. After raising the temperature to 56° C., sensitizing dyes ExS-3, Exs-4 and ExS-5 and compound 2 were added. Then, the emulsion was optimally subjected to chemical sensitization by adding potassium thiocyanate, chloroauric acid, sodium thiosulfate, N,N-dimethylselenourea and compound F-11 shown later, and compound 3. AT the completion of the chemical sensitization, compound F-2 shown later was added.

This emulsion comprised tabular grains having an average equivalent spherical diameter of 1.33 μm, an average equivalent circular diameter of 2.63 μm, an average aspect ratio of 11.4 and a (111) face as a main plane.

From observation of the thus obtained tabular grains through a transmission electron microscope with the liquid-nitrogen cooling, it was found that about 90%, on a number basis, of the total grains were grains containing no dislocation lines within the grain's central area equivalent to 80% based on the projected area. These grains contained 10 or more dislocation lines per grain in their respective peripheral areas equivalent to 20% based on the projected area.

Moreover, the silver iodide contents I₁ and I₂ in the outermost layer of the resulting grains were measured by analytical electron microscopy using a field emission-type electron gun according to the method described in this text. This analysis showed that the grains having a (111) face of I₂/I₁<1.0 as a main plane accounted for 38% of the total projected area.

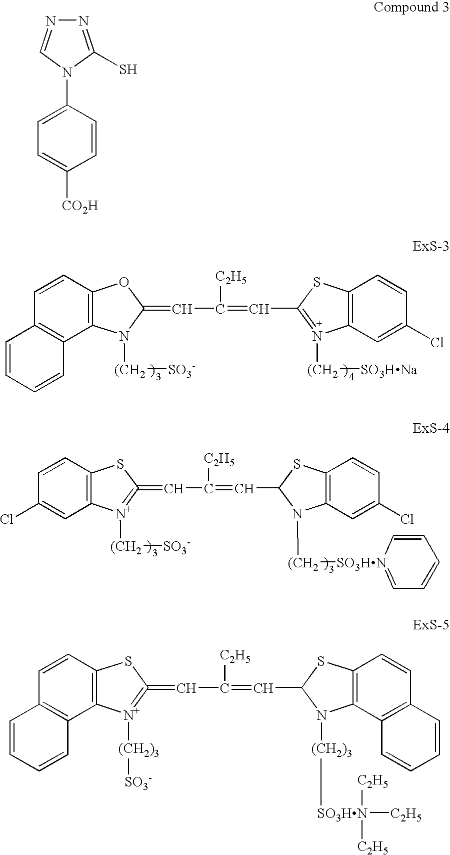

(Em-J2)

After washing with water, the above (Em-J1) was heated to 60° C. and the silver potential thereof was kept at −35 mV to a saturated calomel electrode by a KBr solution. Then, a silver iodobromide fine grain emulsion having an average grain size of 0.04 μm and an average silver iodide content of 7 mol % was added so that the silver amount was 2 mol % based on the total silver amount and the resulting emulsion was ripened for 30 min. After checking that the fine grains added had dissolved completely, an operation of ultrafiltration was carried out. Then, the temperature was raised to 60° C. and the silver potential was kept at −75 mV to a saturated calomel electrode by a KBr solution. After that, Em-J2 was prepared in the same manner as Em-J1 except adding a silver bromide fine grain emulsion having an average grain size of 0.05 μm so that the silver amount might be 4 mol % based on the total silver amount and ripening for 10 min.

In the ultrafiltration operation, a Pall Filtron ultrafiltration membrane having a molecular cutoff of 100 K manufactured by Nihon Pall Ltd. was used as an ultrafiltration membrane. A pressure of 1 to 10 kg/cm² was suitable because too high a pressure to an ultrafiltration membrane may cause rupture of the membrane, etc. though the higher the pressure, the faster the filtration can be done.

Moreover, the silver iodide contents I₁ and I₂ in the outermost layer of the resulting grains were measured by analytical electron microscopy using a field emission-type electron gun according to the method described in this text. This analysis showed that the grains having a (111) face of I₂/I₁<1.0 as a main plane accounted for 75% of the total projected area. This analysis also showed that the grains having a (111) face of I₂/I₁<0.7 as a main plane accounted for 65% of the total projected area.

(Em-P1)

1200 mL of an aqueous solution containing 0.38 g of phthalated gelatin having a weight average molecular weight of about 100000 and a phthalation ratio of 97% and 0.99 g of KBr was kept at 60° C., adjusted to pH 2, and stirred vigorously. An aqueous solution containing 1.96 g of AgNO₃ and an aqueous solution containing 1.97 g of KBr and 0.172 g of KI were added over 30 sec by the double-jet method. After the completion of ripening, 12.8 g of trimellitated gelatin obtained by chemically modifying gelatin having a weight average molecular weight of about 100000 and having a methionine content of 35 μmol per gram with trimellitic acid was added. After the pH was adjusted to 5.9, 2.99 g of KBr and 6.2 g of NaCl were added. 60.7 mL of an aqueous solution containing 27.3 g of AgNO₃ and an aqueous KBr solution were added over 35 min by the double-jet method. At this time, the silver potential was kept at −30 mV to a saturated calomel electrode. Subsequently, silver iodobromide fine grain emulsion having a silver iodide content of 6.5 mol % was prepared in a mixing apparatus out side a reaction vessel by simultaneously adding an aqueous solution containing 65.5 g of AgNO₃ and an aqueous solution containing KBr, KI and gelatin having weight-average molecular weight of about 20000, while the thus prepared silver iodobromide fine grain emulsion was added to the reaction vessel over 62 min. At this time, the silver potential was kept at ±0 mV.

After 1.5 g of thiourea dioxide was added, 132 mL of aqueous solution containing 41.8 g of AgNO₃ and KBr solution were added over 13 min by the double-jet method. The addition of KBr solution was adjusted so that the silver potential at the completion of the addition was +40 mV. After 2 mg of benzenethiosulfonate was added the silver potential was adjusted to −100 mV by the addition of KBr. 6.2 g of the above mentioned silver iodide fine grain emulsion, in terms of KI weight, was added. 300 mL of aqueous solution containing 88.5 g of AgNO₃ was added over 8 min immediately after the completion of the addition. The addition of KBr aqueous solution was adjusted so that the potential ate the completion of the addition was +60 mV. After washing with water, gelatin was added to adjust the pH to 6.5 and the pAg to 8.2 at 40° C. After raising the temperature to 61° C., sensitizing dyes ExS-6, Exs-7 and ExS-8 and compound 3 were added. Then, the emulsion was optimally subjected to chemical sensitization by adding K₂IrCl₆, potassium thiocyanate, chloroauric acid, sodium thiosulfate, hexafluorophenyldiphenylphosfine selenide and compound 1. AT the completion of the chemical sensitization, compound F-2 was added.

From observation of the thus obtained tabular grains through a transmission electron microscope with the liquid-nitrogen cooling, it was found that about 90%, on a number basis, of the total grains were grains containing no dislocation lines within the grain's central area equivalent to 80% based on the projected area. These grains contained 10 or more dislocation lines per grain in their respective peripheral areas equivalent to 20% based on the projected area.

Moreover, the silver iodide contents I₁ and I₂ in the outermost layer of the resulting grains were measured by analytical electron microscopy using a field emission-type electron gun according to the method described in this text. This analysis showed that the grains having a (111) face of I₂/I₁<1.0 as a main plane accounted for 46% of the total projected area.

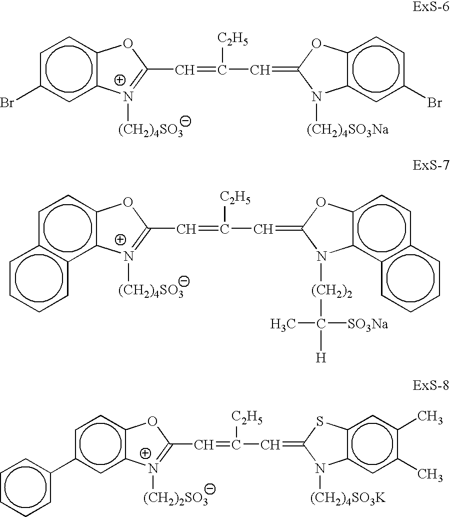

(Em-P2)

After washing with water, the above (Em-P1) was heated to 60° C. and the silver potential thereof was kept at −35 mV to a saturated calomel electrode by a KBr solution. Then, a silver iodobromide fine grain emulsion having an average grain size of 0.04 μm and an average silver iodide content of 7 mol % was added so that the silver amount was 2 mol % based on the total silver amount and the resulting emulsion was ripened for 30 min. After checking that the fine grains added had dissolved completely, the same operation of ultrafiltration as for Em-J2 was carried out. Then, the temperature was raised to 60° C. and the silver potential was kept at −70 mV to a saturated calomel electrode by a KBr solution. After that, Em-P2 was prepared in the same manner as Em-P1 except adding a silver bromide fine grain emulsion having an average grain size of 0.05 μm so that the silver amount might be 5 mol % based on the total silver amount and ripening for 10 min.

From observation of the thus obtained tabular grains through a transmission electron microscope with the liquid-nitrogen cooling, it was found that about 90%, on a number basis, of the total grains were grains containing no dislocation lines within the grain's central area equivalent to 80% based on the projected area. These grains contained 10 or more dislocation lines per grain in their respective peripheral areas equivalent to 20% based on the projected area.

Moreover, the silver iodide contents I₁ and I₂ in the outermost layer of the resulting grains were measured by analytical electron microscopy using a field emission-type electron gun according to the method described in this text. This analysis showed that the grains having a (111) face of I₂/I₁<1.0 as a main plane accounted for 60% of the total projected area. This analysis also showed that the grains having a (111) face of I₂/I₁<0.9 as a main plane accounted for 52% of the total projected area.

Characteristics of the thus prepared emulsions Em-A1 to -A2, -J1 to J2 and —P1 to —P2 are shown in Table 1.

TABLE 1

| | | | | | | Ratio, to the | | |
|---|---|---|---|---|---|---|---|---|
| | | | | | | total projected | | |
| | | | | | | area, of grains | | |
| | | | | | | having (111) | Dislocation | |
| | Av. | Av. | COV | Av. | Av. | main plane and | line | |
| Emulsion | ESD | ECD | of | aspect | value | satisfies | (number per | |
| No. | μm | μm | ECD | ratio | of I₁ | I₂ /I₁ < 1 (%) | grain) | Remarks |
| Em-A1 | 1.70 | 2.80 | 28 | 4.8 | 5.5 | 40% | 10 or more | Comparative |
| | | | | | | | | emulsion to A2 |
| Em-A2 | 1.70 | 2.80 | 28 | 4.8 | 5.0 | 80% | 10 or more | Silver iodide |
| | | | | | | | | contents of the |
| | | | | | | | | outermost surface |
| | | | | | | | | layer are within |
| | | | | | | | | the present |
| | | | | | | | | invention |
| Em-J1 | 1.33 | 2.63 | 25 | 11.4 | 4.8 | 38% | 10 or more | Comparative |
| | | | | | | | | emulsion to J2 |
| Em-J2 | 1.33 | 2.63 | 25 | 11.4 | 6.0 | 75% | 10 or more | Silver iodide |
| | | | | | | | | contents of the |
| | | | | | | | | outermost surface |
| | | | | | | | | layer are within |
| | | | | | | | | the present |
| | | | | | | | | invention |
| Em-P1 | 1.30 | 3.80 | 22 | 38.0 | 4.0 | 46% | 10 or more | Comparative |
| | | | | | | | | emulsion to P2 |
| Em-P2 | 1.30 | 3.80 | 22 | 38.0 | 5.5 | 60% | 10 or more | Silver iodide |
| | | | | | | | | contents of the |
| | | | | | | | | outermost surface |
| | | | | | | | | layer are within |
| | | | | | | | | the present |
| | | | | | | | | invention |

ESD = Equivalent sphere diameter;
ECD = Equivalent circle diameter;
COV = Coefficient of variation;
(Av. aspect ratio 7 in Table 1 means 60% or more of the total projected of silver halide grains have an aspect ratio of 7. The same is applied to Table 2.)

2) Support

A support used in this example was formed as follows.

100 parts by weight of a polyethylene-2,6-naphthalate polymer and 2 parts by weight of Tinuvin P.326 (manufactured by Ciba-Geigy Co.) as an ultraviolet absorbent were dried, melted at 300° C., and extruded from a T-die. The resultant material was longitudinally oriented by 3.3 times at 140° C., laterally oriented by 3.3 times at 130° C., and thermally fixed at 250° C. for 6 sec, thereby obtaining a 90 μm thick PEN (polyethylenenaphthalate) film. Note that proper amounts of blue, magenta, and yellow dyes (I-1, I-4, I-6, I-24, I-26, I-27, and II-5 described in Journal of Technical Disclosure No. 94-6023) were added to this PEN film. The PEN film was wound around a stainless steel core 20 cm in diameter and given a thermal history of 110° C. and 48 hr, manufacturing a support with a high resistance to curling.

3) Coating of Undercoat Layer

The two surfaces of the above support were subjected to corona discharge, UV discharge, and glow discharge. After that, each surface of the support was coated with an undercoat solution (10 mL/m², by using a bar coater) consisting of 0.1 g/m² of gelatin, 0.01 g/m² of sodium α-sulfodi-2-ethylhexylsuccinate, 0.04 g/m² of salicylic acid, 0.2 g/m² of p-chlorophenol, 0.012 g/m² of (CH₂═CHSO₂CH₂CH₂NHCO)₂CH₂, and 0.02 g/m² of a polyamido-epichlorohydrin polycondensation product, thereby forming an undercoat layer on a side at a high temperature upon orientation. Drying was performed at 115° C. for 6 min (all rollers and conveyors in the drying zone were at 115° C.).

4) Coating of Back Layers

One surface of the undercoated support was coated with an antistatic layer, magnetic recording layer, and slip layer having the following compositions as back layers.

4-1) Coating of Antistatic Layer

The surface was coated with 0.2 g/m² of a dispersion (secondary aggregation grain size=about 0.08 μm) of a fine-grain powder, having a specific resistance of 5 Ω·cm, of a tin oxide-antimony oxide composite material with an average grain size of 0.005 μm, together with 0.05 g/m² of gelatin, 0.02 g/m² of (CH₂═CHSO₂CH₂CH₂NHCO)₂CH₂, 0.005 g/m² of polyoxyethylene-p-nonylphenol (polymerization degree 10), and resorcin.

4-2) Coating of Magnetic Recording Layer

A bar coater was used to coat the surface with 0.06 g/m² of cobalt-y-iron oxide (specific area 43 m²/g, major axis 0.14 μm, minor axis 0.03 pin, saturation magnetization 89 Am²/kg, Fe⁺²/Fe⁺³=6/94, the surface was treated with 2 wt % of iron oxide by aluminum oxide silicon oxide) coated with 3-poly(polymerization degree 15)oxyethylene-propyloxytrimethoxysilane (15 wt %), together with 1.2 g/m² of diacetylcellulose (iron oxide was dispersed by an open kneader and sand mill), by using 0.3 g/m² of C₂H₅C(CH₂OCONH—C₆H₃(CH₃)NCO)₃ as a hardener and acetone, methylethylketone, and cyclohexane as solvents, thereby forming a 1.2-μm thick magnetic recording layer. 10 mg/m² of silica grains (0.3 μm) were added as a matting agent, and 10 mg/m² of aluminum oxide (0.15 μm) coated with 3-poly(polymerization degree 15)oxyethylene-propyloxytrimethoxysilane (15 wt %) were added as a polishing agent. Drying was performed at 115° C. for 6 min (all rollers and conveyors in the drying zone were at 115° C.). The color density increase of DB of the magnetic recording layer measured by an X-light (blue filter) was about 0.1. The saturation magnetization moment, coercive force, and squareness ratio of the magnetic recording layer were 4.2 Am²/kg, 7.3×10⁴ A/m, and 65%, respectively.

4-3) Preparation of Slip Layer

The surface was then coated with diacetylcellulose (25 mg/m²) and a mixture of C₆H₁₃CH(OH)C₁₀H₂₀COOC₄₀H₈₁ (compound a, 6 mg/m²)/C₅₀H₁₀₁O(CH₂CH₂O)₁₆H (compound b, 9 mg/m²). Note that this mixture was melted in xylene/propylenemonomethylether (1/1) at 105° C. and poured and dispersed in propylenemonomethylether (tenfold amount) at room temperature. After that, the resultant mixture was formed into a dispersion (average grain size 0.01 μm) in acetone before being added. 15 mg/m² of silica grains (0.3 μm) were added as a matting agent, and 15 mg/m² of aluminum oxide (0.15 μm) coated with 3-poly(polymerization degree 15)oxyethylene-propyloxytrimethoxysiliane (15 wt %) were added as a polishing agent. Drying was performed at 115° C. for 6 min (all rollers and conveyors in the drying zone were at 115° C.). The resultant slip layer was found to have excellent characteristics; the coefficient of kinetic friction was 0.06 (5 mmø stainless steel hard sphere, load 100 g, speed 6 cm/min), and the coefficient of static friction was 0.07 (clip method). The coefficient of kinetic friction between an emulsion surface (to be described later) and the slip layer also was excellent, 0.12.

5) Coating of Sensitive Layers

Next, the surface of the support on the side away from the back layers formed as above was multi-coated with a plurality of layers having the following compositions to form a color negative photographic material of Sample 101. The ISO speed of Sample 101 measured in accordance with JIS K 7614-1981 was 1600. Further, Samples 102 to 114 were prepared in exactly the same manner as Sample 101 except that respective emulsions in the 5th, 6th, 8th, 9th, 10th, 11th, 13th and 14th layers and DIR couplers added to the 8th, 9th, 10th and 13th layers were replaced as shown in Table 3 to be described later.

At this time, respective emulsions were replaced in the same silver amount, while respective DIR couplers were replaced in the equimolar amount. Further, for a layer in which emulsion were used as a mixture, an emulsion of an alphabet was replaces with another emulsion of the same alphabet. (For example, in the 5th layer of Sample 105, emulsion K1 in the 5th layer of Sample 101 was replaced with emulsion K2 in the same silver amount, and emulsion L1 was replaces with emulsion L2 in the same silver amount.)

(Compositions of Sensitive Layers)

The main ingredients used in the individual layers are classified as follows.

| | |
|---|---|
| ExC: Cyan coupler | UV: Ultraviolet absorbent |
| ExM: Magenta coupler | HBS: High-boiling organic solvent |
| ExY: Yellow coupler | H: Gelatin hardener |
| | (Film hardener) |

(In the following description, practical compounds have numbers attached to their symbols. Formulas of these compounds will be presented later.)

The number corresponding to each component indicates the coating amount in units of g/m². The coating amount of a silver halide is indicated by the amount of silver.

1st layer (1st antihalation layer)

| | | |
|---|---|---|
| Black colloidal silver | silver | 0.07 |
| Gelatin | | 0.660 |
| ExM-1 | | 0.048 |
| Cpd-2 | | 0.001 |
| F-8 | | 0.001 |
| HBS-1 | | 0.090 |
| HBS-2 | | 0.010 |

2nd layer (2nd antihalation layer)

| | | |
|---|---|---|
| Black colloidal silver | silver | 0.09 |
| Gelatin | | 0.830 |
| ExM-1 | | 0.057 |
| ExF-1 | | 0.002 |
| F-8 | | 0.001 |
| HBS-1 | | 0.090 |
| HBS-2 | | 0.010 |

3rd layer (Interlayer)

| | |
|---|---|
| ExC-2 | 0.010 |
| Cpd-1 | 0.086 |
| UV-2 | 0.029 |
| UV-3 | 0.052 |
| UV-4 | 0.011 |
| HBS-1 | 0.100 |
| Gelatin | 0.580 |

4th layer (Low-speed red-sensitive emulsion layer)

| | | |
|---|---|---|
| Em-M | silver | 0.40 |
| Em-N | silver | 0.35 |
| Em-O | silver | 0.18 |
| ExC-1 | | 0.222 |
| ExC-2 | | 0.010 |
| ExC-3 | | 0.072 |
| ExC-4 | | 0.148 |
| ExC-5 | | 0.005 |
| ExC-6 | | 0.008 |
| ExC-8 | | 0.071 |
| ExC-9 | | 0.010 |
| UV-2 | | 0.036 |
| UV-3 | | 0.067 |
| UV-4 | | 0.014 |
| Cpd-2 | | 0.010 |
| Cpd-4 | | 0.012 |
| HBS-1 | | 0.240 |
| HBS-5 | | 0.010 |
| Gelatin | | 1.630 |

5th layer (Medium-speed red-sensitive emulsion layer)

| | | |
|---|---|---|
| Em-K1 | silver | 0.43 |
| Em-L1 | silver | 0.23 |
| ExC-1 | | 0.121 |
| ExC-2 | | 0.042 |
| ExC-3 | | 0.018 |
| ExC-4 | | 0.074 |
| ExC-5 | | 0.019 |
| ExC-6 | | 0.024 |
| ExC-8 | | 0.010 |
| ExC-9 | | 0.021 |
| Cpd-2 | | 0.020 |
| Cpd-4 | | 0.021 |
| HBS-1 | | 0.129 |
| Gelatin | | 0.900 |

6th layer (High-speed red-sensitive emulsion layer)

| | | |
|---|---|---|
| Em-J0 | silver | 1.15 |
| ExC-1 | | 0.112 |
| ExC-6 | | 0.0325 |
| ExC-8 | | 0.110 |
| ExC-9 | | 0.005 |
| ExC-10 | | 0.159 |
| Cpd-2 | | 0.068 |
| Cpd-4 | | 0.015 |
| HBS-1 | | 0.440 |
| Gelatin | | 1.710 |

7th layer (Interlayer)

| | |
|---|---|
| Cpd-1 | 0.081 |
| Cpd-6 | 0.002 |
| Solid disperse dye ExF-4 | 0.015 |
| HBS-1 | 0.049 |
| Polyethylacrylate latex | 0.088 |
| Gelatin | 0.759 |

8th layer (interlayer effect-donating interlayer (a
layer providing interlayer effect to
red-sensitive layer)

| | | |
|---|---|---|
| Em-E1 | silver | 0.40 |
| Cpd-4 | | 0.010 |
| ExM-2 | | 0.082 |
| ExM-3 | | 0.006 |
| ExM-4 | | 0.026 |
| ExY-1 | | 0.010 |
| ExY-4 | | 0.051 |
| ExC-7 | | 0.047 |
| HBS-1 | | 0.203 |
| HBS-3 | | 0.003 |
| HBS-5 | | 0.010 |
| Gelatin | | 0.570 |

9th layer (Low-speed green-sensitive emulsion layer)

| | | |
|---|---|---|
| Em-G1 | silver | 0.15 |
| Em-H | silver | 0.23 |
| Em-I | silver | 0.26 |
| ExM-2 | | 0.388 |
| ExM-3 | | 0.040 |
| ExY-1 | | 0.003 |
| ExY-3 | | 0.002 |
| ExC-7 | | 0.006 |
| HBS-1 | | 0.337 |
| HBS-3 | | 0.018 |
| HBS-4 | | 0.260 |
| HBS-5 | | 0.110 |
| Cpd-5 | | 0.010 |
| Gelatin | | 1.470 |

10th layer (Medium-speed green-sensitive emulsion
layer)

| | | |
|---|---|---|
| Em-F1 | silver | 0.30 |
| Em-G1 | silver | 0.12 |
| ExM-2 | | 0.084 |
| ExM-3 | | 0.012 |
| ExM-4 | | 0.005 |
| ExY-3 | | 0.002 |
| ExC-6 | | 0.003 |
| ExC-7 | | 0.004 |
| ExC-8 | | 0.008 |
| HBS-1 | | 0.002 |
| HBS-3 | | 0.002 |
| HBS-5 | | 0.004 |
| Cpd-5 | | 0.004 |
| Gelatin | | 0.382 |

11th layer (High-speed green-sensitive emulsion layer)

| | | |
|---|---|---|
| Em-P0 | silver | 1.200 |
| ExC-6 | | 0.002 |
| ExC-8 | | 0.010 |
| ExM-1 | | 0.014 |
| ExM-2 | | 0.023 |
| ExM-3 | | 0.015 |
| ExM-6 | | 0.010 |
| ExM-4 | | 0.005 |
| ExM-5 | | 0.040 |
| ExY-3 | | 0.003 |
| Cpd-3 | | 0.004 |
| Cpd-4 | | 0.007 |
| Cpd-5 | | 0.010 |
| HBS-1 | | 0.259 |
| HBS-5 | | 0.020 |
| Polyethylacrylate latex | | 0.099 |
| Gelatin | | 1.110 |

12th layer (Yellow filter layer)

| | |
|---|---|
| Cpd-1 | 0.088 |
| Solid disperse dye ExF-2 | 0.051 |
| Solid disperse dye ExF-8 | 0.010 |
| HBS-1 | 0.049 |
| Gelatin | 0.593 |

13th layer (Low-speed blue-sensitive emulsion layer)

| | | |
|---|---|---|
| Em-B1 | silver | 0.50 |
| Em-C | silver | 0.12 |
| Em-D | silver | 0.09 |
| ExC-1 | | 0.024 |
| ExC-7 | | 0.008 |
| ExY-1 | | 0.002 |
| ExY-2 | | 0.956 |
| ExY-4 | | 0.091 |
| Cpd-2 | | 0.037 |
| Cpd-3 | | 0.004 |
| HBS-1 | | 0.372 |
| HBS-5 | | 0.047 |
| Gelatin | | 2.200 |

14th layer (High-speed blue-sensitive emulsion layer)

| | | |
|---|---|---|
| Em-A1 | silver | 1.22 |
| ExY-2 | | 0.235 |
| ExY-4 | | 0.018 |
| Cpd-2 | | 0.075 |
| Cpd-3 | | 0.001 |
| HBS-1 | | 0.087 |
| Gelatin | | 1.156 |

15th layer (1st protective layer)

| | | |
|---|---|---|
| Silver iodobromide emulsion | silver | 0.28 |
| grains having an average | | |
| grain diameter of 0.07 μm | | |
| UV-1 | | 0.358 |
| UV-2 | | 0.179 |
| UV-3 | | 0.254 |
| UV-4 | | 0.025 |
| F-11 | | 0.008 |
| S-1 | | 0.078 |
| ExF-5 | | 0.0024 |
| ExF-6 | | 0.0012 |
| ExF-7 | | 0.0010 |
| HBS-1 | | 0.175 |
| HBS-4 | | 0.050 |
| Gelatin | | 2.231 |

16th layer (2nd protective layer)

| | |
|---|---|
| H-1 | 0.400 |
| B-1 (diameter 1.7 μm) | 0.050 |
| B-2 (diameter 1.7 μm) | 0.150 |
| B-3 | 0.050 |
| S-1 | 0.200 |
| Gelatin | 0.711 |

In addition to the above components, W-1 to W-6, B-4 to B-6, F-1 to F-17, an iron salt, a lead salt, a gold salt, a platinum salt, a palladium salt, an iridium salt, a ruthenium salt, and a rhodium salt were appropriately added to the individual layers in order to improve the storability, processability, resistance to pressure, mildewproofing and antiseptic properties, antistatic properties and coating property thereof.

(Preparation of Dispersions of Organic Solid Disperse Dyes)

A solid dispersion ExF-2 was dispersed by the following method.

4000 g of water and 376 g of a 3% solution of W-2 were added to 2,800 g of a wet cake of ExF-2 containing 18% of water, and the resultant material was stirred to form a slurry of ExF-2 having a concentration of 32%. Next, ULTRA VISCO MILL (UVM-2) manufactured by Imex K.K. was filled with 1,700 mL of zirconia beads having an average grain size of 0.5 mm. The slurry was milled by passing through the mill for 8 hr at a peripheral speed of about 10 m/sec and a discharge amount of 0.5 L/min.

Similarly, solid dispersions of ExF-4 and ExF-8 were obtained. The average grain sizes of the dye fine grains were 0.28 μm and 0.49 μm, respectively.

Further, Em-B1 to Em-O were prepared on the basis of emulsion preparation methods of Em-A to —P described in examples of JP-A-2001-92057 and of Em-A to -O described in example of JP-A-2001-92059 and suitably changing the grain formation conditions therein. The characteristics thereof are shown in Table 2.

TABLE 2
<Grain characteristics of silver halide emulsions Em-B1 to Em-O>

| | | | | | Dislocation | Av. silver | |
|---|---|---|---|---|---|---|---|
| | Layer in which | Av. | Av. | Av. | line | iodide | Kind of |
| Emulsion | emulsion was | ESD | ECD | aspect | (number per | content | sensitizing |
| No. | used | μm | μm | ratio | grain) | mol % | dye |
| Em-B1 | Low-speed blue | 0.9 | 1.3 | 4.3 | Incapable of | 9.0 | ExS-1 |
| | sensitive layer | | | | measurement | | ExS-2 |
| Em-B2 | Low-speed blue | 1.0 | 2.0 | 12.2 | 10 or more | 10.0 | ExS-1 |
| | sensitive layer | | | | | | ExS-2 |
| Em-C | Low-speed blue | 0.7 | 0.6 | 1.0 | 10 or more | 4.0 | ExS-1 |
| | sensitive layer | | | | | | ExS-2 |
| Em-D | Low-speed blue | 0.4 | 0.5 | 3.5 | 10 or more | 4.1 | ExS-1 |
| | sensitive layer | | | | | | ExS-2 |
| Em-E1 | Interlayer | 0.9 | 2.0 | 4.5 | 10 or more | 6.0 | ExS-9 |
| | effect-donating | | | | | | ExS-11 |
| | layer to red | | | | | | |
| | sensitive layer | | | | | | |
| Em-E2 | Interlayer | 1.1 | 2.6 | 20.6 | 10 or more | 6.7 | ExS-9 |
| | effect-donating | | | | | | ExS-11 |
| | layer to red | | | | | | |
| | sensitive layer | | | | | | |
| Em-P0 | High-speed | 1.4 | 1.8 | 3.0 | Incapable of | 5.0 | ExS-6 |
| | green sensitive | | | | measurement | | ExS-7 |
| | layer | | | | | | ExS-8 |
| Em-F1 | Medium-speed | 0.9 | 2.0 | 3.0 | 10 or more | 7.0 | ExS-6 |
| | green sensitive | | | | | | ExS-7 |
| | layer | | | | | | ExS-8 |
| Em-F2 | Medium-speed | 1.2 | 2.7 | 18.0 | 10 or more | 6.9 | ExS-6 |
| | green sensitive | | | | | | ExS-7 |
| | layer | | | | | | ExS-8 |
| Em-G1 | Low- and medium- | 0.8 | 1.6 | 4.5 | 10 or more | 6.1 | ExS-6 |
| | speed green | | | | | | ExS-7 |
| | sensitive layers | | | | | | ExS-8 |
| Em-G2 | Low- and medium- | 0.9 | 2.0 | 15.9 | 10 or more | 6.1 | ExS-6 |
| | speed green | | | | | | ExS-7 |
| | sensitive layers | | | | | | ExS-8 |
| Em-H | Low-speed green | 0.7 | 1.2 | 4.7 | 10 or more | 6.0 | ExS-8 |
| | sensitive layer | | | | | | ExS-9 |
| | | | | | | | ExS-10 |
| Em-I | Low-speed green | 0.7 | 1.2 | 4.7 | 10 or more | 6.0 | ExS-8 |
| | sensitive layer | | | | | | ExS-9 |
| | | | | | | | ExS-10 |
| Em-J0 | High-speed red | 1.4 | 1.8 | 3.0 | Incapable of | 5.0 | ExS-3 |
| | sensitive layer | | | | measurement | | ExS-4 |
| | | | | | | | ExS-5 |
| Em-K1 | Medium-speed red | 1.2 | 2.0 | 4.0 | 10 or more | 4.5 | ExS-3 |
| | sensitive layer | | | | | | ExS-4 |
| | | | | | | | ExS-5 |
| Em-K2 | Medium-speed red | 1.0 | 2.4 | 20.0 | 10 or more | 4.0 | ExS-3 |
| | sensitive layer | | | | | | ExS-4 |
| | | | | | | | ExS-5 |
| Em-L1 | Medium-speed | 0.8 | 1.5 | 4.5 | 10 or more | 3.5 | ExS-3 |
| | red sensitive | | | | | | ExS-4 |
| | layer | | | | | | ExS-5 |
| Em-L2 | Medium-speed | 0.8 | 1.9 | 19.0 | 10 or more | 3.6 | ExS-3 |
| | red sensitive | | | | | | ExS-4 |
| | layer | | | | | | ExS-5 |
| Em-M | Low-speed red | 0.6 | 1.1 | 4.9 | 10 or more | 2.9 | ExS-3 |
| | sensitive | | | | | | ExS-4 |
| | layer | | | | | | ExS-5 |
| Em-N | Low-speed red | 0.4 | 0.6 | 4.5 | 10 or more | 2.0 | ExS-3 |
| | sensitive | | | | | | ExS-4 |
| | layer | | | | | | ExS-5 |
| Em-0 | Low-speed red | 0.3 | 0.4 | 3.0 | 10 or more | 1.0 | ExS-3 |
| | sensitive | | | | | | ExS-4 |
| | layer | | | | | | ExS-5 |

Compounds used for forming the above respective layers are those shown below.

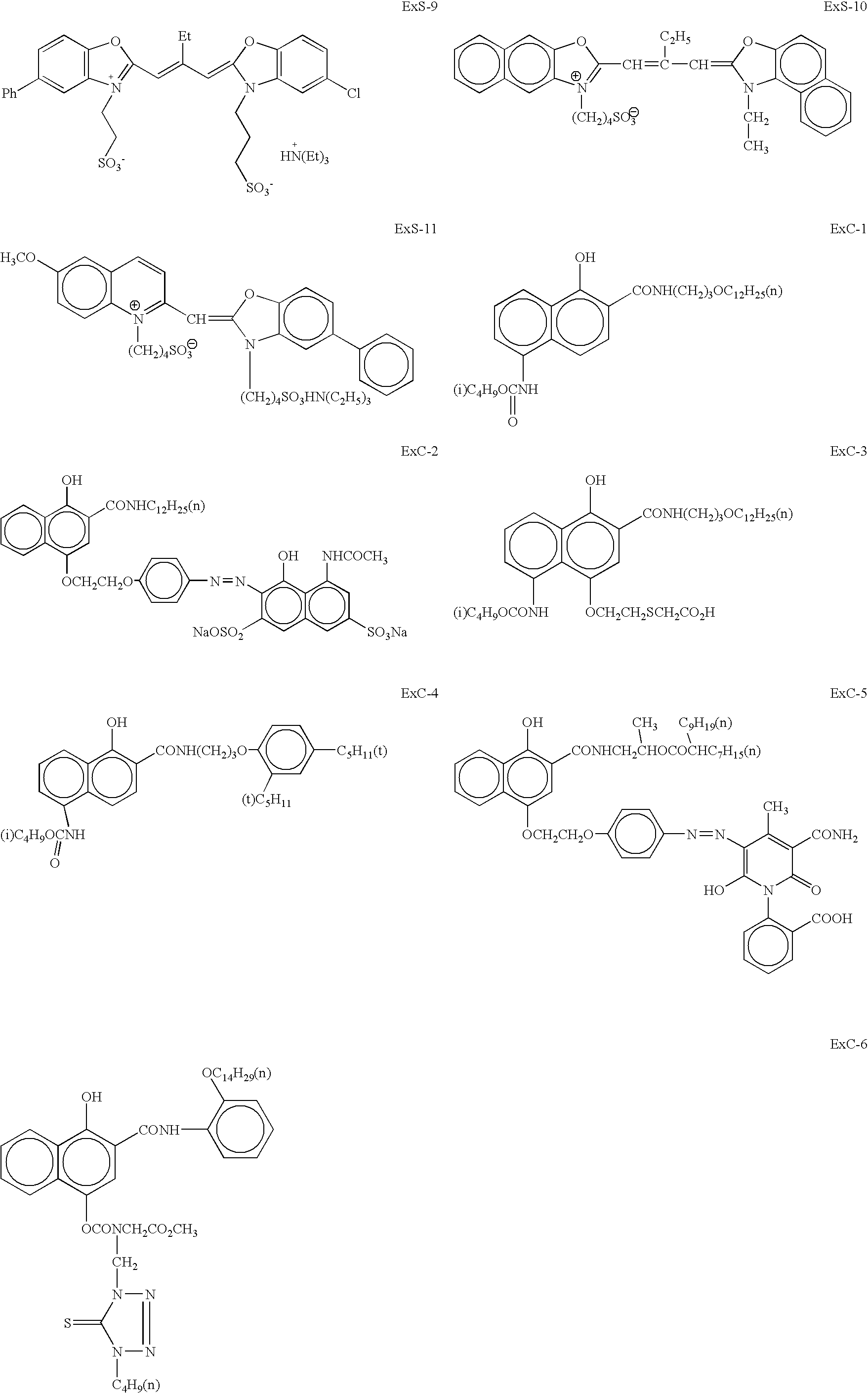

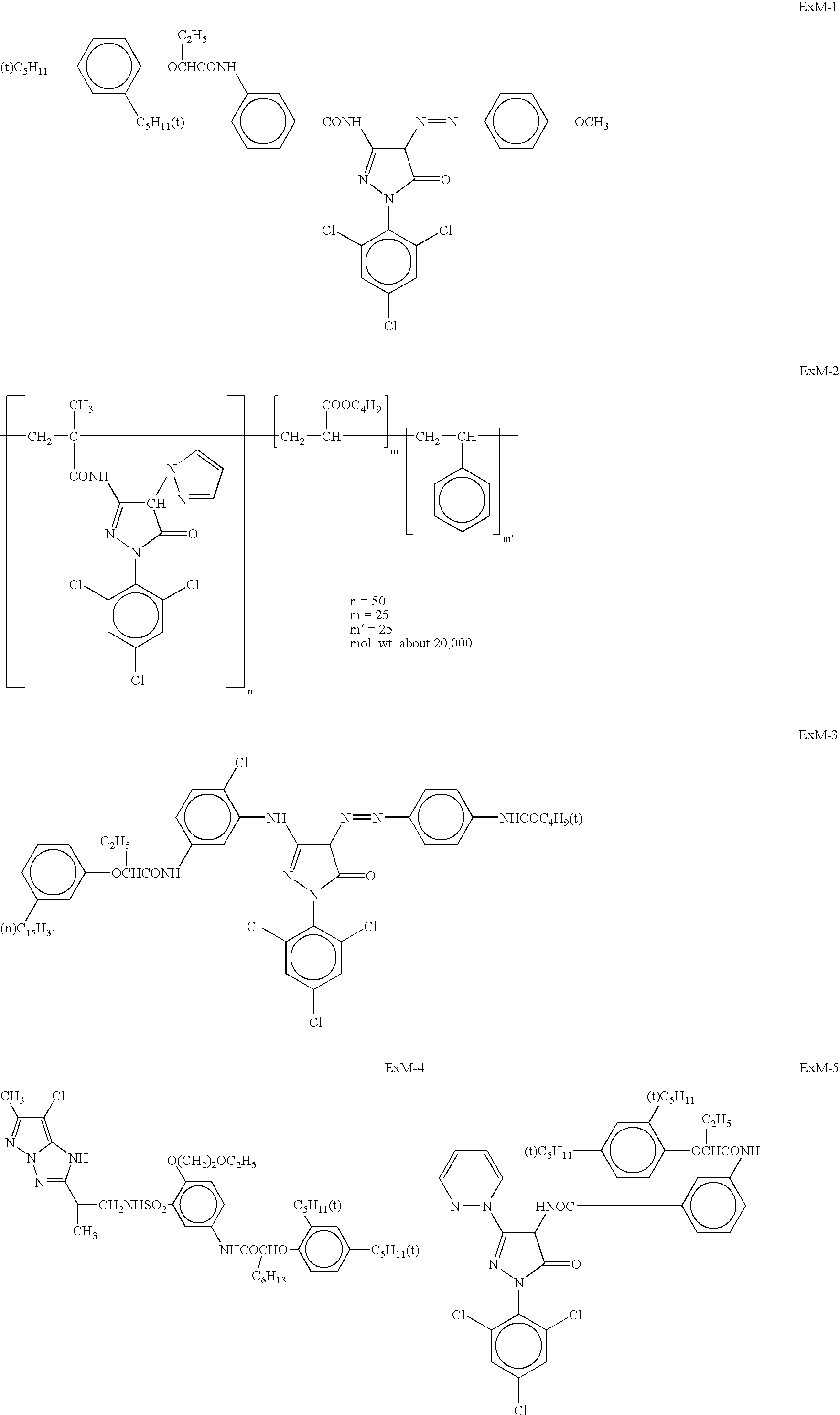

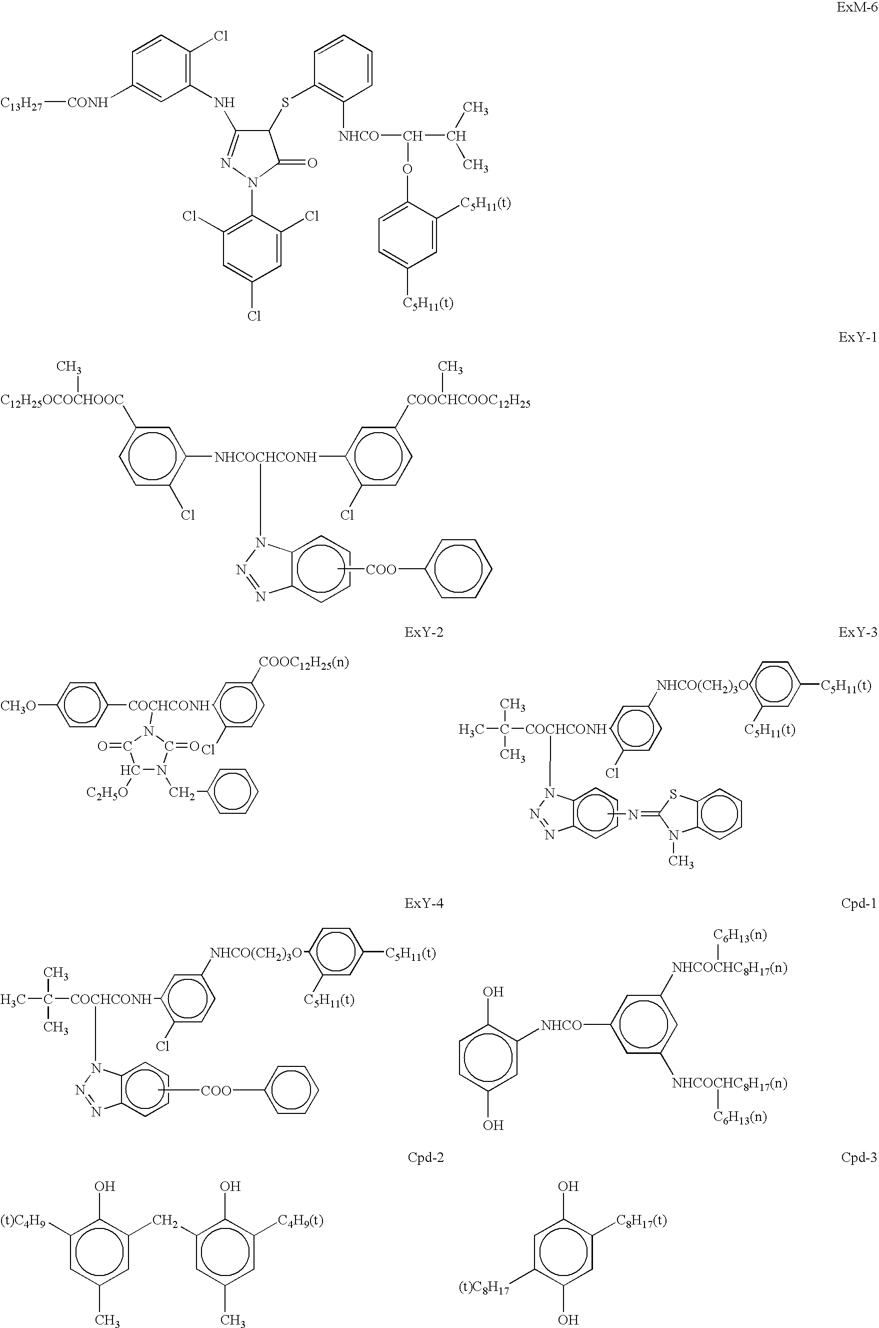

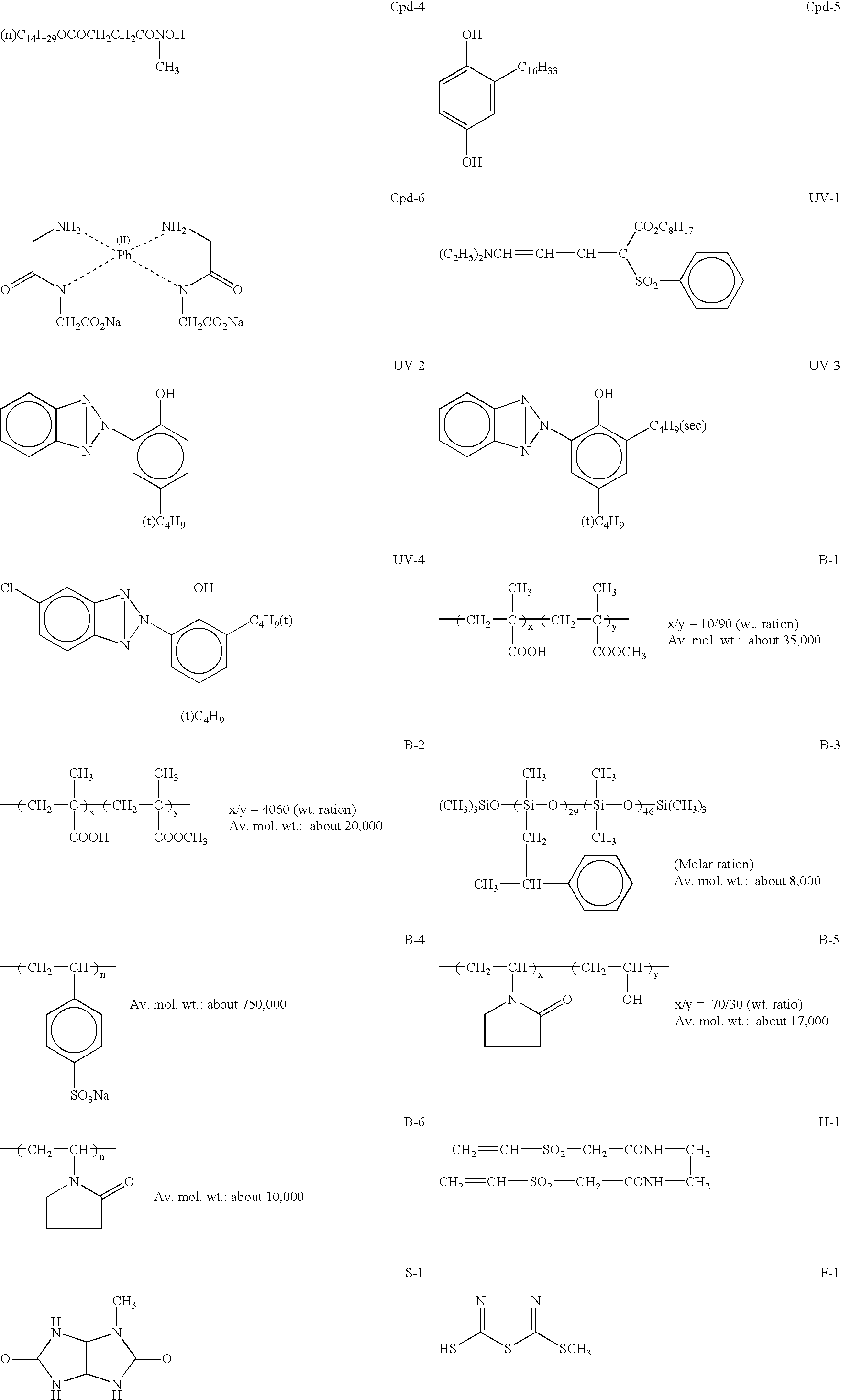

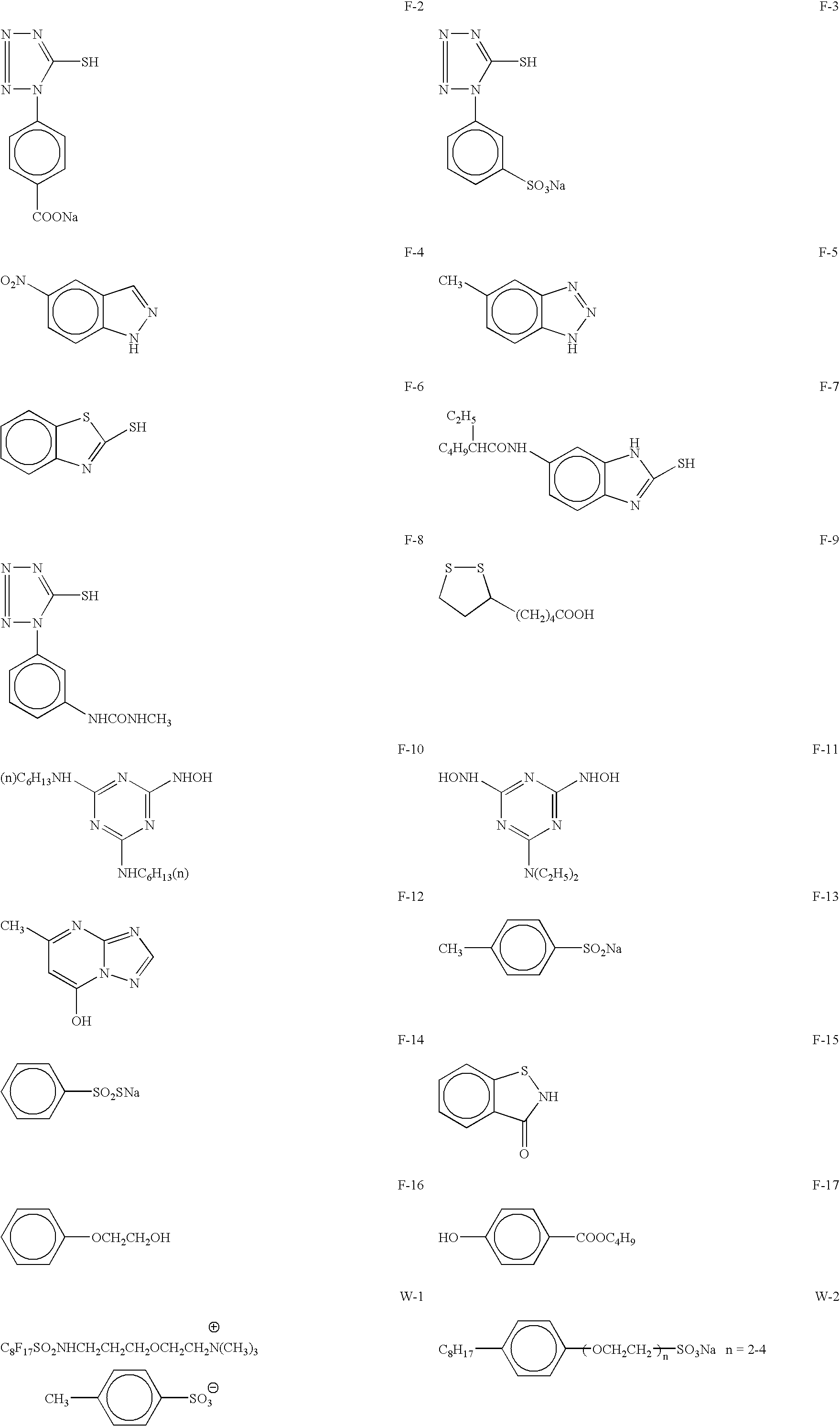

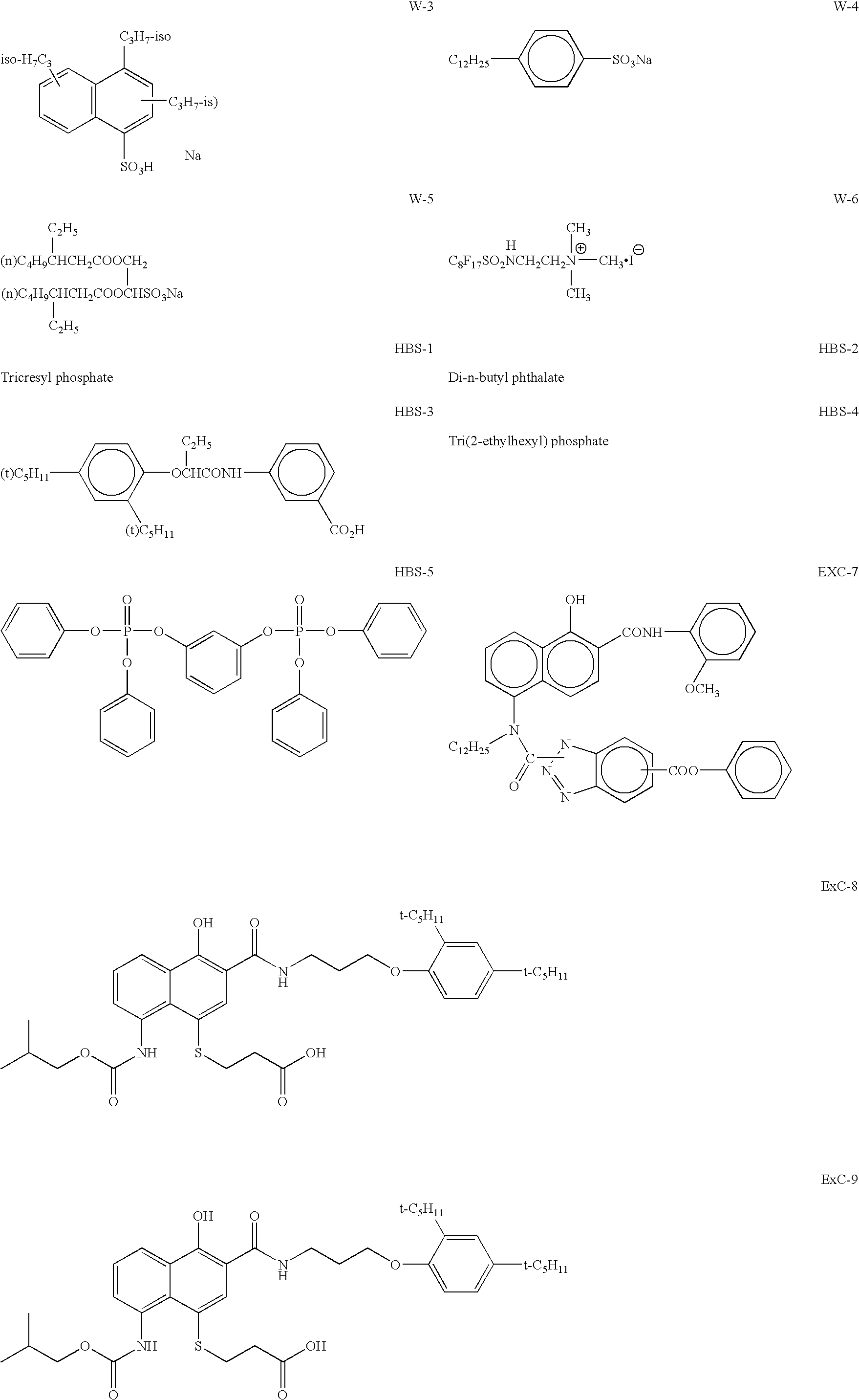

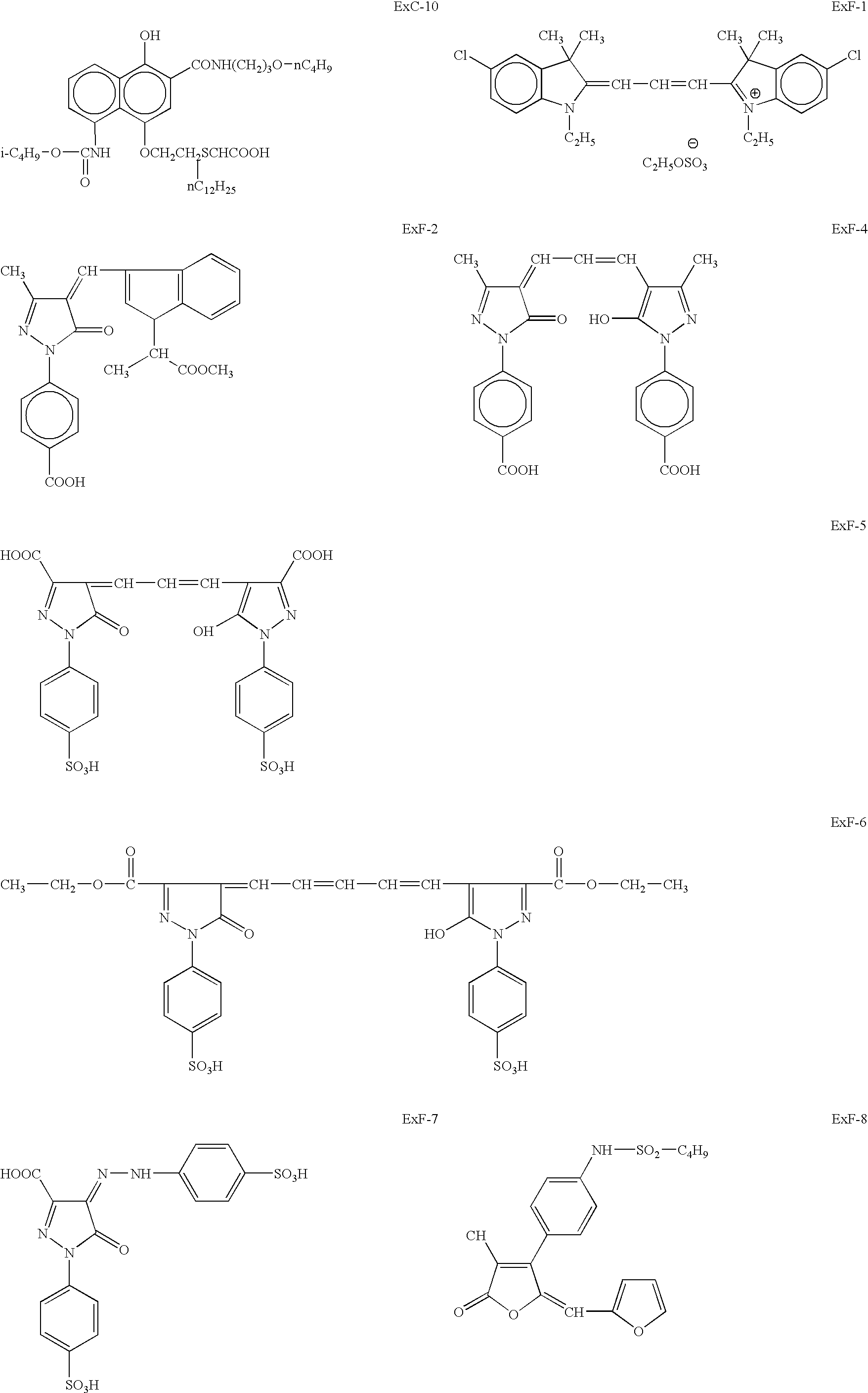

6) Development Processing

Development was performed as follows by using an automatic developer FP-360B manufactured by Fuji Photo Film Co., Ltd. Note that FP-360B was modified such that the overflow solution of the bleaching bath was entirely discharged to a waste solution tank without being supplied to the subsequent bath. This FP-360B includes an evaporation correcting means described in JIII Journal of Technical Disclosure No. 94-4992.

The processing steps and the processing solution compositions are presented below.

(Processing steps)

| | | | Replenishing | Tank |
|---|---|---|---|---|
| Step | Time | Temperature | rate* | volume |
| Color | 3 min 5 sec | 37.8° C. | 20 mL | 11.5 L |
| development | | | | |
| Bleaching | 50 sec | 38.0° C. | 5 mL | 5 L |
| Fixing (1) | 50 sec | 38.0° C. | — | 5 L |
| Fixing (2) | 50 sec | 38.0° C. | 8 mL | 5 L |
| Washing | 30 sec | 38.0° C. | 17 mL | 3 L |
| Stabilization | 20 sec | 38.0° C. | — | 3 L |
| (1) | | | | |
| Stabilization | 20 sec | 38.0° C. | 15 mL | 3 L |
| (2) | | | | |
| Drying | 1 min 30 sec | 60.0° C. | | |

*The replenishment rate was per 1.1 m of a 35-mm wide sensitized material (equivalent to one 24 Ex. 1)

The stabilizer and fixer were counterflowed from (2) to (1), and the overflow of washing water was entirely introduced to the fixing bath (2). Note that the amounts of the developer, bleaching solution, and fixer carried over to the bleaching step, fixing step, and washing step were 2.5 mL, 2.0 mL, and 2.0 mL, respectively, per 1.1 m of a 35-mm wide sensitized material. Note also that each crossover time was 6 sec, and this time was included in the processing time of each preceding step.

The aperture areas of the processor were 100 cm² for the color developer, 120 cm² for the bleaching solution, and about 100 cm² for the other processing solutions.

The compositions of the processing solutions are presented below.

| | Tank | Replenisher |
|---|---|---|
| | solution (g) | (g) |
| (Color developer) | | |
| Diethylenetriamine | 3.0 | 3.0 |
| pentaacetic acid | | |
| Disodium cathecol-3,5- | 0.3 | 0.3 |
| disulfonate | | |
| Sodium sulfite | 3.9 | 5.3 |
| Potassium carbonate | 39.0 | 39.0 |
| Disodium-N, N-bis (2- | 1.5 | 2.0 |
| sulfonatoethyl) | | |
| hydroxylamine | | |
| Potassium bromide | 1.3 | 0.3 |
| Potassium iodide | 1.3 mg | — |
| 4-hydroxy-6-methyl- | 0.05 | — |
| 1,3,3a,7-tetrazaindene | | |
| Hydroxylamine sulfate | 2.4 | 3.3 |
| 2-methyl-4-[N-ethyl-N- | 4.5 | 6.5 |
| (β-hydroxyethyl) amino] | | |
| aniline sulfate | | |
| Water to make | 1.0 L | 1.0 L |
| pH (adjusted by potassium | 10.05 | 10.18 |
| hydroxide and sulfuric | | |
| acid) | | |
| (Bleaching solution) | | |
| Ferric ammonium 1,3- | 113 | 170 |
| diaminopropanetetra | | |
| acetate monohydrate | | |
| Ammonium bromide | 70 | 105 |
| Ammonium nitrate | 14 | 21 |
| Succinic acid | 34 | 51 |
| Maleic acid | 28 | 42 |
| Water to make | 1.0 L | 1.0 L |
| pH (controlled by ammonia | 4.6 | 4.0 |
| water) | | |

(Fixing (1) Tank Solution)

A 5:95 (volume ratio) mixture of the above bleaching tank solution and the following fixing tank solution (pH 6.8).

| | Tank | Replenisher |
|---|---|---|
| (Fixer (2)) | solution (g) | (g) |
| Aqueous ammonium | 240 mL | 720 mL |
| thiosulfate solution | | |
| (750 g/L) | | |
| Imidazole | 7 | 21 |
| Ammonium methane | 5 | 15 |
| thiosulfonate | | |
| Ammonium methane | 10 | 30 |
| sulfinate | | |
| Ethylenediamine | 13 | 39 |
| tetraacetic acid | | |
| Water to make | 1.0 L | 1.0 L |
| pH (controlled by ammonia | 7.4 | 7.45 |
| water and acetic acid) | | |

(Washing Water) Common to Tank Solution and Replenisher

Tap water was supplied to a mixed-bed column filled with an H type strongly acidic cation exchange resin (Amberlite IR-120B: available from Rohm & Haas Co.) and an OH type strongly basic anion exchange resin (Amberlite IR-400) to set the concentrations of calcium and magnesium to be 3 mg/L or less. Subsequently, 20 mg/L of sodium isocyanuric acid dichloride and 150 mg/L of sodium sulfate were added. The pH of the solution ranged from 6.5 to 7.5.

(Stabilizer) common to tank solution and replenisher (g)

| | |
|---|---|
| Sodium p-toluenesulfinate | 0.03 |
| Polyoxyethylene-p-monononylphenylether | 0.2 |
| (average polymerization degree 10) | |
| 1,2-benzoisothiazoline-3-one·sodium | 0.10 |
| Disodium ethylenediaminetetraacetate | 0.05 |
| 1,2,4-triazole | 1.3 |
| 1,4-bis (1,2,4-triazole-1-isomethyl) | 0.75 |
| piperazine | |
| Water to make | 1.0 L |
| pH | 8.5 |

Evaluation of Photographic Performance

When the sample 101 prepared above was measured for ISO film speed, a speed of 1600 was obtained.

The samples 101 to 114 prepared above were exposed imagewise using white light and subjected to the aforementioned color developing treatment. A reciprocal number of an exposure amount giving a magenta density of (fog +0.5) was determined as the speed. In Table 3 shown are the results indicated by relative values to the speed of Sample 101 which was taken as 100.

Moreover, RMS values (values measured with an aperture of 48 μm in diameter at a magenta density of fog +0.5) indicating the granularity and MTF values indicating the sharpness were measured and the results are shown in Table 3.

Furthermore, each sample was applied a uniform exposure using red light at 0.05 lux·sec and then exposed imagewise using green light. A value obtained by subtracting a cyan density at a magenta density of fog +1.5 from a cyan density at the fog density of magenta is shown as the interlayer effect in Table 3.

Performances of Samples 101 to 114 thus determined are shown in Table 3.

TABLE 3

| | | | | | | |
|---|---|---|---|---|---|---|
| | | Replacement | | RMS | | |
| Sample | DIR coupler | of emulsion | Relative | value × | MTF value | Interlayer |

| No. | Layer | Compound | Layer | Emulsion | speed | 1000 | cycle/mm | effect | Remarks |
|---|---|---|---|---|---|---|---|---|---|
| 101 | 8th, 9th | ExC-7 | 5th | K1, L1 | 100 | 21.5 | 0.76 | 0.21 | Comp. |
| | 10th and | | layer | | | | | | |
| | 13th | | 6th | J0 | | | | | |
| | layers | | layer | | | | | | |
| | | | 8th | E1 | | | | | |
| | | | layer | | | | | | |
| | | | 9th | G1, H, I | | | | | |
| | | | layer | | | | | | |
| | | | 10th | G1, F1 | | | | | |
| | | | layer | | | | | | |
| | | | 11th | P0 | | | | | |
| | | | layer | | | | | | |
| | | | 13th | B1, C, D | | | | | |
| | | | layer | | | | | | |
| | | | 14th | A1 | | | | | |
| | | | layer | | | | | | |
| 102 | 8th, 9th | (31) | ″ | ″ | 105 | 22.0 | 0.85 | 0.33 | Comp. |
| | 10th and | | | | | | | | |
| | 13th | | | | | | | | |
| | layers | | | | | | | | |
| 103 | 8th, 9th | (44) | ″ | ″ | 100 | 21.6 | 0.83 | 0.30 | Comp. |
| | 10th and | | | | | | | | |
| | 13th | | | | | | | | |
| | layers | | | | | | | | |
| 104 | 8th, 9th | (54) | ″ | ″ | 102 | 21.8 | 0.92 | 0.37 | Comp. |
| | 10th and | | | | | | | | |
| | 13th | | | | | | | | |
| | layers | | | | | | | | |
| 105 | 8th, 9th | ExC-7 | 5th | K2, L2 | 105 | 19.0 | 0.64 | 0.15 | Comp. |
| | 10th and | | layer | | | | | | |
| | 13th | | 6th | J1 | | | | | |
| | layers | | layer | | | | | | |
| | | | 8th | E2 | | | | | |
| | | | layer | | | | | | |
| | | | 9th | G2, H, I | | | | | |
| | | | layer | | | | | | |
| | | | 10th | F2, G1 | | | | | |
| | | | layer | | | | | | |
| | | | 11th | P1 | | | | | |
| | | | layer | | | | | | |
| | | | 13th | B2, C, D | | | | | |
| | | | layer | | | | | | |
| | | | 14th | A1 | | | | | |
| | | | layer | | | | | | |
| 106 | 8th, 9th | (24) | ″ | ″ | 110 | 19.2 | 0.83 | 0.31 | Inv. |
| | 10th and | | | | | | | | |
| | 13th | | | | | | | | |
| | layers | | | | | | | | |
| 107 | 8th, 9th | (32) | ″ | ″ | 107 | 19.0 | 0.80 | 0.29 | Inv. |
| | 10th and | | | | | | | | |
| | 13th | | | | | | | | |
| | layers | | | | | | | | |
| 108 | 8th, 9th | (37) | ″ | ″ | 110 | 19.1 | 0.88 | 0.35 | Inv. |
| | 10th and | | | | | | | | |
| | 13th | | | | | | | | |
| | layers | | | | | | | | |
| 109 | 8th, 9th | ExC-7 | 5th layer | K2, L2 | 107 | 18.8 | 0.66 | 0.16 | Comp. |
| | 10th and | | 6th layer | J2 | | | | | |
| | 13th layers | | 8th layer | E2 | | | | | |
| | | | 9th layer | G2, H, I | | | | | |
| | | | 10th layer | F2, G2 | | | | | |
| | | | 11th layer | P2 | | | | | |
| | | | 13th layer | B2, C, D | | | | | |
| | | | 14th layer | A2 | | | | | |
| 110 | 8th, 9th | (24) | ″ | ″ | 115 | 19.0 | 0.87 | 0.34 | Inv. |
| | 10th and | | | | | | | | |
| | 13th layers | | | | | | | | |
| 111 | 8th, 9th | (32) | ″ | ″ | 110 | 18.9 | 0.85 | 0.30 | Inv. |
| | 10th and | | | | | | | | |
| | 13th layers | | | | | | | | |
| 112 | 8th, 9th | (37) | ″ | ″ | 112 | 18.9 | 0.94 | 0.38 | Inv. |
| | 10th and | | | | | | | | |
| | 13th layers | | | | | | | | |
| 113 | 8th, 9th | (57) | ″ | ″ | 112 | 18.9 | 0.92 | 0.37 | Inv. |
| | 10th and | | | | | | | | |
| | 13th layers | | | | | | | | |
| 114 | 8th, 9th | (61) | ″ | ″ | 111 | 19.0 | 0.88 | 0.35 | Inv. |
| | 10th and | | | | | | | | |
| | 13th layers | | | | | | | | |

As is clear from Table 3, Samples 105 to 108 using emulsions having aspect ratios of 8 or more are preferable to Samples 101 to 104 due to their high speed and superior graininess. On the other hand, Sample 105 using a conventional DIR coupler is not preferable from the viewpoint of color reproduction due to its small interlayer effect. In addition, an MTF value showing sharpness is small. It is shown that the interlayer effect and sharpness are improved sufficiently in Samples 106 to 108 using DIR couplers of the present invention.

On the other hand, Sample 109 using a tabular grain having a silver iodide content in an outermost layer defined in the present invention has a high speed and is improved in graininess. However, the interlayer effect and the sharpness are still insufficient because a comparative DIR coupler was used. Samples 110 to 114 using DIR couplers of the present invention are good in speed and graininess and, in addition, realize a high level of interlayer effect.

Thus, it has become possible to provide a photosensitive material which has a high speed and a high image quality and also is superior in sharpness and color reproducibility.

### Example 2

Each of Samples 101 to 114 prepared in Example 1 was cut, processed and installed in a package unit with a photographing capability loaded in a single use camera “Super Slim Ace” manufactured by Fuji Photo Film Co., Ltd., affording a photographic product with a built-in photosensitive material.

These photographic products were subjected to evaluations similar to those in Example 1 to provide results similar to those of Example 1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A silver halide color photosensitive material having, on a support, a unit blue-sensitive silver halide emulsion layer, a unit green-sensitive silver halide emulsion layer and a unit red-sensitive silver halide emulsion layer, each comprising two or more light-sensitive layers having the same color sensitivity but differing in speed to each other,
wherein the silver halide color photosensitive material containing at least one compound represented by the following general formula (I) or general formula (II); and
wherein at least one of the light-sensitive layers containing silver halide grains in which tabular grains each having an aspect ratio of 5.0 or more account for 60% or more of the total projected area of the silver halide grains: 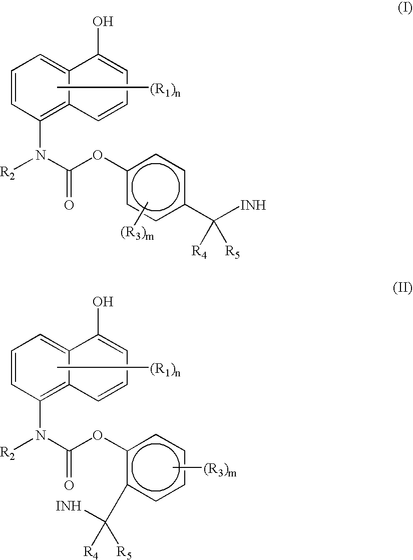
wherein R₁ represents a substituent capable of bonding to a naphthalene ring; n represents an integer of 0 to 6, provided that when n is 2 or more; R₁s may be the same or different; R₂ represents an alkyl group or aryl group, provided that R₁ and R₂ may be bonded to each other to form a ring; R₃s represent m independent substituents bonding to an aryloxy ring which are selected so that the sum of their Hammett substituent constants σ_{P} may be 0.1 or more, provided that R₃ may be bonded to R₅ to form a ring, m represents an integer of 1 to 3, provided that when m is 2 or 3, R₃s may be the same or different; R₄ and RS independently represent a hydrogen atom, alkyl group (including cycloalkyl), alkenyl group (including cycloalkenyl), alkynyl group or aryl group; and INH represents a residue of a mercaptotetrazole derivative, mercaptotriazole derivative, mercaptothiadiazole derivative, mercaptooxadiazole derivative, mercaptothiazole derivative, mercaptooxazole derivative, mercaptoimidazole derivative, mercaptobenzimidazole derivative, mercaptobenzothiazole derivative, mercaptobenzoxazole derivative, tetrazole derivative, 1,2,3-triazole derivative, 1,2,4-triazole derivative or benzotriazole derivative.

2. The silver halide color photosensitive material according to claim 1, wherein the silver halide tabular grains accounting for 60% or more of the total projected area of the silver halide grains each having an aspect ratio of 8.0 or more.

3. The silver halide color photosensitive material according to claim 1, wherein the tabular silver halide grains each having at least ten dislocation lines per grain.

4. The silver halide color photosensitive material according to claim 2, wherein the tabular silver halide grains each having at least ten dislocation lines per grain.

5. The silver halide color photosensitive material according to claim 1, wherein an emulsion contained in at least one light-sensitive emulsion layer in the silver halide color photosensitive material comprising tabular grains
each having a (111) face as a main plane, and
each meeting a relationship:
I₂/I₁<1
wherein I₁ represents a silver iodide content (mol %) of an outermost surface layer in a main plane region and I₂ represents a silver iodide content (mol %) of an outermost surface layer in a side face region,
in an amount of 50% or more of the total projected area of all the silver halide grains contained in the emulsion.

6. The silver halide color photosensitive material according to claim 2, wherein an emulsion contained in at least one light-sensitive emulsion layer in the silver halide color photosensitive material comprising tabular grains
each having a (111) face as a main plane, and
each meeting a relationship:
I₂/I₁<1
wherein I₁ represents a silver iodide content (mol %) of an outermost surface layer in a main plane region and I₂ represents a silver iodide content (mol %) of an outermost surface layer in a side face region,
in an amount of 50% or more of the total projected area of all the silver halide grains contained in the emulsion.

7. The silver halide color photosensitive material according to claim 3, wherein an emulsion contained in at least one light-sensitive emulsion layer in the silver halide color photosensitive material comprising tabular grains
each having a (111) face as a main plane, and
each meeting a relationship:
I₂/I₁<1
wherein I₁ represents a silver iodide content (mol %) of an outermost surface layer in a main plane region and I₂ represents a silver iodide content (mol %) of an outermost surface layer in a side face region,
in an amount of 50% or more of the total projected area of all the silver halide grains contained in the emulsion.

8. The silver halide color photosensitive material according to claim 4, wherein an emulsion contained in at least one light-sensitive emulsion layer in the silver halide color photosensitive material comprising tabular grains
each having a (111) face as a main plane, and
each meeting a relationship:
I₂/I₁<1
wherein I₁ represents a silver iodide content (mol %) of an outermost surface layer in a main plane region and I₂ represents a silver iodide content (mol %) of an outermost surface layer in a side face region,
in an amount of 50% or more of the total projected area of all the silver halide grains contained in the emulsion.

9. The silver halide color photosensitive material according to claim 1, wherein the silver halide color photosensitive material having an ISO speed of 640 or more.

10. The silver halide color photosensitive material according to claim 2, wherein the silver halide color photosensitive material having an ISO speed of 640 or more.

11. The silver halide color photosensitive material according to claim 3, wherein the silver halide color photosensitive material having an ISO speed of 640 or more.

12. The silver halide color photosensitive material according to claim 4, wherein the silver halide color photosensitive material having an ISO speed of 640 or more.

13. The silver halide color photosensitive material according to claim 5, wherein the silver halide color photosensitive material having an ISO speed of 640 or more.

14. The silver halide color photosensitive material according to claim 6, wherein the silver halide color photosensitive material having an ISO speed of 640 or more.

15. The silver halide color photosensitive material according to claim 7, wherein the silver halide color photosensitive material having an ISO speed of 640 or more.

16. The silver halide color photosensitive material according to claim 8, wherein the silver halide color photosensitive material having an ISO speed of 640 or more.
